(19) United States
(12) Patent Application Publication
(10) Pub. No.: US 2016/0292324 A1
(43) Pub. Date: Oct. 6, 2016

(54) SYSTEMS AND METHODS FOR PREDICTING PERFORMANCE

(71) Applicant: SAS Institute Inc., Cary, NC (US)

(72) Inventors: Michael J. Leonard, Cary, NC (US); Thomas H. Dickey, Cary, NC (US); Samuel Lawrence Guseman, Austin, TX (US); Michele Angelo Trovero, Dunellen, NJ (US)

(73) Assignee: SAS Institute Inc., Cary, NC (US)

(21) Appl. No.: 15/055,092

(22) Filed: Feb. 26, 2016

Related U.S. Application Data
(63) Continuation-in-part of application No. 12/036,782, filed on Feb. 25, 2008.

(51) Int. Cl. G06F 17/50; G06F 17/18

(52) U.S. Cl. CPC G06F 17/5009; G06F 17/18

(57) ABSTRACT

Systems and methods are provided for predicting new product performance, such as by way of an interface that allows for structured judgment analysis. The disclosed systems and methods, allow for the optional intervention of an expert, for assessing which other products are most similar to the new product, for excluding certain data from a performance prediction analysis, and thus may allow use of the most similar product and useful data as the basis for forming a product prediction for the new product.

### SUMMARY

In accordance with the teachings herein, computer-implemented systems and methods are provided for predicting the performance of new products. For example, a group that seeks to introduce a new product may query the data maintained by the group about the results of previous introductions of new products. Further, the computer-implemented systems and methods may assess which of the previous products are most similar to the new product that the group seeks to introduce, and thus may use the most similar product as the basis for forming a performance prediction for the product that is to be newly introduced. Accordingly, similarity techniques may be used to limit the potentially large amount of past data to those data sets that correspond to the product launches most likely to be helpful in generating a prediction for the new product. The performance data associated with the products identified as being the most similar then are used to create a prediction of the performance of the new product.

In one aspect, systems for predicting performance of a product are provided. In a particular embodiment, a system of this aspect comprises one or more processors, and one or more non-transitory computer-readable storage mediums containing instructions that, when executed by the one or more processors, cause the one or more processors to perform operations including: querying a group of past products to identify a subgroup of products related to a new product, such as where each of the past products is associated with past performance data and product attribute data, such as where products in the subgroup share one or more product attributes with the new product, such as where the past performance data and the product attribute data for the products in the subgroup form a set of candidate series data, such as where querying includes facilitating a first structured judgment analysis in identification of the subgroup of products related to the new product, filtering the set of candidate series data to add or remove past performance data for one or more products in the subgroup, such as where the filtered set of candidate series data forms a set of surrogate series data, such as where filtering includes facilitating a second structured judgment analysis in forming the set of surrogate series data, extracting a set of statistical modeling features from the set of surrogate series data, such as where extracting includes facilitating a third structured judgment analysis for forming the set of statistical modeling features, and generating a predicted performance for the new product, such as where generating includes generating a prediction function specification using the set of statistical modeling features extracted from the set of surrogate series data, such as where generating includes facilitating a fourth structured judgment analysis in generating the prediction function specification. Optionally, one or more graphical user interfaces are provided for one or more of the querying, filtering, extracting, or generating to facilitate structured judgment analysis in analyzing the predicted performance of the new product.

In another example, the computer-implemented systems and methods taught herein are supplemented by the guidance of a human expert, who makes use of the graphical user interfaces disclosed herein to ensure that the data chosen according to these systems and methods are appropriate for the new product to be introduced. In still another example, the teachings herein permit capturing the analysis performed by the human expert and reducing the analysis to computer-executable instructions, so that non-expert users and/or the computer-implemented systems and methods themselves may make use of the expert's analytical methods in analyses of other products.

In an embodiment, structured judgment analysis includes receiving an input data set, receiving an analysis specification, applying the analysis specification to the input data set to generate a statistical results data set, receiving judgmental data, applying the judgmental data to the statistical results data set to generate a judgmental results data set, and identifying one of the statistical results data set and the judgmental results data set as a structured judgment analysis output.

Optionally, the graphical interface that facilitates exploring the statistical analysis results identifies an amount of data present in the surrogate series data. Optionally, the graphical interface that facilitates exploring the statistical analysis results provides an indication of how many surrogate series are included in the surrogate series data. Optionally, the past performance data comprises panel series data.

In embodiment, querying, filtering, extracting, and generating are performed using a computer-implemented wizard. Useful computer-implemented wizards include those configured to include one or more of a back operation configured to access a previous step for facilitating modification of data with respect to the previous step, a next operation configured to examine an effect of modifications of the data on one or more succeeding steps, and a reset operation configured to undo any changes made and to restore values to an initial generated state.

In embodiments, one or more of the querying, filtering, extracting, and generating are automatically performed without intervention of an analyst.

Optionally, filtering the set of candidate series data includes identifying clusters of products in the subgroup, such as where past performance data is removed for products in one or more of the identified clusters.

In embodiments, querying the group of past products includes providing a graphical interface for display on a computer display device to facilitate specifying a statistical analysis, such as where the graphical interface is configured to receive values for the product attributes associated with the new product, providing a graphical interface for display on the computer display device to facilitate performing the specified statistical analysis and generating statistical analysis results, such as where the graphical interface is configured to receive a command to query the candidate series data, providing a graphical interface for display on the computer display device to facilitate exploring of the statistical analysis results, such as where the graphical interface is configured to display the set of candidate series data, providing a graphical interface for display on the computer display device to facilitate overriding the statistical analysis results, such as where the graphical interface is configured to receive a command to remove or add one or more of the past products from or to the subgroup or alter the values for the product attributes to generate a revised set of candidate series data, and providing a graphical interface for display on the computer display device to facilitate visual analysis of an impact of overriding the statistical analysis results, such as where the graphical interface is configured to provide the revised set of candidate series data.

In embodiments, filtering the set of candidate series data includes providing a graphical interface for display on a computer display device to facilitate specification of a statistical analysis, such as where the graphical interface is configured to receive a statistical filter specification, providing a graphical interface for display on the computer display device to facilitate performing the specified statistical analysis and generating statistical analysis results, such as where the candidate series data includes multiple candidate series, such as where the graphical interface provides properties of the candidate series data, provides statistical distances between the multiple candidate series to identify outlier candidate series, and removes outlier candidate series to form the surrogate series data, such as where the surrogate series data includes multiple surrogate series, providing a graphical interface for display on the computer display device to facilitate exploring of the statistical analysis results, such as where the graphical interface provides the surrogate series data, providing a graphical interface for display on the computer display device to facilitate overriding the statistical analysis results, such as where the graphical interface is configured to receive a command to add or remove one or more of the candidate series to form revised surrogate series data, and providing a graphical interface for display on the computer display device to facilitate visual analysis of an impact of overriding the statistical analysis results, such as where the graphical interface provides the revised surrogate series data.

In embodiments, extracting the set of modeling features includes providing a graphical interface for display on a computer display device to facilitate specification of a statistical analysis, such as where the graphical interface is configured to receive a statistical model specification, providing a graphical interface for display on the computer display device to facilitate performing the specified statistical analysis and generating statistical analysis results, such as where the surrogate series data includes multiple surrogate series, such as where the statistical model specification is fit to the set of surrogate series data, such as where a set of statistical modeling features are extracted based on the statistical model specification, such as where pooled predictions are computed for the set of surrogate series data using the set of statistical modeling features, such as where prediction errors for each of the multiple surrogate series are computed based on the pooled predictions, providing a graphical interface for display on the computer display device to facilitate exploring of the statistical analysis results, such as where the graphical interface displays the set of surrogate series data, the pooled predictions, and the statistical analysis results for each of the surrogate series, providing a graphical interface for display on the computer display device to facilitate overriding the statistical analysis results, such as where the graphical interface is configured to receive a command to remove one or more surrogate series from the set of surrogate series data to generate revised surrogate series data, and providing a graphical interface for display on the computer display device to facilitate visual analysis of an impact of overriding the statistical analysis results, such as where the graphical interface provides the revised set of surrogate series data and the statistical analysis results.

In embodiments, generating the predicted performance for the new product includes providing a graphical interface for display on a computer display device to facilitate specification of a statistical analysis, such as where the graphical interface is configured to receive a prediction specification describing timing of the new product, providing a graphical interface for display on the computer display device to facilitate performing the specified statistical analysis and generating statistical analysis results corresponding to statistical predictions for the new product, such as where the statistical predictions for the new product are based upon timing considerations for the new product, providing a graphical interface for display on the computer display device to facilitate exploring of the statistical analysis results, such as where the graphical interface is configured to provide the statistical predictions for the new product, providing a graphical interface for display on the computer display device to facilitate overriding the statistical analysis results, such as where the graphical interface is configured to receive a command to override one or more of the statistical predictions for the new product, and providing a graphical interface for display on the computer display device to facilitate visual analysis of an impact of overriding the statistical analysis results, such as where the graphical interface is configured to display the statistical predictions and the one or more overrides.

In another aspect, computer-implemented methods for predicting performance of a product are provided. In one embodiment, a method of this aspect comprises querying, using one or more data processors, a group of past products to identify a subgroup of products related to a new product, such as where each of the past products is associated with past performance data and product attribute data, such as where products in the subgroup share one or more product attributes with the new product, such as where the past performance data and the product attribute data for the products in the subgroup form a set of candidate series data, such as where querying includes facilitating a first structured judgment analysis in identification of the subgroup of products related to the new product, filtering, using the one or more data processors, the set of candidate series data to add or remove past performance data for one or more products in the subgroup, such as where the filtered set of candidate series data forms a set of surrogate series data, such as where filtering includes facilitating a second structured judgment analysis in forming the set of surrogate series data, extracting, using the one or more data processors, a set of statistical modeling features from the set of surrogate series data, such as where extracting includes facilitating a third structured judgment analysis for forming the set of statistical modeling features, and generating, using the one or more data processors, a predicted performance for the new product, such as where generating includes generating a prediction function specification using the set of statistical modeling features extracted from the set of surrogate series data, such as where generating includes facilitating a fourth structured judgment analysis in generating the prediction function specification. Optionally, one or more graphical user interfaces are provided for one or more of the querying, filtering, extracting, or generating to facilitate structured judgment analysis in analyzing the predicted performance of the new product.

In another aspect, computer program products, such as non-transitory machine-readable storage media for predicting performance of a product are provided. In one embodiment, such a computer program product comprises instructions configured to cause a data processing system including one or more processors to perform operations including querying, using the one or more processors, a group of past products to identify a subgroup of products related to a new product, such as where each of the past products is associated with past performance data and product attribute data, such as where products in the subgroup share one or more product attributes with the new product, such as where the past performance data and the product attribute data for the products in the subgroup form a set of candidate series data, such as where querying includes facilitating a first structured judgment analysis in identification of the subgroup of products related to the new product, filtering, using the one or more processors, the set of candidate series data to add or remove past performance data for one or more products in the subgroup, such as where the filtered set of candidate series data forms a set of surrogate series data, such as where filtering includes facilitating a second structured judgment analysis in forming the set of surrogate series data, extracting, using the one or more processors, a set of statistical modeling features from the set of surrogate series data, such as where extracting includes facilitating a third structured judgment analysis for forming the set of statistical modeling features, and generating, using the one or more processors, a predicted performance for the new product, such as where generating includes generating a prediction function specification using the set of statistical modeling features extracted from the set of surrogate series data, such as where generating includes facilitating a fourth structured judgment analysis in generating the prediction function specification. Optionally, one or more graphical user interfaces are provided for one or more of the querying, filtering, extracting, or generating to facilitate structured judgment analysis in analyzing or generating the predicted performance of the new product.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

The present disclosure is described in conjunction with the appended figures:

FIG. 1 illustrates a block diagram that provides an illustration of the hardware components of a computing system, according to some embodiments of the present technology.

FIG. 2 illustrates an example network including an example set of devices communicating with each other over an exchange system and via a network, according to some embodiments of the present technology.

FIG. 3 illustrates a representation of a conceptual model of a communications protocol system, according to some embodiments of the present technology.

FIG. 4 illustrates a communications grid computing system including a variety of control and worker nodes, according to some embodiments of the present technology.

FIG. 5 illustrates a flow chart showing an example process for adjusting a communications grid or a work project in a communications grid after a failure of a node, according to some embodiments of the present technology.

FIG. 6 illustrates a portion of a communications grid computing system including a control node and a worker node, according to some embodiments of the present technology.

FIG. 7 illustrates a flow chart showing an example process for executing a data analysis or processing project, according to some embodiments of the present technology.

FIG. 8 illustrates a block diagram including components of an Event Stream Processing Engine (ESPE), according to embodiments of the present technology.

FIG. 9 illustrates a flow chart showing an example process performed by an event stream processing engine, according to some embodiments of the present technology.

FIG. 10 illustrates an ESP system interfacing between a publishing device and multiple event subscribing devices, according to embodiments of the present technology.

FIG. 11 is a block diagram depicting an environment wherein users can interact with a prediction system.

FIG. 12A is a block diagram illustrating an example system and method for performance prediction.

FIG. 12B is a block diagram illustrating analytic and judgmental steps performed in an example system and method for performance prediction.

FIG. 13 is a block diagram illustrating further detail of the process of structured judgment analysis.

FIG. 14 is a block diagram illustrating further detail of the process of combining statistics and judgment in an example system and method for performance prediction.

FIG. 15A, FIG. 15B, FIG. 15C, FIG. 15D, and FIG. 15E are graphs showing various representations of performance series data.

FIG. 16 is a block diagram illustrating an example method of deriving performance data.

FIG. 17 is a block diagram depicting further detail of the query step of an example method for performance prediction.

FIG. 18 is a dendrogram depicting information contained in the distance matrix of a cluster of performance series data.

FIG. 19A and FIG. 19B are graphs depicting cycle series data for different clusters generated from performance series data.

FIG. 20 is a block diagram depicting additional details of the filter step of an example method for performance prediction.

FIG. 21 is a graph depicting the predictions derived from a panel summary model.

FIG. 22 is a graph depicting the predictions derived from a profile series model.

FIG. 23 is a graph depicting the predictions derived from a cycle series model.

FIG. 24 is a block diagram depicting additional details of the model step of an example method for performance prediction.

FIG. 25 is a block diagram depicting additional details of the prediction step of an example method for performance prediction.

FIG. 26 is a block diagram depicting details about the overrides sub-step in a prediction step of an example method for performance prediction.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of embodiments of the technology. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the technology as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional operations not included in a figure. A process may correspond to a method, a function, a procedure, a subroutine, a subprogram, etc. When a process corresponds to a function, its termination can correspond to a return of the function to the calling function or the main function.

Systems depicted in some of the figures may be provided in various configurations. In some embodiments, the systems may be configured as a distributed system where one or more components of the system are distributed across one or more networks in a cloud computing system.

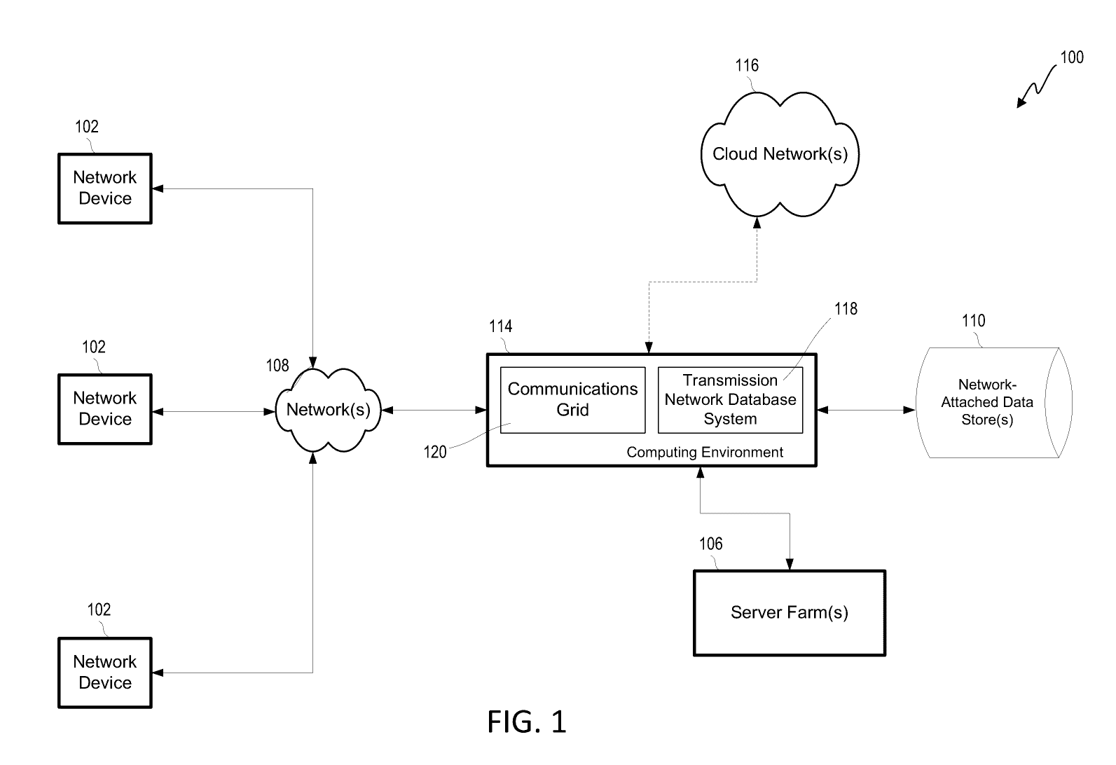

FIG. 1 is a block diagram that provides an illustration of the hardware components of a data transmission network 100, according to embodiments of the present technology. Data transmission network 100 is a specialized system that may be used for processing large amounts of data where a large number of processing cycles are required.

Data transmission network 100 may also include computing environment 114. Computing environment 114 may be a specialized or other machine that processes the data received within the data transmission network 100. Data transmission network 100 also includes one or more network devices 102. Network devices 102 may include client devices that attempt to communicate with computing environment 114. For example, network devices 102 may send data to the computing environment 114 to be processed, may send signals to the computing environment 114 to control different aspects of the computing environment or the data it is processing, among other reasons. Network devices 102 may interact with the computing environment 114 through a number of ways, such as, for example, over one or more networks 108. As shown in FIG. 1, computing environment 114 may include one or more other systems. For example, computing environment 114 may include a database system 118 and/or a communications grid 120.

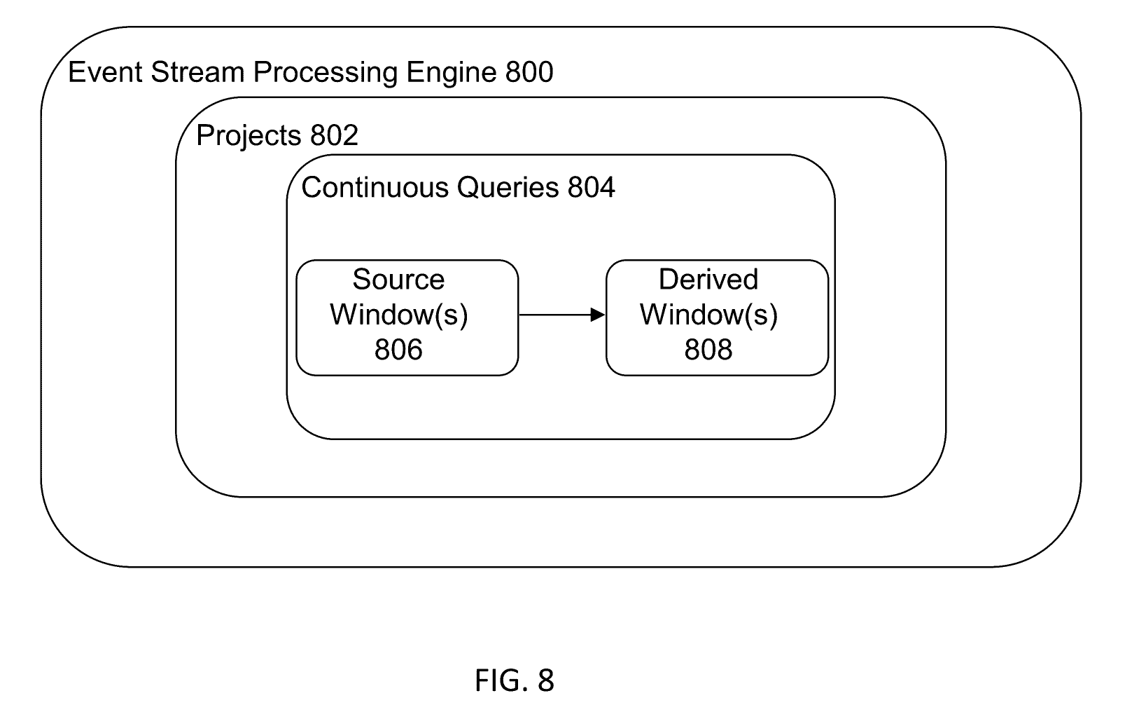

In other embodiments, network devices may provide a large amount of data, either all at once or streaming over an interval of time (e.g., using event stream processing (ESP), described further with respect to FIGS. 8-10), to the computing environment 114 via networks 108. For example, network devices 102 may include network computers, sensors, databases, or other devices that may transmit or otherwise provide data to computing environment 114. For example, network devices may include local area network devices, such as routers, hubs, switches, or other networking devices. These devices may provide a variety of stored or generated data, such as network data or data specific to the network devices themselves. Network devices may also include sensors that monitor their environment or other devices to collect data regarding that environment or those devices, and such network devices may provide data they collect over time. Network devices may also include devices within the internet of things, such as devices within a home automation network. Some of these devices may be referred to as edge devices, and may involve edge computing circuitry. Data may be transmitted by network devices directly to computing environment 114 or to network-attached data stores, such as network-attached data stores 110 for storage so that the data may be retrieved later by the computing environment 114 or other portions of data transmission network 100.

Data transmission network 100 may also include one or more network-attached data stores 110. Network-attached data stores 110 are used to store data to be processed by the computing environment 114 as well as any intermediate or final data generated by the computing system in non-volatile memory. However in certain embodiments, the configuration of the computing environment 114 allows its operations to be performed such that intermediate and final data results can be stored solely in volatile memory (e.g., RAM), without a requirement that intermediate or final data results be stored to non-volatile types of memory (e.g., disk). This can be useful in certain situations, such as when the computing environment 114 receives ad hoc queries from a user and when responses, which are generated by processing large amounts of data, need to be generated on-the-fly. In this non-limiting situation, the computing environment 114 may be configured to retain the processed information within memory so that responses can be generated for the user at different levels of detail as well as allow a user to interactively query against this information.

Network-attached data stores may store a variety of different types of data organized in a variety of different ways and from a variety of different sources. For example, network-attached data storage may include storage other than primary storage located within computing environment 114 that is directly accessible by processors located therein. Network-attached data storage may include secondary, tertiary or auxiliary storage, such as large hard drives, servers, virtual memory, among other types. Storage devices may include portable or non-portable storage devices, optical storage devices, and various other mediums capable of storing, containing data. A machine-readable storage medium or computer-readable storage medium may include a non-transitory medium in which data can be stored and that does not include carrier waves and/or transitory electronic signals. Examples of a non-transitory medium may include, for example, a magnetic disk or tape, optical storage media such as compact disk or digital versatile disk, flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. Furthermore, the data stores may hold a variety of different types of data. For example, network-attached data stores 110 may hold unstructured (e.g., raw) data, such as manufacturing data (e.g., a database containing records identifying objects being manufactured with parameter data for each object, such as colors and models) or object output databases (e.g., a database containing individual data records identifying details of individual object outputs/sales).

The unstructured data may be presented to the computing environment 114 in different forms such as a flat file or a conglomerate of data records, and may have data points and accompanying time stamps. The computing environment 114 may be used to analyze the unstructured data in a variety of ways to determine the best way to structure (e.g., hierarchically) that data, such that the structured data is tailored to a type of further analysis that a user wishes to perform on the data. For example, after being processed, the unstructured time stamped data may be aggregated by time (e.g., into daily time interval units) to generate time series data and/or structured hierarchically according to one or more dimensions (e.g., parameters, attributes, and/or variables). For example, data may be stored in a hierarchical data structure, such as a ROLAP OR MOLAP database, or may be stored in another tabular form, such as in a flat-hierarchy form.

Data transmission network 100 may also include one or more server farms 106. Computing environment 114 may route select communications or data to the one or more sever farms 106 or one or more servers within the server farms. Server farms 106 can be configured to provide information in a predetermined manner. For example, server farms 106 may access data to transmit in response to a communication. Server farms 106 may be separately housed from each other device within data transmission network 100, such as computing environment 114, and/or may be part of a device or system.

Server farms 106 may host a variety of different types of data processing as part of data transmission network 100. Server farms 106 may receive a variety of different data from network devices, from computing environment 114, from cloud network 116, or from other sources. The data may have been obtained or collected from one or more sensors, as inputs from a control database, or may have been received as inputs from an external system or device. Server farms 106 may assist in processing the data by turning raw data into processed data based on one or more rules implemented by the server farms. For example, sensor data may be analyzed to determine changes in an environment over time or in real-time.

Data transmission network 100 may also include one or more cloud networks 116. Cloud network 116 may include a cloud infrastructure system that provides cloud services. In certain embodiments, services provided by the cloud network 116 may include a host of services that are made available to users of the cloud infrastructure system as needed. Cloud network 116 is shown in FIG. 1 as being connected to computing environment 114 (and therefore having computing environment 114 as its client or user), but cloud network 116 may be connected to or utilized by any of the devices in FIG. 1. Services provided by the cloud network can dynamically scale to meet the needs of its users. The cloud network 116 may comprise one or more computers, servers, and/or systems. In some embodiments, the computers, servers, and/or systems that make up the cloud network 116 are different from the user's own on-premises computers, servers, and/or systems. For example, the cloud network 116 may host an application, and a user may, via a communication network such as the Internet, as needed, order and use the application.

While each device, server and system in FIG. 1 is shown as a single device, it will be appreciated that multiple devices may instead be used. For example, a set of network devices can be used to transmit various communications from a single user, or remote server 140 may include a server stack. As another example, data may be processed as part of computing environment 114.

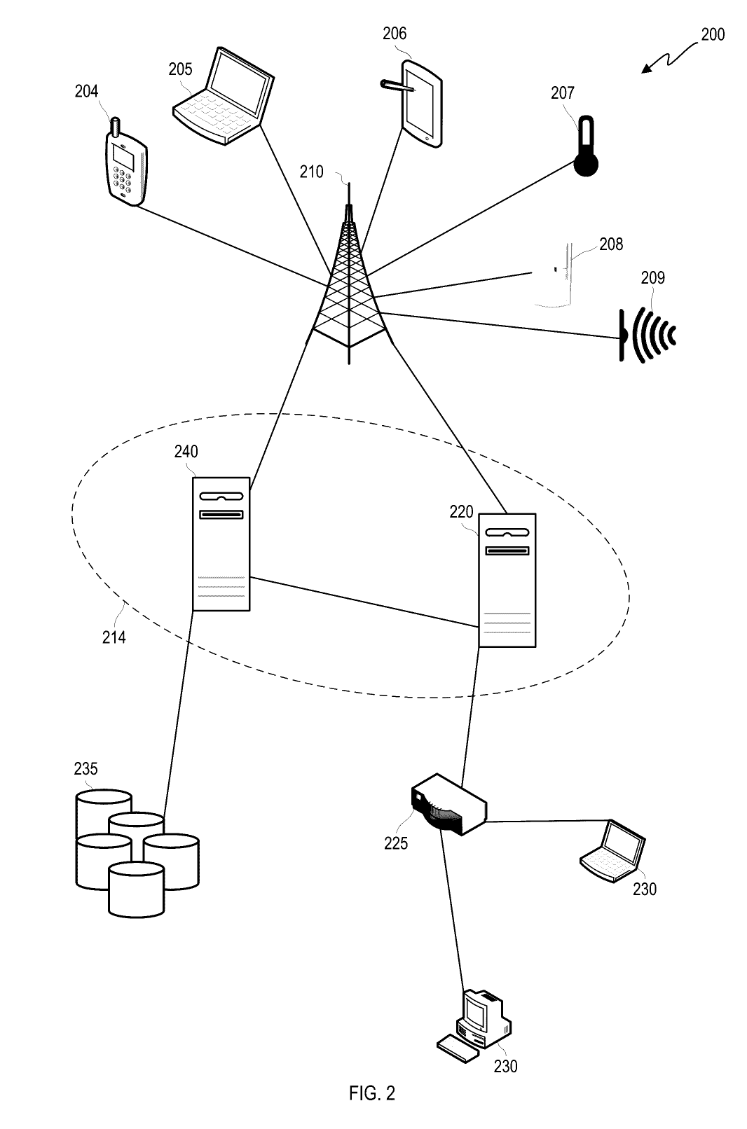

Each communication within data transmission network 100 (e.g., between client devices, between a device and connection system 150, between servers 106 and computing environment 114 or between a server and a device) may occur over one or more networks 108. Networks 108 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or combination of wireless interfaces. As an example, a network in the one or more networks 108 may include a short-range communication channel, such as a Bluetooth or a Bluetooth Low Energy channel. A wired network may include a wired interface. The wired and/or wireless networks may be implemented using routers, access points, bridges, gateways, or the like, to connect devices in the network 114, as will be further described with respect to FIG. 2. The one or more networks 108 can be incorporated entirely within or can include an intranet, an extranet, or a combination thereof. In one embodiment, communications between two or more systems and/or devices can be achieved by a secure communications protocol, such as secure sockets layer (SSL) or transport layer security (TLS). In addition, data and/or transactional details may be encrypted.

Some aspects may utilize the Internet of Things (IoT), where things (e.g., machines, devices, phones, sensors) can be connected to networks and the data from these things can be collected and processed within the things and/or external to the things. For example, the IoT can include sensors in many different devices, and relational analytics can be applied to identify hidden relationships and drive increased effectiveness. This can apply to both big data analytics and real-time (e.g., ESP) analytics. This will be described further below with respect to FIG. 2.

As noted, computing environment 114 may include a communications grid 120 and a transmission network database system 118. Communications grid 120 may be a grid-based computing system for processing large amounts of data. The transmission network database system 118 may be for managing, storing, and retrieving large amounts of data that are distributed to and stored in the one or more network-attached data stores 110 or other data stores that reside at different locations within the transmission network database system 118. The compute nodes in the grid-based computing system 120 and the transmission network database system 118 may share the same processor hardware, such as processors that are located within computing environment 114.

FIG. 2 illustrates an example network including an example set of devices communicating with each other over an exchange system and via a network, according to embodiments of the present technology. As noted, each communication within data transmission network 100 may occur over one or more networks. System 200 includes a network device 204 configured to communicate with a variety of types of client devices, for example client devices 230, over a variety of types of communication channels.

As shown in FIG. 2, network device 204 can transmit a communication over a network (e.g., a cellular network via a base station 210). The communication can be routed to another network device, such as network devices 205-209, via base station 210. The communication can also be routed to computing environment 214 via base station 210. For example, network device 204 may collect data either from its surrounding environment or from other network devices (such as network devices 205-209) and transmit that data to computing environment 214.

Although network devices 204-209 are shown in FIG. 2 as a mobile phone, laptop computer, tablet computer, temperature sensor, motion sensor, and audio sensor respectively, the network devices may be or include sensors that are sensitive to detecting aspects of their environment. For example, the network devices may include sensors such as water sensors, power sensors, electrical current sensors, chemical sensors, optical sensors, pressure sensors, geographic or position sensors (e.g., GPS), velocity sensors, acceleration sensors, flow rate sensors, among others. Examples of characteristics that may be sensed include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, electrical current, among others. The sensors may be mounted to various components used as part of a variety of different types of systems (e.g., an oil drilling operation). The network devices may detect and record data related to the environment that it monitors, and transmit that data to computing environment 214.

As noted, one type of system that may include various sensors that collect data to be processed and/or transmitted to a computing environment according to certain embodiments includes an oil drilling system. For example, the one or more drilling operation sensors may include surface sensors that measure a hook load, a fluid rate, a temperature and a density in and out of the wellbore, a standpipe pressure, a surface torque, a rotation speed of a drill pipe, a rate of penetration, a mechanical specific energy, etc. and downhole sensors that measure a rotation speed of a bit, fluid densities, downhole torque, downhole vibration (axial, tangential, lateral), a weight applied at a drill bit, an annular pressure, a differential pressure, an azimuth, an inclination, a dog leg severity, a measured depth, a vertical depth, a downhole temperature, etc. Besides the raw data collected directly by the sensors, other data may include parameters either developed by the sensors or assigned to the system by a client or other controlling device. For example, one or more drilling operation control parameters may control settings such as a mud motor speed to flow ratio, a bit diameter, a predicted formation top, seismic data, weather data, etc. Other data may be generated using physical models such as an earth model, a weather model, a seismic model, a bottom hole assembly model, a well plan model, an annular friction model, etc. In addition to sensor and control settings, predicted outputs, of for example, the rate of penetration, mechanical specific energy, hook load, flow in fluid rate, flow out fluid rate, pump pressure, surface torque, rotation speed of the drill pipe, annular pressure, annular friction pressure, annular temperature, equivalent circulating density, etc. may also be stored in the data warehouse.

In another example, another type of system that may include various sensors that collect data to be processed and/or transmitted to a computing environment according to certain embodiments includes a home automation or similar automated network in a different environment, such as an office space, school, public space, sports venue, or a variety of other locations. Network devices in such an automated network may include network devices that allow a user to access, control, and/or configure various home appliances located within the user's home (e.g., a television, radio, light, fan, humidifier, sensor, microwave, iron, and/or the like), or outside of the user's home (e.g., exterior motion sensors, exterior lighting, garage door openers, sprinkler systems, or the like). For example, network device 102 may include a home automation switch that may be coupled with a home appliance. In another embodiment, a network device can allow a user to access, control, and/or configure devices, such as office-related devices (e.g., copy machine, printer, or fax machine), audio and/or video related devices (e.g., a receiver, a speaker, a projector, a DVD player, or a television), media-playback devices (e.g., a compact disc player, a CD player, or the like), computing devices (e.g., a home computer, a laptop computer, a tablet, a personal digital assistant (PDA), a computing device, or a wearable device), lighting devices (e.g., a lamp or recessed lighting), devices associated with a security system, devices associated with an alarm system, devices that can be operated in an automobile (e.g., radio devices, navigation devices), and/or the like. Data may be collected from such various sensors in raw form, or data may be processed by the sensors to create parameters or other data either developed by the sensors based on the raw data or assigned to the system by a client or other controlling device.

In another example, another type of system that may include various sensors that collect data to be processed and/or transmitted to a computing environment according to certain embodiments includes a power or energy grid. A variety of different network devices may be included in an energy grid, such as various devices within one or more power plants, energy farms (e.g., wind farm, solar farm, among others) energy storage facilities, factories, and homes, among others. One or more of such devices may include one or more sensors that detect energy gain or loss, electrical input or output or loss, and a variety of other benefits. These sensors may collect data to inform users of how the energy grid, and individual devices within the grid, may be functioning and how they may be better utilized.

Network device sensors may also process data collected before transmitting the data to the computing environment 114, or before deciding whether to transmit data to the computing environment 114. For example, network devices may determine whether data collected meets certain rules, for example by comparing data or points calculated from the data and comparing that data to one or more thresholds. The network device may use this data and/or comparisons to determine if the data should be transmitted to the computing environment 214 for further use or processing.

Computing environment 214 may include machines 220 and 240. Although computing environment 214 is shown in FIG. 2 as having two machines, 220 and 240, computing environment 214 may have only one machine or may have more than two machines. The machines that make up computing environment 214 may include specialized computers, servers, or other machines that are configured to individually and/or collectively process large amounts of data. The computing environment 214 may also include storage devices that include one or more databases of structured data, such as data organized in one or more hierarchies, or unstructured data. The databases may communicate with the processing devices within computing environment 214 to distribute data to them. Since network devices may transmit data to computing environment 214, that data may be received by the computing environment 214 and subsequently stored within those storage devices. Data used by computing environment 214 may also be stored in data stores 235, which may also be a part of or connected to computing environment 214.

Computing environment 214 can communicate with various devices via one or more routers 225 or other inter-network or intra-network connection components. For example, computing environment 214 may communicate with devices 230 via one or more routers 225. Computing environment 214 may collect, analyze and/or store data from or pertaining to communications, client device operation, client rules, and/or user-associated actions stored at one or more data stores 235. Such data may influence communication routing to the devices within computing environment 214, how data is stored or processed within computing environment 214, among other actions.

Notably, various other devices can further be used to influence communication routing and/or processing between devices within computing environment 214 and with devices outside of computing environment 214. For example, as shown in FIG. 2, computing environment 214 may include a web server 240. Thus, computing environment 214 can retrieve data of interest, such as client information (e.g., object information, client rules, etc.), technical object details, news, current or predicted weather, and so on.

In addition to computing environment 214 collecting data (e.g., as received from network devices, such as sensors, and client devices or other sources) to be processed as part of a big data analytics project, it may also receive data in real time as part of a streaming analytics environment. As noted, data may be collected using a variety of sources as communicated via different kinds of networks or locally. Such data may be received on a real-time streaming basis. For example, network devices may receive data periodically from network device sensors as the sensors continuously sense, monitor and track changes in their environments. Devices within computing environment 214 may also perform pre-analysis on data it receives to determine if the data received should be processed as part of an ongoing project. The data received and collected by computing environment 214, no matter what the source or method or timing of receipt, may be processed over an interval of time for a client to determine results data based on the client's needs and rules.

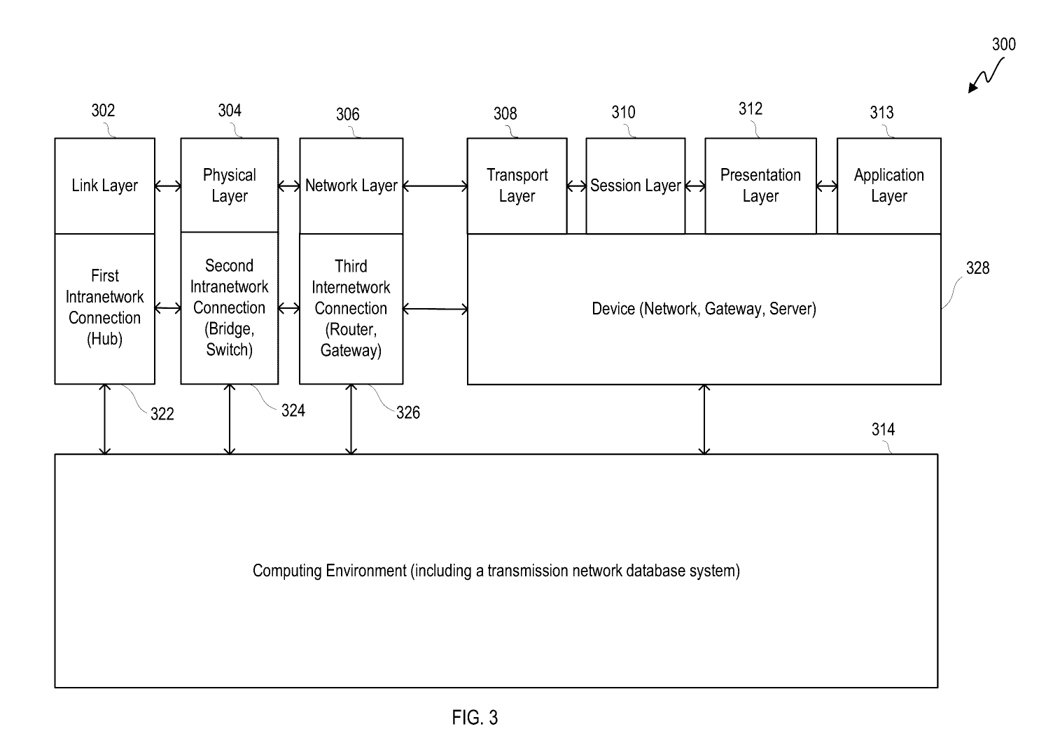

FIG. 3 illustrates a representation of a conceptual model of a communications protocol system, according to embodiments of the present technology. More specifically, FIG. 3 identifies operation of a computing environment in an Open Systems Interaction model that corresponds to various connection components. The model 300 shows, for example, how a computing environment, such as computing environment 314 (or computing environment 214 in FIG. 2) may communicate with other devices in its network, and control how communications between the computing environment and other devices are executed and under what conditions.

The model can include layers 302-313. The layers are arranged in a stack. Each layer in the stack serves the layer one level higher than it (except for the application layer, which is the highest layer), and is served by the layer one level below it (except for the physical layer, which is the lowest layer). The physical layer is the lowest layer because it receives and transmits raw bites of data, and is the farthest layer from the user in a communications system. On the other hand, the application layer is the highest layer because it interacts directly with an application.

As noted, the model includes a physical layer 302. Physical layer 302 represents physical communication, and can define parameters of that physical communication. For example, such physical communication may come in the form of electrical, optical, or electromagnetic signals. Physical layer 302 also defines protocols that may control communications within a data transmission network.

Link layer 304 defines links and mechanisms used to transmit (i.e., move) data across a network. The link layer handles node-to-node communications, such as within a grid computing environment. Link layer 304 can detect and correct errors (e.g., transmission errors in the physical layer 302). Link layer 304 can also include a media access control (MAC) layer and logical link control (LLC) layer.

Network layer 306 defines the protocol for routing within a network. In other words, the network layer coordinates transferring data across nodes in a same network (e.g., such as a grid computing environment). Network layer 306 can also define the processes used to structure local addressing within the network.

Transport layer 308 can handle the transmission of data and the quality of the transmission and/or receipt of that data. Transport layer 308 can provide a protocol for transferring data, such as, for example, a Transmission Control Protocol (TCP). Transport layer 308 can assemble and disassemble data frames for transmission. The transport layer can also detect transmission errors occurring in the layers below it.

Session layer 310 can establish, maintain, and handle communication connections between devices on a network. In other words, the session layer controls the dialogues or nature of communications between network devices on the network. The session layer may also establish checkpointing, adjournment, termination, and restart procedures.

Presentation layer 312 can provide translation for communications between the application and network layers. In other words, this layer may encrypt, decrypt and/or format data based on data types known to be accepted by an application or network layer.

Application layer 313 interacts directly with applications and end users, and handles communications between them. Application layer 313 can identify destinations, local resource states or availability and/or communication content or formatting using the applications.

Intra-network connection components 322 and 324 are shown to operate in lower levels, such as physical layer 302 and link layer 304, respectively. For example, a hub can operate in the physical layer, a switch can operate in the physical layer, and a router can operate in the network layer. Inter-network connection components 326 and 328 are shown to operate on higher levels, such as layers 306-313. For example, routers can operate in the network layer and network devices can operate in the transport, session, presentation, and application layers.

As noted, a computing environment 314 can interact with and/or operate on, in various embodiments, one, more, all or any of the various layers. For example, computing environment 314 can interact with a hub (e.g., via the link layer) so as to adjust which devices the hub communicates with. The physical layer may be served by the link layer, so it may implement such data from the link layer. For example, the computing environment 314 may control which devices it will receive data from. For example, if the computing environment 314 knows that a certain network device has turned off, broken, or otherwise become unavailable or unreliable, the computing environment 314 may instruct the hub to prevent any data from being transmitted to the computing environment 314 from that network device. Such a process may be beneficial to avoid receiving data that is inaccurate or that has been influenced by an uncontrolled environment. As another example, computing environment 314 can communicate with a bridge, switch, router or gateway and influence which device within the system (e.g., system 200) the component selects as a destination. In some embodiments, computing environment 314 can interact with various layers by exchanging communications with equipment operating on a particular layer by routing or modifying existing communications. In another embodiment, such as in a grid computing environment, a node may determine how data within the environment should be routed (e.g., which node should receive certain data) based on certain parameters or information provided by other layers within the model.

As noted, the computing environment 314 may be a part of a communications grid environment, the communications of which may be implemented as shown in the protocol of FIG. 3. For example, referring back to FIG. 2, one or more of machines 220 and 240 may be part of a communications grid computing environment. A gridded computing environment may be employed in a distributed system with non-interactive workloads where data resides in memory on the machines, or compute nodes. In such an environment, analytic code, instead of a database management system (DBMS), controls the processing performed by the nodes. Data is co-located by pre-distributing it to the grid nodes, and the analytic code on each node loads the local data into memory. Each node may be assigned a particular task such as a portion of a processing project, or to organize or control other nodes within the grid.

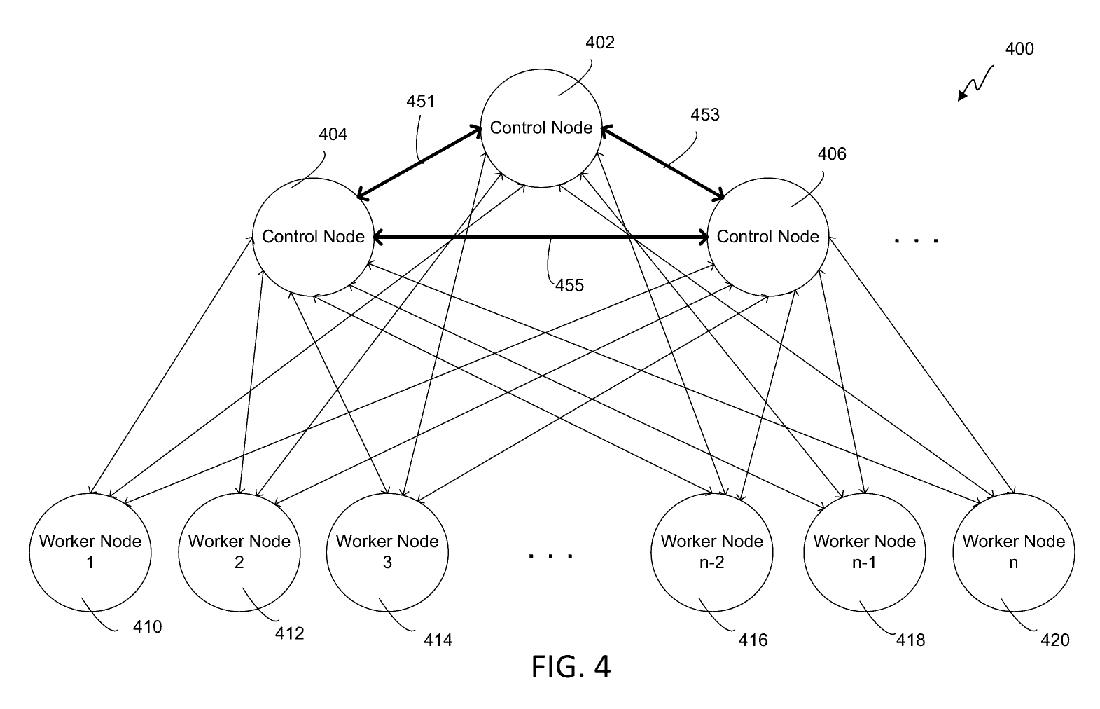

FIG. 4 illustrates a communications grid computing system 400 including a variety of control and worker nodes, according to embodiments of the present technology. Communications grid computing system 400 includes three control nodes and one or more worker nodes. Communications grid computing system 400 includes control nodes 402, 404, and 406. The control nodes are communicatively connected via communication paths 451, 453, and 455. Therefore, the control nodes may transmit information (e.g., related to the communications grid or notifications), to and receive information from each other. Although communications grid computing system 400 is shown in FIG. 4 as including three control nodes, the communications grid may include more or less than three control nodes.

Communications grid computing system (or just “communications grid”) 400 also includes one or more worker nodes. Shown in FIG. 4 are six worker nodes 410-420. Although FIG. 4 shows six worker nodes, a communications grid according to embodiments of the present technology may include more or less than six worker nodes. The number of worker nodes included in a communications grid may be dependent upon how large the project or data set is being processed by the communications grid, the capacity of each worker node, the time designated for the communications grid to complete the project, among others. Each worker node within the communications grid 400 may be connected (wired or wirelessly, and directly or indirectly) to control nodes 402-406. Therefore, each worker node may receive information from the control nodes (e.g., an instruction to perform work on a project) and may transmit information to the control nodes (e.g., a result from work performed on a project). Furthermore, worker nodes may communicate with each other (either directly or indirectly). For example, worker nodes may transmit data between each other related to a job being performed or an individual task within a job being performed by that worker node. However, in certain embodiments, worker nodes may not, for example, be connected (communicatively or otherwise) to certain other worker nodes. In an embodiment, worker nodes may only be able to communicate with the control node that controls it, and may not be able to communicate with other worker nodes in the communications grid, whether they are other worker nodes controlled by the control node that controls the worker node, or worker nodes that are controlled by other control nodes in the communications grid.

A control node may connect with an external device with which the control node may communicate (e.g., a grid user, such as a server or computer, may connect to a controller of the grid). For example, a server may connect to control nodes and may transmit a project or job to the node. The project may include a data set. The data set may be of any size. Once the control node receives such a project including a large data set, the control node may distribute the data set or projects related to the data set to be performed by worker nodes. Alternatively, for a project including a large data set, the data set may be receive or stored by a machine other than a control node (e.g., a Hadoop data node).

Control nodes may maintain knowledge of the status of the nodes in the grid (i.e., grid status information), accept work requests from clients, subdivide the work across worker nodes, coordinate the worker nodes, among other responsibilities. Worker nodes may accept work requests from a control node and provide the control node with results of the work performed by the worker node. A grid may be started from a single node (e.g., a machine, computer, server, etc.). This first node may be assigned or may start as the primary control node that will control any additional nodes that enter the grid.

When a project is submitted for execution (e.g., by a client or a controller of the grid) it may be assigned to a set of nodes. After the nodes are assigned to a project, a data structure (i.e., a communicator) may be created. The communicator may be used by the project for information to be shared between the project code running on each node. A communication handle may be created on each node. A handle, for example, is a reference to the communicator that is valid within a single process on a single node, and the handle may be used when requesting communications between nodes.

A control node, such as control node 402, may be designated as the primary control node. A server or other external device may connect to the primary control node. Once the control node receives a project, the primary control node may distribute portions of the project to its worker nodes for execution. For example, when a project is initiated on communications grid 400, primary control node 402 controls the work to be performed for the project in order to complete the project as requested or instructed. The primary control node may distribute work to the worker nodes based on various factors, such as which subsets or portions of projects may be completed most effectively and in the correct amount of time. For example, a worker node may perform analysis on a portion of data that is already local (e.g., stored on) the worker node. The primary control node also coordinates and processes the results of the work performed by each worker node after each worker node executes and completes its job. For example, the primary control node may receive a result from one or more worker nodes, and the control node may organize (e.g., collect and assemble) the results received and compile them to produce a complete result for the project received from the end user.

Any remaining control nodes, such as control nodes 404 and 406, may be assigned as backup control nodes for the project. In an embodiment, backup control nodes may not control any portion of the project. Instead, backup control nodes may serve as a backup for the primary control node and take over as primary control node if the primary control node were to fail. If a communications grid were to include only a single control node, and the control node were to fail (e.g., the control node is shut off or breaks) then the communications grid as a whole may fail and any project or job being run on the communications grid may fail and may not complete. While the project may be run again, such a failure may cause a delay (severe delay in some cases, such as overnight delay) in completion of the project. Therefore, a grid with multiple control nodes, including a backup control node, may be beneficial.

To add another node or machine to the grid, the primary control node may open a pair of listening sockets, for example. A socket may be used to accept work requests from clients, and the second socket may be used to accept connections from other grid nodes). The primary control node may be provided with a list of other nodes (e.g., other machines, servers) that will participate in the grid, and the role that each node will fill in the grid. Upon startup of the primary control node (e.g., the first node on the grid), the primary control node may use a network protocol to start the server process on every other node in the grid. Command line parameters, for example, may inform each node of one or more pieces of information, such as: the role that the node will have in the grid, the host name of the primary control node, the port number on which the primary control node is accepting connections from peer nodes, among others. The information may also be provided in a configuration file, transmitted over a secure shell tunnel, recovered from a configuration server, among others. While the other machines in the grid may not initially know about the configuration of the grid, that information may also be sent to each other node by the primary control node. Updates of the grid information may also be subsequently sent to those nodes.

For any control node other than the primary control node added to the grid, the control node may open three sockets. The first socket may accept work requests from clients, the second socket may accept connections from other grid members, and the third socket may connect (e.g., permanently) to the primary control node. When a control node (e.g., primary control node) receives a connection from another control node, it first checks to see if the peer node is in the list of configured nodes in the grid. If it is not on the list, the control node may clear the connection. If it is on the list, it may then attempt to authenticate the connection. If authentication is successful, the authenticating node may transmit information to its peer, such as the port number on which a node is listening for connections, the host name of the node, information about how to authenticate the node, among other information. When a node, such as the new control node, receives information about another active node, it will check to see if it already has a connection to that other node. If it does not have a connection to that node, it may then establish a connection to that control node.

Any worker node added to the grid may establish a connection to the primary control node and any other control nodes on the grid. After establishing the connection, it may authenticate itself to the grid (e.g., any control nodes, including both primary and backup, or a server or user controlling the grid). After successful authentication, the worker node may accept configuration information from the control node.

When a node joins a communications grid (e.g., when the node is powered on or connected to an existing node on the grid or both), the node is assigned (e.g., by an operating system of the grid) a universally unique identifier (UUID). This unique identifier may help other nodes and external entities (devices, users, etc.) to identify the node and distinguish it from other nodes. When a node is connected to the grid, the node may share its unique identifier with the other nodes in the grid. Since each node may share its unique identifier, each node may know the unique identifier of every other node on the grid. Unique identifiers may also designate a hierarchy of each of the nodes (e.g., backup control nodes) within the grid. For example, the unique identifiers of each of the backup control nodes may be stored in a list of backup control nodes to indicate an order in which the backup control nodes will take over for a failed primary control node to become a new primary control node. However, a hierarchy of nodes may also be determined using methods other than using the unique identifiers of the nodes. For example, the hierarchy may be predetermined, or may be assigned based on other predetermined factors.

The grid may add new machines at any time (e.g., initiated from any control node). Upon adding a new node to the grid, the control node may first add the new node to its table of grid nodes. The control node may also then notify every other control node about the new node. The nodes receiving the notification may acknowledge that they have updated their configuration information.

Primary control node 402 may, for example, transmit one or more communications to backup control nodes 404 and 406 (and, for example, to other control or worker nodes within the communications grid). Such communications may sent periodically, at fixed time intervals, between known fixed stages of the project's execution, among other protocols. The communications transmitted by primary control node 402 may be of varied types and may include a variety of types of information. For example, primary control node 402 may transmit snapshots (e.g., status information) of the communications grid so that backup control node 404 always has a recent snapshot of the communications grid. The snapshot or grid status may include, for example, the structure of the grid (including, for example, the worker nodes in the grid, unique identifiers of the nodes, or their relationships with the primary control node) and the status of a project (including, for example, the status of each worker node's portion of the project). The snapshot may also include analysis or results received from worker nodes in the communications grid. The backup control nodes may receive and store the backup data received from the primary control node. The backup control nodes may transmit a request for such a snapshot (or other information) from the primary control node, or the primary control node may send such information periodically to the backup control nodes.

As noted, the backup data may allow the backup control node to take over as primary control node if the primary control node fails without requiring the grid to start the project over from scratch. If the primary control node fails, the backup control node that will take over as primary control node may retrieve the most recent version of the snapshot received from the primary control node and use the snapshot to continue the project from the stage of the project indicated by the backup data. This may prevent failure of the project as a whole.

A backup control node may use various methods to determine that the primary control node has failed. In one example of such a method, the primary control node may transmit (e.g., periodically) a communication to the backup control node that indicates that the primary control node is working and has not failed, such as a heartbeat communication. The backup control node may determine that the primary control node has failed if the backup control node has not received a heartbeat communication for a certain predetermined interval of time. Alternatively, a backup control node may also receive a communication from the primary control node itself (before it failed) or from a worker node that the primary control node has failed, for example because the primary control node has failed to communicate with the worker node.

Different methods may be performed to determine which backup control node of a set of backup control nodes (e.g., backup control nodes 404 and 406) will take over for failed primary control node 402 and become the new primary control node. For example, the new primary control node may be chosen based on a ranking or “hierarchy” of backup control nodes based on their unique identifiers. In an alternative embodiment, a backup control node may be assigned to be the new primary control node by another device in the communications grid or from an external device (e.g., a system infrastructure or an end user, such as a server, controlling the communications grid). In another alternative embodiment, the backup control node that takes over as the new primary control node may be designated based on bandwidth or other statistics about the communications grid.

A worker node within the communications grid may also fail. If a worker node fails, work being performed by the failed worker node may be redistributed amongst the operational worker nodes. In an alternative embodiment, the primary control node may transmit a communication to each of the operable worker nodes still on the communications grid that each of the worker nodes should purposefully fail also. After each of the worker nodes fail, they may each retrieve their most recent saved checkpoint of their status and re-start the project from that checkpoint to minimize lost progress on the project being executed.

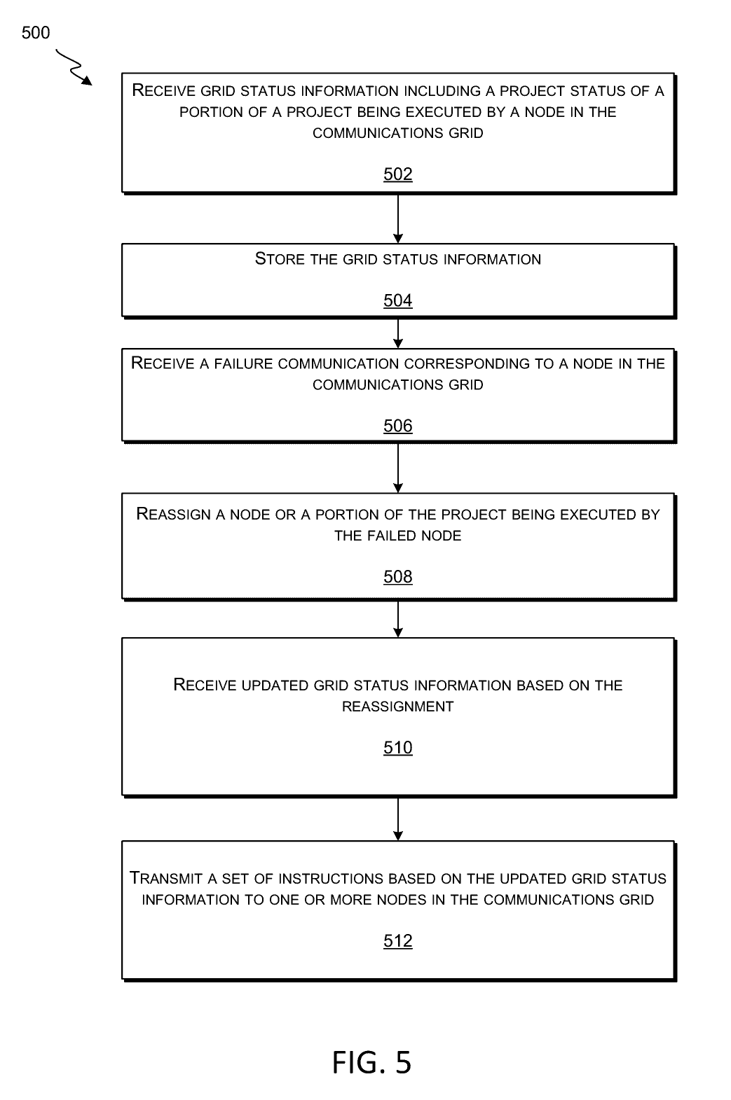

FIG. 5 illustrates a flow chart showing an example process for adjusting a communications grid or a work project in a communications grid after a failure of a node, according to embodiments of the present technology. The process may include, for example, receiving grid status information including a project status of a portion of a project being executed by a node in the communications grid, as described in operation 502. For example, a control node (e.g., a backup control node connected to a primary control node and a worker node on a communications grid) may receive grid status information, where the grid status information includes a project status of the primary control node or a project status of the worker node. The project status of the primary control node and the project status of the worker node may include a status of one or more portions of a project being executed by the primary and worker nodes in the communications grid. The process may also include storing the grid status information, as described in operation 504. For example, a control node (e.g., a backup control node) may store the received grid status information locally within the control node. Alternatively, the grid status information may be sent to another device for storage where the control node may have access to the information.

The process may also include receiving a failure communication corresponding to a node in the communications grid in operation 506. For example, a node may receive a failure communication including an indication that the primary control node has failed, prompting a backup control node to take over for the primary control node. In an alternative embodiment, a node may receive a failure that a worker node has failed, prompting a control node to reassign the work being performed by the worker node. The process may also include reassigning a node or a portion of the project being executed by the failed node, as described in operation 508. For example, a control node may designate the backup control node as a new primary control node based on the failure communication upon receiving the failure communication. If the failed node is a worker node, a control node may identify a project status of the failed worker node using the snapshot of the communications grid, where the project status of the failed worker node includes a status of a portion of the project being executed by the failed worker node at the failure time.

The process may also include receiving updated grid status information based on the reassignment, as described in operation 510, and transmitting a set of instructions based on the updated grid status information to one or more nodes in the communications grid, as described in operation 512. The updated grid status information may include an updated project status of the primary control node or an updated project status of the worker node. The updated information may be transmitted to the other nodes in the grid to update their stale stored information.

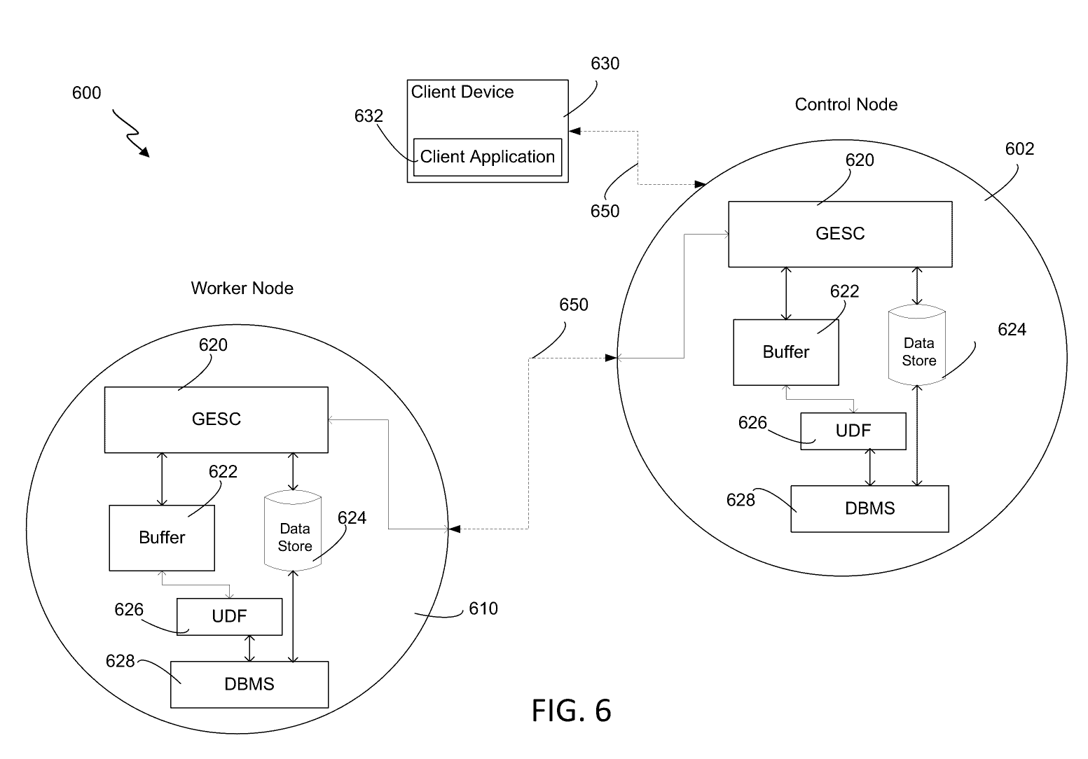

FIG. 6 illustrates a portion of a communications grid computing system 600 including a control node and a worker node, according to embodiments of the present technology. Communications grid 600 computing system includes one control node (control node 602) and one worker node (worker node 610) for purposes of illustration, but may include more worker and/or control nodes. The control node 602 is communicatively connected to worker node 610 via communication path 650. Therefore, control node 602 may transmit information (e.g., related to the communications grid or notifications), to and receive information from worker node 610 via path 650.

Similar to in FIG. 4, communications grid computing system (or just “communications grid”) 600 includes data processing nodes (control node 602 and worker node 610). Nodes 602 and 610 comprise multi-core data processors. Each node 602 and 610 includes a grid-enabled software component (GESC) 620 that executes on the data processor associated with that node and interfaces with buffer memory 622 also associated with that node. Each node 602 and 610 includes a DBMS 628 that executes on a database server (not shown) at control node 602 and on a database server (not shown) at worker node 610.

Each node also includes a data store 624. Data stores 624, similar to network-attached data stores 110 in FIG. 1 and data stores 235 in FIG. 2, are used to store data to be processed by the nodes in the computing environment. Data stores 624 may also store any intermediate or final data generated by the computing system after being processed, for example in non-volatile memory. However in certain embodiments, the configuration of the grid computing environment allows its operations to be performed such that intermediate and final data results can be stored solely in volatile memory (e.g., RAM), without a requirement that intermediate or final data results be stored to non-volatile types of memory. Storing such data in volatile memory may be useful in certain situations, such as when the grid receives queries (e.g., ad hoc) from a client and when responses, which are generated by processing large amounts of data, need to be generated quickly or on-the-fly. In such a situation, the grid may be configured to retain the data within memory so that responses can be generated at different levels of detail and so that a client may interactively query against this information.

Each node also includes a user-defined function (UDF) 626. The UDF provides a mechanism for the DMBS 628 to transfer data to or receive data from the database stored in the data stores 624 that are handled by the DBMS. For example, UDF 626 can be invoked by the DBMS to provide data to the GESC for processing. The UDF 626 may establish a socket connection (not shown) with the GESC to transfer the data. Alternatively, the UDF 626 can transfer data to the GESC by writing data to shared memory accessible by both the UDF and the GESC.

The GESC 620 at the nodes 602 and 620 may be connected via a network, such as network 108 shown in FIG. 1. Therefore, nodes 602 and 620 can communicate with each other via the network using a predetermined communication protocol such as, for example, the Message Passing Interface (MPI). Each GESC 620 can engage in point-to-point communication with the GESC at another node or in collective communication with multiple GESCs via the network. The GESC 620 at each node may contain identical (or nearly identical) instructions. Each node may be capable of operating as either a control node or a worker node. The GESC at the control node 602 can communicate, over a communication path 652, with a client deice 630. More specifically, control node 602 may communicate with client application 632 hosted by the client device 630 to receive queries and to respond to those queries after processing large amounts of data.

DMBS 628 may control the creation, maintenance, and use of database or data structure (not shown) within a nodes 602 or 610. The database may organize data stored in data stores 624. The DMBS 628 at control node 602 may accept requests for data and transfer the appropriate data for the request. With such a process, collections of data may be distributed across multiple physical locations. In this example, each node 602 and 610 stores a portion of the total data handled in the associated data store 624.

Furthermore, the DBMS may be responsible for protecting against data loss using replication techniques. Replication includes providing a backup copy of data stored on one node on one or more other nodes. Therefore, if one node fails, the data from the failed node can be recovered from a replicated copy residing at another node. However, as described herein with respect to FIG. 4, data or status information for each node in the communications grid may also be shared with each node on the grid.

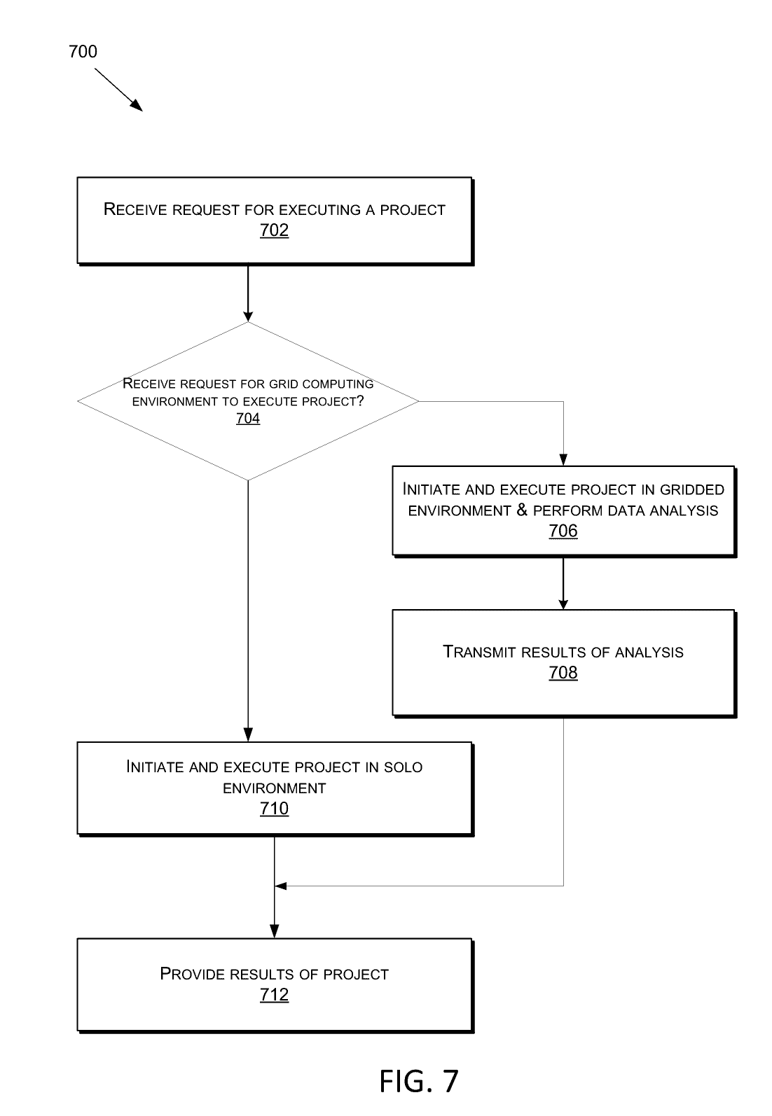

FIG. 7 illustrates a flow chart showing an example method for executing a project within a grid computing system, according to embodiments of the present technology. As described with respect to FIG. 6, the GESC at the control node may transmit data with a client device (e.g., client device 630) to receive queries for executing a project and to respond to those queries after large amounts of data have been processed. The query may be transmitted to the control node, where the query may include a request for executing a project, as described in operation 702. The query can contain instructions on the type of data analysis to be performed in the project and whether the project should be executed using the grid-based computing environment, as shown in operation 704.

To initiate the project, the control node may determine if the query requests use of the grid-based computing environment to execute the project. If the determination is no, then the control node initiates execution of the project in a solo environment (e.g., at the control node), as described in operation 710. If the determination is yes, the control node may initiate execution of the project in the grid-based computing environment, as described in operation 706. In such a situation, the request may include a requested configuration of the grid. For example, the request may include a number of control nodes and a number of worker nodes to be used in the grid when executing the project. After the project has been completed, the control node may transmit results of the analysis yielded by the grid, as described in operation 708. Whether the project is executed in a solo or grid-based environment, the control node provides the results of the project.

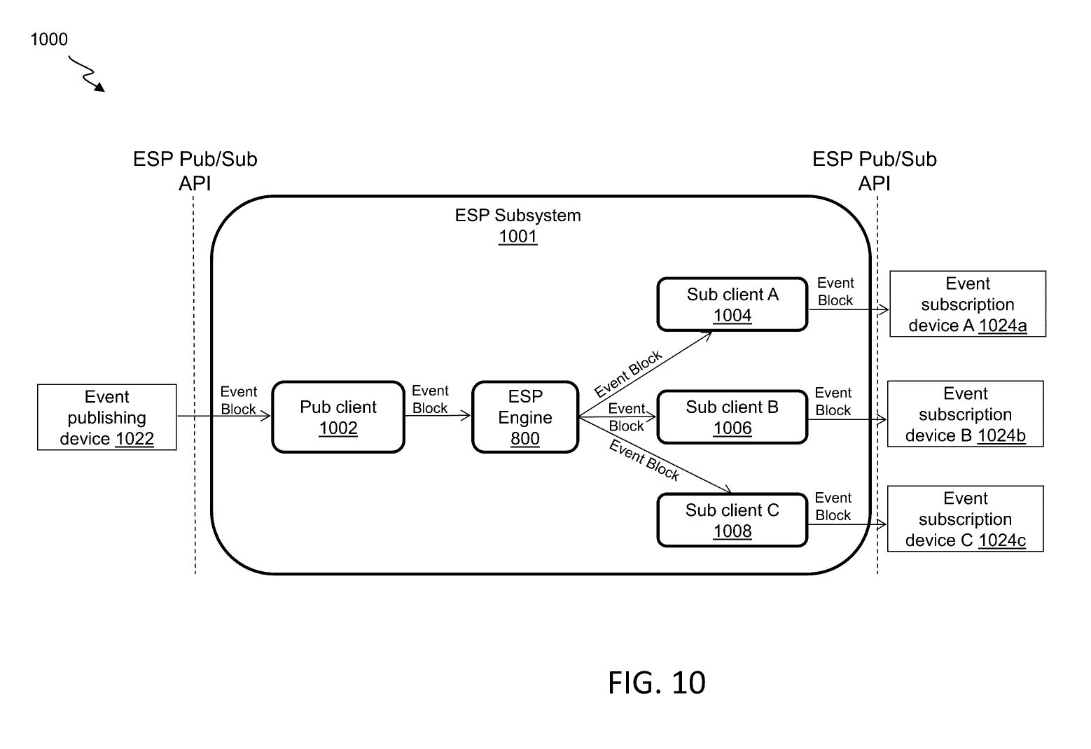

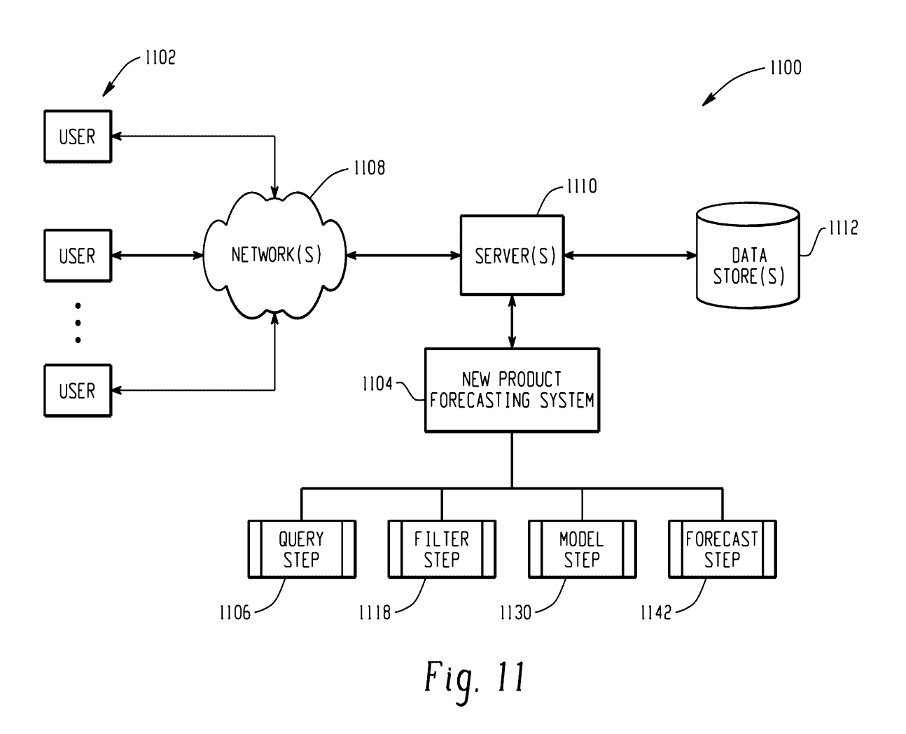

As noted with respect to FIG. 2, the computing environments described herein may collect data (e.g., as received from network devices, such as sensors, such as network devices 204-209 in FIG. 2, and client devices or other sources) to be processed as part of a data analytics project, and data may be received in real time as part of a streaming analytics environment (e.g., ESP). Data may be collected using a variety of sources as communicated via different kinds of networks or locally, such as on a real-time streaming basis. For example, network devices may receive data periodically from network device sensors as the sensors continuously sense, monitor and track changes in their environments. More specifically, an increasing number of distributed applications develop or produce continuously flowing data from distributed sources by applying queries to the data before distributing the data to geographically distributed recipients. An event stream processing engine (ESPE) may continuously apply the queries to the data as it is received and determines which entities should receive the data. Client or other devices may also subscribe to the ESPE or other devices processing ESP data so that they can receive data after processing, based on for example the entities determined by the processing engine. For example, client devices 230 in FIG. 2 may subscribe to the ESPE in computing environment 214. In another example, event subscription devices 1024a-c, described further with respect to FIG. 10, may also subscribe to the ESPE. The ESPE may determine or define how input data or event streams from network devices or other publishers (e.g., network devices 204-209 in FIG. 2) are transformed into meaningful output data to be consumed by subscribers, such as for example client devices 230 in FIG. 2.

FIG. 8 illustrates a block diagram including components of an Event Stream Processing Engine (ESPE), according to embodiments of the present technology. ESPE 800 may include one or more projects 802. A project may be described as a second-level container in an engine model handled by ESPE 800 where a thread pool size for the project may be defined by a user. Each project of the one or more projects 802 may include one or more continuous queries 804 that contain data flows, which are data transformations of incoming event streams. The one or more continuous queries 804 may include one or more source windows 806 and one or more derived windows 808.

The ESPE may receive streaming data over an interval of time related to certain events, such as events or other data sensed by one or more network devices. The ESPE may perform operations associated with processing data created by the one or more devices. For example, the ESPE may receive data from the one or more network devices 204-209 shown in FIG. 2. As noted, the network devices may include sensors that sense different aspects of their environments, and may collect data over time based on those sensed observations. For example, the ESPE may be implemented within one or more of machines 220 and 240 shown in FIG. 2. The ESPE may be implemented within such a machine by an ESP application. An ESP application may embed an ESPE with its own dedicated thread pool or pools into its application space where the main application thread can do application-specific work and the ESPE processes event streams at least by creating an instance of a model into processing objects.

The engine container is the top-level container in a model that handles the resources of the one or more projects 802. In an illustrative embodiment, for example, there may be only one ESPE 800 for each instance of the ESP application, and ESPE 800 may have a unique engine name. Additionally, the one or more projects 802 may each have unique project names, and each query may have a unique continuous query name and begin with a uniquely named source window of the one or more source windows 806. ESPE 800 may or may not be persistent.

Continuous query modeling involves defining directed graphs of windows for event stream manipulation and transformation. A window in the context of event stream manipulation and transformation is a processing node in an event stream processing model. A window in a continuous query can perform aggregations, computations, pattern-matching, and other techniques on data flowing through the window. A continuous query may be described as a directed graph of source, relational, pattern matching, and procedural windows. The one or more source windows 806 and the one or more derived windows 808 represent continuously executing queries that generate updates to a query result set as new event blocks stream through ESPE 800. A directed graph, for example, is a set of nodes connected by edges, where the edges have a direction associated with them.

An event object may be described as a packet of data accessible as a collection of fields, with at least one of the fields defined as a key or unique identifier (ID). The event object may be created using a variety of formats including binary, alphanumeric, WL, etc. Each event object may include one or more fields designated as a primary identifier (ID) for the event so ESPE 800 can support operation codes (opcodes) for events including insert, update, upsert, and delete. Upsert opcodes update the event if the key field already exists; otherwise, the event is inserted. For illustration, an event object may be a packed binary representation of a set of field data points and include both metadata and field data associated with an event. The metadata may include an opcode indicating if the event represents an insert, update, delete, or upsert, a set of flags indicating if the event is a normal, partial-update, or a retention generated event from retention policy handling, and a set of microsecond timestamps that can be used for latency measurements.

An event block object may be described as a grouping or package of event objects. An event stream may be described as a flow of event block objects. A continuous query of the one or more continuous queries 804 transforms a source event stream made up of streaming event block objects published into ESPE 800 into one or more output event streams using the one or more source windows 806 and the one or more derived windows 808. A continuous query can also be thought of as data flow modeling.

The one or more source windows 806 are at the top of the directed graph and have no windows feeding into them. Event streams are published into the one or more source windows 806, and from there, the event streams may be directed to the next set of connected windows as defined by the directed graph. The one or more derived windows 808 are all instantiated windows that are not source windows and that have other windows streaming events into them.

The one or more derived windows 808 may perform computations or transformations on the incoming event streams. The one or more derived windows 808 transform event streams based on the window type (that is operators such as join, filter, compute, aggregate, copy, pattern match, procedural, union, etc.) and window settings. As event streams are published into ESPE 800, they are continuously queried, and the resulting sets of derived windows in these queries are continuously updated.

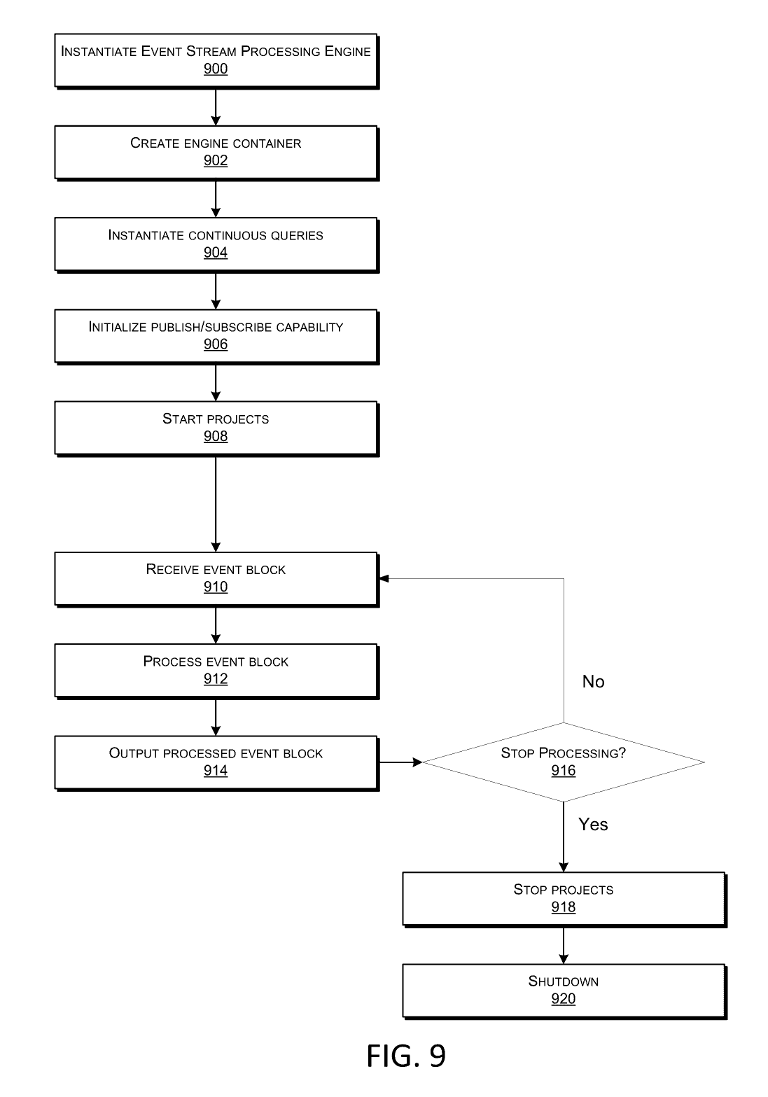

FIG. 9 illustrates a flow chart showing an example process of an event stream processing engine, according to some embodiments of the present technology. As noted, the ESPE 800 (or an associated ESP application) defines how input event streams are transformed into meaningful output event streams. More specifically, the ESP application may define how input event streams from publishers (e.g., network devices providing sensed data) are transformed into meaningful output event streams consumed by subscribers (e.g., a data analytics project being executed by a machine or set of machines).

Within the application, a user may interact with one or more user interface windows presented to the user in a display under control of the ESPE independently or through a browser application in an order selectable by the user. For example, a user may execute an ESP application, which causes presentation of a first user interface window, which may include a plurality of menus and selectors such as drop down menus, buttons, text boxes, hyperlinks, etc. associated with the ESP application as understood by a person of skill in the art. As further understood by a person of skill in the art, various operations may be performed in parallel, for example, using a plurality of threads.

At operation 900, an ESP application may define and start an ESPE, thereby instantiating an ESPE at a device, such as machine 220 and/or 240. In an operation 902, the engine container is created. For illustration, ESPE 800 may be instantiated using a function call that specifies the engine container as a handler for the model.

In an operation 904, the one or more continuous queries 804 are instantiated by ESPE 800 as a model. The one or more continuous queries 804 may be instantiated with a dedicated thread pool or pools that generate updates as new events stream through ESPE 800. For illustration, the one or more continuous queries 804 may be created to model business processing logic within ESPE 800, to predict events within ESPE 800, to model a physical system within ESPE 800, to predict the physical system state within ESPE 800, etc. For example, as noted, ESPE 800 may be used to support sensor data monitoring and handling (e.g., sensing may include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, or electrical current, etc.).

ESPE 800 may analyze and process events in motion or “event streams.” Instead of storing data and running queries against the stored data, ESPE 800 may store queries and stream data through them to allow continuous analysis of data as it is received. The one or more source windows 806 and the one or more derived windows 808 may be created based on the relational, pattern matching, and procedural algorithms that transform the input event streams into the output event streams to model, simulate, score, test, predict, etc. based on the continuous query model defined and application to the streamed data.

In an operation 906, a publish/subscribe (pub/sub) capability is initialized for ESPE 800. In an illustrative embodiment, a pub/sub capability is initialized for each project of the one or more projects 802. To initialize and enable pub/sub capability for ESPE 800, a port number may be provided. Pub/sub clients can use a host name of an ESP device running the ESPE and the port number to establish pub/sub connections to ESPE 800.

FIG. 10 illustrates an ESP system 1000 interfacing between publishing device 1022 and event subscribing devices 1024a-c, according to embodiments of the present technology. ESP system 1000 may include ESP device or subsystem 1001, event publishing device 1022, an event subscribing device A 1024a, an event subscribing device B 1024b, and an event subscribing device C 1024c. Input event streams are output to ESP device 1001 by publishing device 1022. In alternative embodiments, the input event streams may be created by a plurality of publishing devices. The plurality of publishing devices further may publish event streams to other ESP devices. The one or more continuous queries instantiated by ESPE 800 may analyze and process the input event streams to form output event streams output to event subscribing device A 1024a, event subscribing device B 1024b, and event subscribing device C 1024c. ESP system 1000 may include a greater or a fewer number of event subscribing devices of event subscribing devices.

Publish-subscribe is a message-oriented interaction paradigm based on indirect addressing. Processed data recipients specify their interest in receiving information from ESPE 800 by subscribing to specific classes of events, while information sources publish events to ESPE 800 without directly addressing the receiving parties. ESPE 800 coordinates the interactions and processes the data. In some cases, the data source receives confirmation that the published information has been received by a data recipient.

A publish/subscribe API may be described as a library that enables an event publisher, such as publishing device 1022, to publish event streams into ESPE 800 or an event subscriber, such as event subscribing device A 1024a, event subscribing device B 1024b, and event subscribing device C 1024c, to subscribe to event streams from ESPE 800. For illustration, one or more publish/subscribe APIs may be defined. Using the publish/subscribe API, an event publishing application may publish event streams into a running event stream processor project source window of ESPE 800, and the event subscription application may subscribe to an event stream processor project source window of ESPE 800.

The publish/subscribe API provides cross-platform connectivity and endianness compatibility between ESP application and other networked applications, such as event publishing applications instantiated at publishing device 1022, and event subscription applications instantiated at one or more of event subscribing device A 1024a, event subscribing device B 1024b, and event subscribing device C 1024c.

Referring back to FIG. 9, operation 906 initializes the publish/subscribe capability of ESPE 800. In an operation 908, the one or more projects 802 are started. The one or more started projects may run in the background on an ESP device. In an operation 910, an event block object is received from one or more computing device of the event publishing device 1022.

ESP subsystem 800 may include a publishing client 1002, ESPE 800, a subscribing client A 1004, a subscribing client B 1006, and a subscribing client C 1008. Publishing client 1002 may be started by an event publishing application executing at publishing device 1022 using the publish/subscribe API. Subscribing client A 1004 may be started by an event subscription application A, executing at event subscribing device A 1024a using the publish/subscribe API. Subscribing client B 1006 may be started by an event subscription application B executing at event subscribing device B 1024b using the publish/subscribe API. Subscribing client C 1008 may be started by an event subscription application C executing at event subscribing device C 1024c using the publish/subscribe API.

An event block object containing one or more event objects is injected into a source window of the one or more source windows 806 from an instance of an event publishing application on event publishing device 1022. The event block object may generated, for example, by the event publishing application and may be received by publishing client 1002. A unique ID may be maintained as the event block object is passed between the one or more source windows 806 and/or the one or more derived windows 808 of ESPE 800, and to subscribing client A 1004, subscribing client B 806, and subscribing client C 808 and to event subscription device A 1024a, event subscription device B 1024b, and event subscription device C 1024c. Publishing client 1002 may further generate and include a unique embedded transaction ID in the event block object as the event block object is processed by a continuous query, as well as the unique ID that publishing device 1022 assigned to the event block object.

In an operation 912, the event block object is processed through the one or more continuous queries 804. In an operation 914, the processed event block object is output to one or more computing devices of the event subscribing devices 1024a-c. For example, subscribing client A 804, subscribing client B 806, and subscribing client C 808 may send the received event block object to event subscription device A 1024a, event subscription device B 1024b, and event subscription device C 1024c, respectively.

ESPE 800 maintains the event block containership aspect of the received event blocks from when the event block is published into a source window and works its way through the directed graph defined by the one or more continuous queries 804 with the various event translations before being output to subscribers. Subscribers can correlate a group of subscribed events back to a group of published events by comparing the unique ID of the event block object that a publisher, such as publishing device 1022, attached to the event block object with the event block ID received by the subscriber.

In an operation 916, a determination is made concerning whether or not processing is stopped. If processing is not stopped, processing continues in operation 910 to continue receiving the one or more event streams containing event block objects from the, for example, one or more network devices. If processing is stopped, processing continues in an operation 918. In operation 918, the started projects are stopped. In operation 920, the ESPE is shutdown.

As noted, in some embodiments, big data is processed for an analytics project after the data is received and stored. In other embodiments, distributed applications process continuously flowing data in real-time from distributed sources by applying queries to the data before distributing the data to geographically distributed recipients. As noted, an event stream processing engine (ESPE) may continuously apply the queries to the data as it is received and determines which entities receive the processed data. This allows for large amounts of data being received and/or collected in a variety of environments to be processed and distributed in real time. For example, as shown with respect to FIG. 2, data may be collected from network devices that may include devices within the internet of things, such as devices within a home automation network. However, such data may be collected from a variety of different resources in a variety of different environments. In any such situation, embodiments of the present technology allow for real-time processing of such data.

Aspects of the current disclosure provide technical solutions to technical problems, such as computing problems that arise when an ESP device fails which results in a complete service interruption and potentially significant data loss. The data loss can be catastrophic when the streamed data is supporting mission critical operations such as those in support of an ongoing manufacturing or drilling operation. An embodiment of an ESP system achieves a rapid and seamless failover of ESPE running at the plurality of ESP devices without service interruption or data loss, thus significantly improving the reliability of an operational system that relies on the live or real-time processing of the data streams. The event publishing systems, the event subscribing systems, and each ESPE not executing at a failed ESP device are not aware of or effected by the failed ESP device. The ESP system may include thousands of event publishing systems and event subscribing systems. The ESP system keeps the failover logic and awareness within the boundaries of out-messaging network connector and out-messaging network device.

In one example embodiment, a system is provided to support a failover when event stream processing (ESP) event blocks. The system includes, but is not limited to, an out-messaging network device and a computing device. The computing device includes, but is not limited to, a processor and a machine-readable medium operably coupled to the processor. The processor is configured to execute an ESP engine (ESPE). The machine-readable medium has instructions stored thereon that, when executed by the processor, cause the computing device to support the failover. An event block object is received from the ESPE that includes a unique identifier. A first status of the device as active or standby is determined. When the first status is active, a second status of the computing device as newly active or not newly active is determined. Newly active is determined when the computing device is switched from a standby status to an active status. When the second status is newly active, a last published event block object identifier that uniquely identifies a last published event block object is determined. A next event block object is selected from a non-transitory machine-readable medium accessible by the computing device. The next event block object has an event block object identifier that is greater than the determined last published event block object identifier. The selected next event block object is published to an out-messaging network device. When the second status of the computing device is not newly active, the received event block object is published to the out-messaging network device. When the first status of the computing device is standby, the received event block object is stored in the non-transitory machine-readable medium.

In various embodiments, systems, methods, and products of the invention are used to predict performance of a new product when it is first introduced. U.S. patent application Ser. No. 12/036,782, filed on Feb. 25, 2008, which is hereby incorporated by reference in its entirety for all purposes, discloses useful systems, methods, and products for predicting performance of new products.

FIG. 11 depicts at 1100 an environment wherein users 1102 can interact with a prediction system 1104 that is configured to provide predictions for new products. In embodiments, the terms “prediction” and “predict,” as used herein, may be considered synonymous with the term “forecast.” The users 1102 can interact with the new product prediction system 1104 through a number of ways, such as over one or more networks 1108. Server(s) 1110 accessible through the network(s) 1108 can host the system 1104, and one or more data stores 1112 can store the data to be analyzed by the system 1104 as well as any intermediate or final data generated by the system 1104.

The system 1104 allows for predicting the performance of a product that will be introduced, released, or launched. The prediction by system 1104 is based on a statistical model or models that are derived from a set of past performance data for products previously introduced. To help accomplish the prediction based upon a set past performance data, the prediction system 1104 uses a series of steps to help obtain, refine, and ultimately utilize the past data and/or a derivation thereof to provide performance predictions for a new product. In one embodiment, the series of steps can include a query step 1106, filter step 1118, model step 1130, and prediction step 1142, wherein each step further can include both analytical substeps and judgmental substeps.

For example, a query step 1106 can allow a user to specify attributes of a new product that will be used to identify those products that have been previously introduced and which are most similar to the new product. The analytical substeps of the query step 1106 may involve the application of a defined query to the past data set that generates a subset of performance data for a group of products ostensibly similar to the new product. The judgment substeps of the query step 1106 then may involve the user, or a proxy for the user, such as stored decision programs encapsulating the user's decision processes, exploring the results produced in the analytical substeps and further refining, through addition or removal of performance data, the subset of the past data set.

In a filter step 1118, the user can specify a statistical filtering methodology to be applied to the subset of the past data set. Examples of such methodologies may include clustering methods, reduction transformations, and distance measures. The analytical substeps of the filter step 1118 again can involve the automated application of the user-produced specification to the input data (in this example, the subset of the past data set), which generates a surrogate data set. The judgmental substeps of the filter step 1118 than may involve the user, or the user's proxy, exploring the surrogate data set and further refining the data contained therein.

In a model step 1130, the user can specify an analytical input, for example a model specification, which identifies one or more modeling techniques the user wishes to be carried out in the analytical substeps of the model step 1130. Examples of such modeling techniques may include growth curves, neural networks, and diffusion models. The application of the model specification to the surrogate data results in a model data set. In the judgmental substeps of the model step 1130, the user, or the user's proxy, may explore the output of the analytical substeps in order to refine the composition of the model data set.

In a prediction step 1142, the user can generate a prediction specification, which describes the timing of the release of the new product. The prediction specification then may be used in the analytical substeps to adjust the data in the model data set for timing considerations, such as seasonal effects on a product's performance. The output of the analytical substeps of the prediction step 1142 is a prediction data set. As in the other judgmental substeps, the user or the user's proxy may explore the prediction data set in order to ensure that the prediction data are as accurate and relevant as possible, such that the prediction generated for the new product will prove as useful as possible. The output of the prediction step 1142 is a prediction function specification that then may be used to predict the performance of the new product upon its introduction, release, or launch.

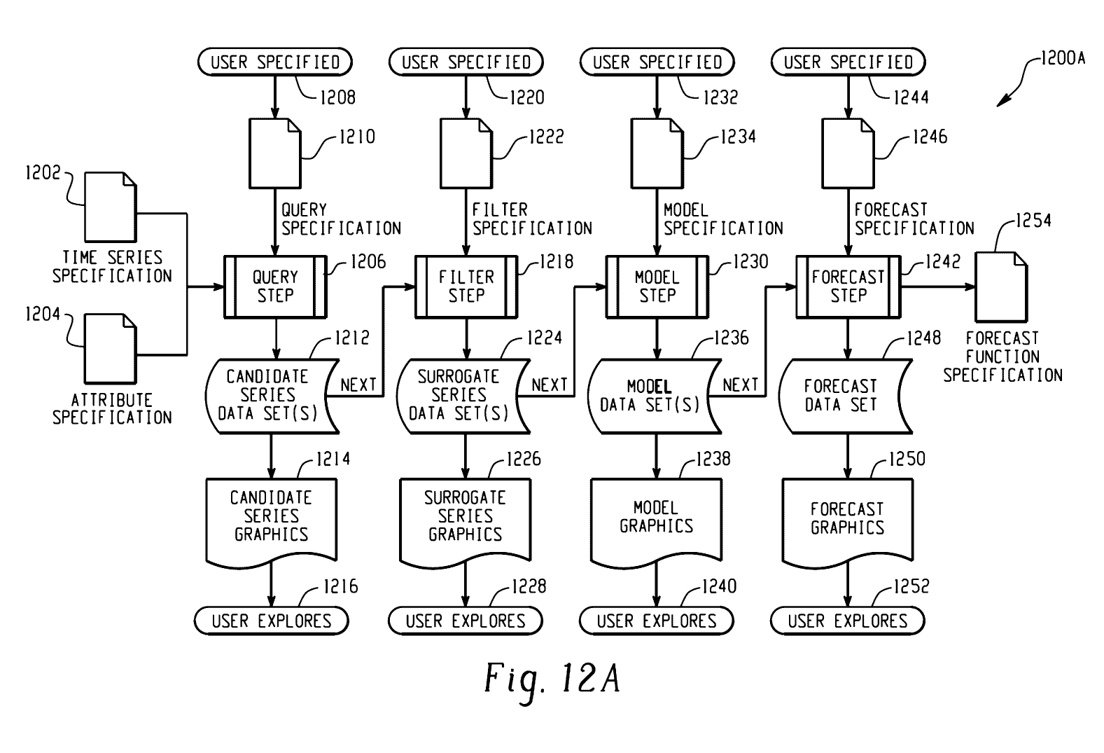

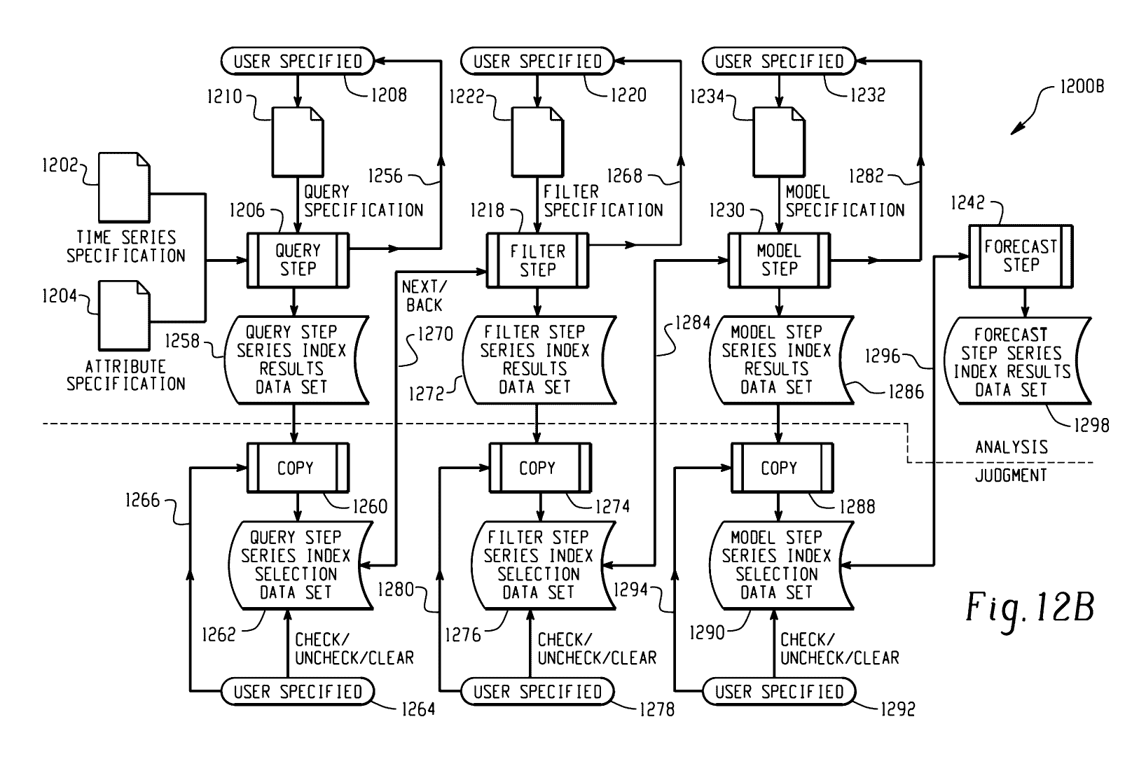

FIG. 12A provides additional details of a way to implement a query step 1206, filter step 1218, model step 1230, and prediction step 1242 in order to predict the performance of a product to be introduced. With respect to FIG. 12A, processing for the system begins with time series specification 1202 and attribute specification 1204 being provided to the system 1200A. The time series specification 1202 includes time series data regarding the past performance of a product. For example, in the case of a motion picture, one such time series data might include the gross weekly receipts derived from entry tickets to screenings of the motion picture at movie theaters in the United States. Another set of time series data could include the gross weekly receipts derived from entry tickets to screenings of the motion picture at movie theaters in Europe, or more generally, gross weekly receipts in all countries outside the United States. In another example, the time series data could include the gross daily receipts derived from entry tickets to screenings of the motion picture. These receipts, too, could be represented on any time basis, including daily, weekly, or monthly, and they could include amounts derived at any geographical granularity, from particular regions, locations, or areas with a single country, to individual countries, regions, or the entire world.

The attribute specification 1204 includes information about attributes of the product whose past performance data was included in the time series specification 1202. In the motion picture example, the attribute specification 1204 could include data such as the title of the motion picture, the date on which the picture was released, the genre of the motion picture (e.g., drama, comedy, or horror), the content rating assigned to the motion picture in one or more countries or regions (e.g., the rating assigned by the Motion Picture Association of America), the amount spent promoting the motion picture, the running time of the motion picture, and the primary language spoken in the soundtrack of the motion picture. All of this data is related to a particular product, which may be related to one or more time series specifications 1202 containing data about the past performance of the product.

Query step 1206 takes as input the time series specification 1202 and attribute specification 1204 and filters the data contained in the specifications to identify the data most likely to be relevant to predicting the performance of the new product. At 1208, a user specifies the query specification 1210, which also is input to the query step 1206. The query specification 1210 identifies attributes of the new product that the user considers important to identifying previously introduced products that are similar to the new product. In addition, the specification may include values for the attributes identified by the user, where the values can be used to ensure that products that satisfy the elements of the query specification are sufficiently similar to the new product for their past performance data to be relevant to the generation of a prediction for the new product. The values specified for the attributes chosen by the user may be discrete or continuous.

Once the user has generated query specification 1210, the query step 1206 applies the query specification 1210 to the overall set of past performance data. The overall set optimally contains past performance data for all products that have previously been introduced into the area in which the new product will be introduced, but a complete set is not necessary to the operation of the system. As an alternative, the past performance data may include data for products that have previously been introduced into areas that are similar to that in which the new product will be introduced. For example, a company considering the introduction of a new food product may have past performance data only for the United States, but the company might consider the Canadian or British food products to be similar enough to the U.S. that the past data from the U.S. could be used to create a new product prediction for Canada or the U.K. The result of applying the query specification 1210 to the overall set of past performance data is one or more candidate series data sets 1212, each of which is a set of past performance data for products with attributes that satisfied the conditions of the query specification 1210. Once they are included in the data set 1212, time series of past performance data are referred to herein as candidate series.

The data in candidate series data set 1212 is presented through a set of candidate series graphics 1214. The use of candidate series graphics 1214 simplifies the process of a user exploring the candidate series data, as shown at 1216. The user explores the data in order to apply the user's judgment to the inclusion of each of the candidate series in later stages of the new product prediction process. In addition, the candidate series graphics 1214 may permit the user to override the generated results of the query step 1206 and include as candidate series additional time series of past performance data for products that were not identified through query step 1206 as matching the criteria in query specification 1210, but which the user feels are similar products that could improve the accuracy of the prediction process. As the user revises the candidate series data set 1212, the candidate series graphics 1214 are continually updated, thereby permitting the user to monitor graphically the data included in the data set 1212. This further facilitates the user's inclusion of the most relevant candidate series data in the data set 1212.

In an alternative approach to the query step, the identification of past performance data is provided by third-party software, such as Oracle or Teradata, which may be pre-existing parts of the product vendor's prediction efforts. In yet another alternative approach, the query step is omitted entirely, and the candidate series data set 1212 is provided directly by the user to commence the prediction process.

Once the user is satisfied with the data included in the candidate series data set 1212, the system 1200A proceeds to the filter step 1218. The candidate series data set 1212 is input to the filter step 1218. The filter step 1218 removes from the input candidate series data set 1212 those candidate series that are outliers with respect to the set of candidate series. If done properly, filtering the input data set 1212 in this way should result in a data set containing series data related to products that are more similar to the new product than the group of products represented by the input data set 1212. For this purpose, at 1220 the user generates filter specification 1222. A partial list of filters that the user may choose to use in the filter specification 1222 includes reduction transformations, similarity measures, distance measures, clustering methods, and other rules. Also, these filters may be used individually or in combinations. For example, if a user wishes to predict the performance of a new motion picture to be released, the user could specify that an exponential decay model be used to reduce each input data. The user could further specify that, once the reduction is complete, the reduced data should be clustered, and the largest cluster could be selected on the assumption that it is the most representative cluster.

Applying the filter specification 1222 to the input data set 1212 results in the creation of surrogate series data set 1224. Each data included in data set 1224 now is referred to as a surrogate series. As was the case during the query step 1206 with the candidate series data set 1212, in filter step 1218, once the surrogate series data set 1224 is generated, the surrogate series graphics 1226 may be employed by the user, as shown at 1228, to explore the data included in data set 1224. The user explores the data in order to apply the user's judgment to the question of whether each of the surrogate series in the data set 1224 should be included in later stages of the new product prediction process. Further, the user may apply additional transformations to the data in the data set 1224, and the user also has the option to include additional data in the surrogate series data 1224 should the user believe that the additional data will be useful to the further stages of the prediction process.

It is noted that there is not a single accepted term in the field to represent data such as those included in surrogate series data set 1224. Those skilled in the art also may use similar terms, such as “analogy.”

If the user has chosen to apply a clustering method to the surrogate series, then the exploration and revising of the surrogate series data set 1224 by the user may be done at the cluster level instead of the surrogate series level. Thus, in such an instance, the surrogate series graphics 1226 would present cluster information to the user, rather than surrogate series information, and the user could select a cluster or clusters of surrogate series to remove from the data set 1224 or the user could add an additional cluster or clusters of surrogate series to the data set 1224.

Once the surrogate series data set 1224 has been revised as needed by the user, the system proceeds to the model step 1230, in which the surrogate series data set 1224 serves as an input. Model step 1230 extracts statistical features from the input data set 1224. Because the input data set 1224 includes performance data for those previously introduced products that are relatively highly similar to the new product, statistical features extracted from the input data set 1224 may be useful in predicting the performance of the new product.

In addition, at 1232, the user specifies a model specification 1234. A partial list of modeling techniques the user may incorporate in the specification 1234 of the statistical model includes diffusion models, growth curves, neural networks, mixed models, and smoothing models. In addition, the statistical model can model the components of each series separately, and other rules also may applied at this step. In the example of the introduction of a new motion picture, the user could choose to include in the model specification 1234 a model that decomposes the surrogate series into the total quantity series and the profile series. Then, the profile series can be modeled using a pooled smoothing technique and the total quantity can be modeled by the sample mean.

Once the user has specified the model specification 1234, the model is fitted to the input data set 1224 and the desired statistical features are extracted based on the model. The features thus extracted are included in one or more model data sets 1236 and are used to compute pooled predictions for the set of surrogate series. Once the predictions are computed, prediction errors may be computed and evaluated for each surrogate series. In the example of introducing a new motion picture, the predicted profile series can be computed from the set of surrogate profile series, while the predicted total quantity can be computed from the mean of the surrogate total quantities. The predicted profile series and predicted total quantity then can be combined to form a prediction for the pool of surrogate cycle series.

After generating the model data set 1236, the user may make use of the model graphics 1238 to visually explore at 1240 the model data set 1236. The user may explore the surrogate series data from which the statistical features were extracted, as well as pooled model results and individual model results (i.e., model results for each surrogate series). In the motion picture example, the user might wish to explore the individual surrogate series model predictions and/or the prediction error evaluation statistics, examples of which can include root mean square error (RMSE), mean absolute percentage error (MAPE), and AIC. Based upon the user's exploration of the model data set 1236, the user may apply his or her judgment to remove additional surrogate series from the remaining set of surrogate series data. For example, the user may determine from reviewing the model graphics 1238 that there is a poor fit between the performance data for one of the previously released motion pictures and the model predictions, and the user then may decide to remove the performance series data associated with that motion picture from the surrogate series data set.

Once the model data set 1236 has been revised as needed by the user, the system proceeds to the prediction step 1242, in which the model data set 1236 serves as an input. Prediction step 1242 uses the pooled predictions associated with the features extracted from the set of surrogate series. Also, in this step, the model predictions are adjusted to take into account the fact that predictions for the performance of products newly introduced are connected to a particular time period and season, whereas the past performance data (provided it is sufficiently large) represents times throughout the year. Correcting for this is performed because the failure to do so may lead to skewed results. For example, a motion picture that is a family comedy may perform better if it is released at a time when most children are not attending school or during the holiday season. If, however, the new motion picture for which the prediction is to be created is a comedy intended for an audience that does not include children and it is planned for release at a time when children are in school, the performance series data for the family motion picture may be skewed towards a different time period, which could affect the overall reliability of the prediction for the new product.

In addition to the model data set, at 1244 the user specifies a prediction specification 1246 as an additional input into the prediction step 1242. The prediction specification 1246 describes the timing of the release of the new product. After the prediction specification 1246 is specified by the user, the model predictions for the new product are compensated for timing considerations. The result is the prediction data set 1248, which the prediction graphics 1250 facilitate visual exploration by the user 1252. The user may apply his or her judgment to determine that one or more of the model predictions should be overridden. For example, with the release of a new motion picture, the user may adjust the total receipts predicted to be derived from tickets, or he or she may hold constant the total receipts to be derived from tickets while adjusting the percentage of the total predicted to be derived during particular time periods. Once the user has applied his or her judgment to the prediction data set 1248 and is satisfied with the predictions it contains, the prediction step 1242 ends, outputting a prediction function specification 1254. The prediction function specification 1254 is used to generate a prediction for the performance of the new product.

FIG. 12B depicts the operations of a new product prediction system 1200B that have been delineated according to whether the steps are analytic steps or judgmental steps, where judgmental steps represent the optional intervention of a human user to apply the user's judgment to one or more aspects of system 1200B.

Query step 1206 takes as input time series specification 1202 and attribute specification 1204. In addition, a user specifies at 1208 a query specification 1210, which identifies attributes and values for attributes that define what products the user considers similar to the new product for purposes of creating a prediction model. Query specification 1210 is an additional input to query step 1206. Query step 1206 applies query specification 1210 to an overall set of past performance data. As shown at 1256, the user may modify the query specification 1210 if, in the user's judgment, revised attributes and/or values would result in a more accurate selection of similar products from the overall set of past performance data. Once the user is satisfied that query specification 1210 will select the most accurate subset of the overall set of past performance data, the query specification 1210 is applied to the overall set of past performance data to produce query step series index results data set 1258, which is saved in order to permit the user to revisit query step 1206 at a later point in method 1200B and make further adjustments to query specification 1210 or data set 1258.

Once the data set 1258 has been saved, it is copied at 1260 to query step series index selection data set 1262. Data set 1262 also is saved, after which the user may apply judgment modifications to data set 1262, as shown at 1264, including selecting or deselecting one or more of the product data present in data set 1262. The saving of data set 1262 permits the resetting of any judgment modifications applied to data set 1262, as shown at 1266. If the user decides to make use of the reset option to undo the judgment modifications to the data set 1262, data set 1262 is returned to the saved version of data set 1258. The saved version of data set 1258 is copied again at 1260, thereby resetting data set 1262. When the user has completed any judgment modifications to and/or resetting of data set 1262, data set 1262 becomes an input to filter step 1218.

Filter step 1218 takes as input the data set 1262 generated as a result of the query step 1206 and optionally modified by the user. Also, at 1220, the user specifies a filter specification 1222, which indicates which of the available filters should be applied to the data set generated in the query step 1206. The filters may be used individually or in combinations. The primary goal of filter step 1218 is to remove from input data set 208 those products that are statistically least similar to the new product. Once filter specification 1222 has been applied to input data set 1262, the user may review the results and decide to modify the filter specification, as depicted at 1268.

Also, as shown at 1270, at any point where the user is performing the filter step 1218 of method 1200B, the user may decide to return, or go back, from the filter step 1218 to the modification of data set 1262 within the context of the judgment aspects of query step 1206. This may be done, for example, if the user realizes upon seeing the results of the application of filter specification 1222 to input data set 1262 that one or more product data that were removed from data set 1262 should have been included, or that one or more product data that were included in data set 1262 should have been removed. If the user exercises this option, then once the necessary modifications to data set 1262 are complete, the system returns to filter step 1218, where the user may re-specify a filter specification 1222.

Once the user is satisfied that filter specification 1222 includes the most appropriate statistical filter(s), filter specification 1222 is applied to input data set 1262, which results in the creation of filter step series index results data set 1272. Data set 1272 is saved in order to permit revisiting of the analytic aspects of filter step 1218 later in system 1200B. Once data set 1272 has been saved, it is copied at 1274 to filter step series index selection data set 1276. At this point, as shown at 1278, the user may apply judgment modifications to data set 1276, including selecting product data to remove or include in data set 1276. If during the judgment aspects of filter step 1218, the user decides that it would be preferable to undo any judgment modifications to data set 1276, the reset option 1280 is available to the user. Use of reset option 1280 causes data set 1276 to be reverted to the version of data set 1272 that was saved previously, and the saved version of data set 1272 is copied again at 1274, thus resetting data set 1276. When the user has completed any judgment modifications to and/or resetting of data set 1276, data set 1276 becomes an input to model step 1230.

Model step 1230 takes as input the data set 1276 generated as a result of filter step 1218. Also, the user specifies at 1232 a model specification 1234, which specifies which modeling techniques the user believes should be used within method 1200B to extract statistical features from input data set 1276. Model step 1230 applies model specification 1232 to input data set 1276. As shown at 1282, the user may modify the model specification 1234 if, in the user's judgment, the results of applying the initial model specification are somehow unsatisfactory. Also, as shown at 1284, at any point where the user is performing model step 1230, the user may decide to return, or go back, from model step 1230 to the modification of data set 1276 within the context of the judgment aspects of filter step 1218. Once the user is content with model specification 1234, it is applied to input data set 1276 to create model step series index results data set 1286. Data set 1286 is saved in order to permit revisiting of the analytic aspects of model step 1230 later in method 1200B.

After data set 1286 is saved, it is copied at 1288 to model step series index selection data set 1290. As shown at 1292, the user may apply judgment to data set 1290 in order to ensure that the modeling characteristics contained in data set 1290 will produce an accurate prediction with respect to performance of the new product. The user has the option to reset 1294 the judgment modifications made to data set 1290, which causes data set 1290 to revert to the version of data set 1286 that was saved and copied initially at 1288 to data set 1290. Once the user is satisfied with data set 1290, it becomes the input to prediction step 1242.

Prediction step 1242 applies the modeling features extracted from the past performance data during the previous steps to the new product, while correcting for timing considerations. While performing prediction step 1242, the user may go back to the modification of data set 1290 in the judgment aspects of model step 1230, as shown at 1296. Once the user is satisfied that the extracted modeling features will produce an appropriate prediction, the prediction is applied to the new product to produce prediction step series index results data set 1298.

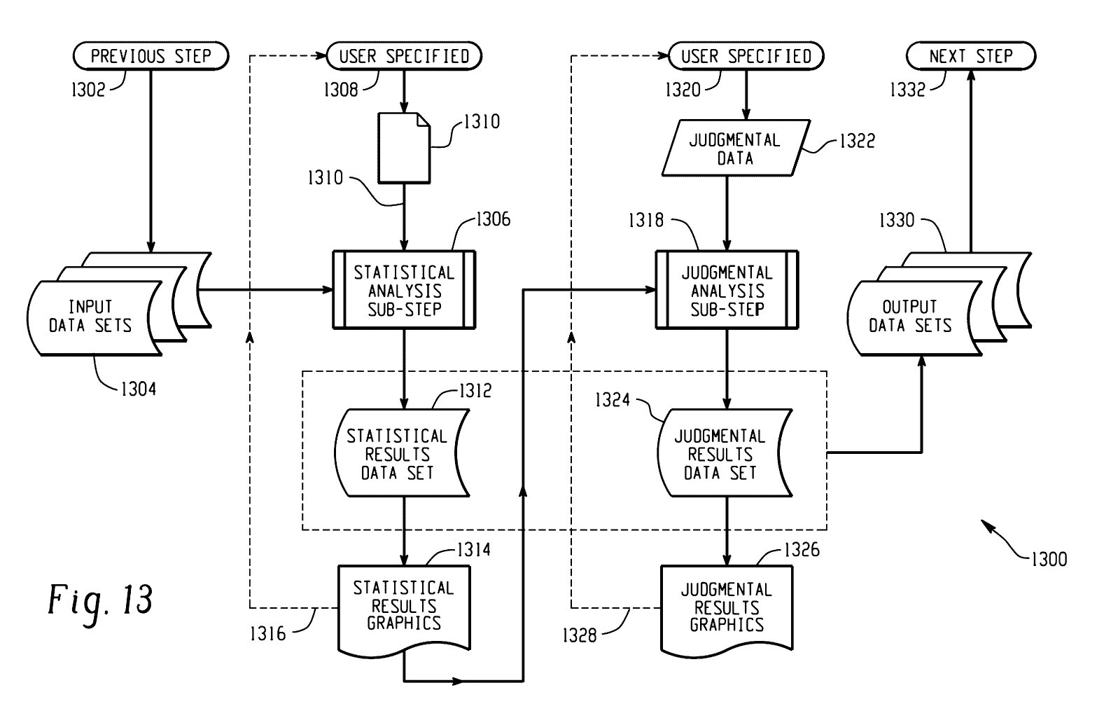

FIG. 13 illustrates a generic set of substeps (e.g., a template) for applying structured judgment analysis to any of the query, filter, model, or prediction steps. As shown in FIG. 13, operation begins with a previous step 1302 (e.g., a query step), the output of which becomes the input data sets 1304 to another step 1300 (e.g., a filter step). The first aspect of step 1300 is a statistical analysis sub-step 1306. Statistical analysis sub-step 1306 takes as input the input data sets 1304. Also, at 1308, the user specifies analysis specification 1310, which becomes an additional input to statistical analysis sub-step 1306. The application of analysis specification 1310 to input data sets 1304 produces statistical results data set 1312. The data in statistical results data set 1312 is displayed to a user through the statistical results graphics 1314, which a user may use to assess whether the analysis specification 1310 included the most accurate and useful data in data set 1312. If the user feels that the analysis specification did not produce the most accurate and useful data, then the user may modify the analysis specification 1310, as shown at 1316. The result is a modified analysis specification 1310, which is input to statistical analysis sub-step 1306, where the modified analysis specification is applied to input data sets 1304. The result is a modified statistical results data set 1312, the contents of which are viewed by the user through the use of the statistical results graphics 1314. The cycle of reviewing the data in data set 1312, modifying the analysis specification 1310, and repeating the application of analysis specification 1310 to input data sets 1304 may be repeated as often as the user wishes.

Once the user is satisfied that the data in data set 1312 is the most accurate and useful data, the data set becomes an input to judgmental analysis sub-step 1318. As shown at 1320, the user specifies judgmental data 1322 as an additional input to judgmental analysis sub-step 1318. This judgmental data 1322 may take many forms, examples of which include an informal process of selecting what data to include in or exclude from the data set input to sub-step 1318 or a formally defined set of rules that can be applied to duplicate the judgment of a user. The application of judgmental data 1322 to the data set input to sub-step 1318 produces judgmental results data set 1324.

The user may examine the data in judgmental results data set 1324 using judgmental results graphics 1326, in order to determine if data set 1324 contains the most appropriate data to be output from method step 1300. As shown at 1328, if the user feels that data set 1324 should be revised, the user may specify modified judgmental data 1322. This modified judgmental data is applied to the data set input from the statistical analysis sub-step to produce a modified judgmental results data set 1324. As in the statistical analysis sub-step, the cycle of reviewing the data in data set 1324, modifying the judgmental data 1322, and re-applying the judgmental data to the input data set may be repeated as often as the user wishes. Once the user is satisfied that the judgmental results data set 1324 is correct, the data is copied to output data sets 1330, where they comprise the input to the next step 1332 in the prediction process.

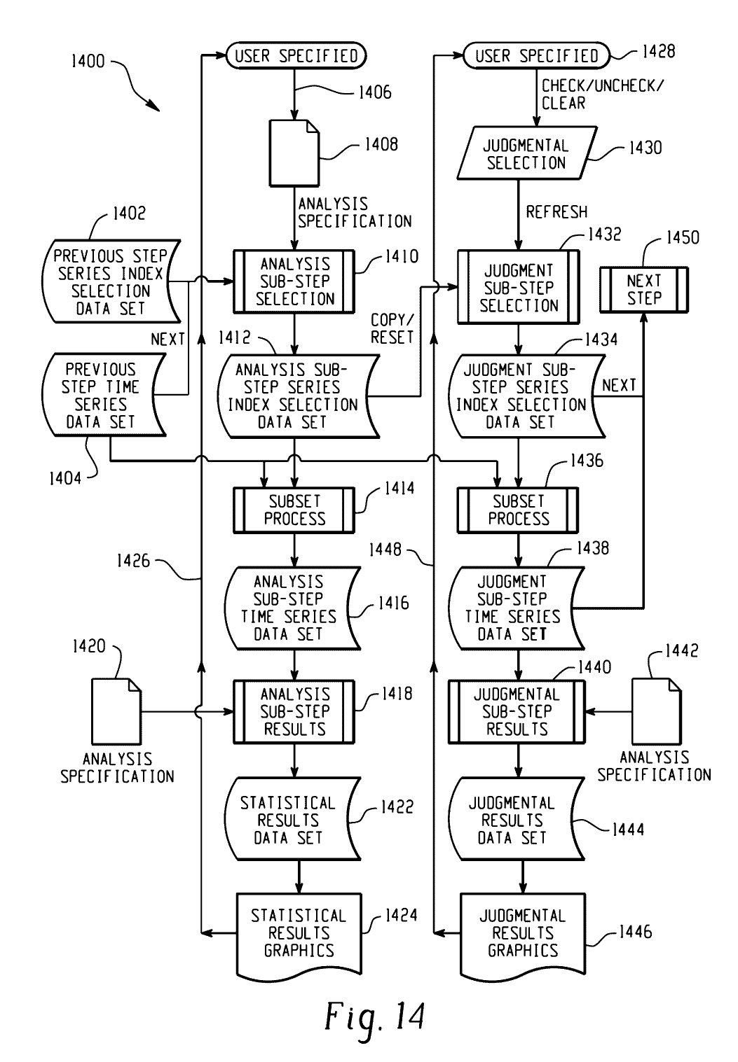

It should be understood that the operations of FIG. 13 can be implemented in many different ways, such as in the approach shown in FIG. 14. FIG. 14 depicts at 1400 the sub-steps associated with an arbitrary major step in the new product prediction process that focuses on combining statistics and judgment in selecting similar products for use in generating a prediction for the performance of the new product. In this example, the user focuses on series index selection. A series index identifies a data for a particular product within the overall set of past performance data for all products that are similar to the new product. For example, if N represents the number of products similar to the new product for which past performance data is available, i represents the series index, and DS indicates a data for a particular similar product, then the set of data for all similar products is represented as DS₁ . . . DS_{N}, while an arbitrary data within the set would be referred to as DSᵢ. Thus, if the fifteenth similar product should be included in a particular data set, the series index selection related to that data set would include at least DS₁₅, which could be represented simply by selecting i=15. An exemplary series index selection data set is the previous step series index selection data set 1402, which in this example contains all of the series for similar products selected pursuant to the step prior to the step illustrated in the figure.

Associated with each similar product is a time series data set. The time series data set contains the time series for a particular similar product, which comprises the dependent time series vector and the independent time series vector for the similar product. Let y_{i,t} represent a single dependent time series value for series i, such as, for example, gross receipts derived from entry tickets to screenings of a motion picture, where

tε{tᵢ^{b}, . . . tᵢ^{e}}

in which tᵢ^{b} and tᵢ^{e} represent the beginning and ending time index for the i^{th} series, respectively, or the time period when the similar product was available, such as the weeks when a motion picture was “in theaters.” Then, \vec{y}ᵢ is the dependent time series vector, representing the sum of y_{i,t} for all values of t. The independent time series vector, on the other hand, helps model or predict values for y_{i,t} as the independent time series vector may include, for example, information about pricing, promotional budget, inventory, or other causal factors that could have affected the magnitude of y_{i,t} for period t. An exemplary time series data set is previous step time series data set 1404.

As shown at 1406 in FIG. 14, the user specifies analysis specification 1408, which describes the analytical process for selecting a series and how a selected series should be analyzed and graphically displayed. At 1410, the analysis sub-step selection uses previous step series index selection data set 1402 and previous step time series data set 1404, along with analysis specification 1408 to create the analysis sub-step series index selection data set 1412. Using data set 1412, subset process 1414 generates a subset of previous step time series data set 1404 to form the analysis sub-step time series data set 1416. At 1418, the analysis sub-step time series data set 1416 is combined with analysis specification 1420 to produce statistical results data set 1422. The user may use statistical results graphics 1424 to explore statistical results data set 1422 and at 1426, make modifications to the analysis specification 1408 used in the analysis sub-step.

Once the user is satisfied with the results of the analysis sub-step, the analysis sub-step series index selection data set 1412 becomes an input to the judgment sub-step. At 1428, the user specifies judgmental selection 1430, which may comprise a series selected according to the analysis specification in the analysis sub-step. The user's judgmental selection 1430 is combined at 1432 with the input data copied from data set 1412 to create the judgment sub-step series index selection data set 1434. At 1436, a subset of data set 1434 is generated, using the previous step time series data set 1404, which results in the creation of judgment sub-step time series data set 1438. At 1440, the analysis specification 1442 is applied to data set 1438, producing judgmental results data set 1444, which the user may explore with judgmental results graphics 1446. If the user wishes to modify 1448 the judgmental selection 1430 that was applied in the judgment sub-step, then the judgment sub-step is repeated using the modified judgmental selection. Once the user is satisfied with the results of the statistical analysis, the user can choose to move on to the next step in the process, whereupon judgment sub-step series index selection data set 1434 and judgment sub-step time series data set 1438 become inputs to the next step 1450.

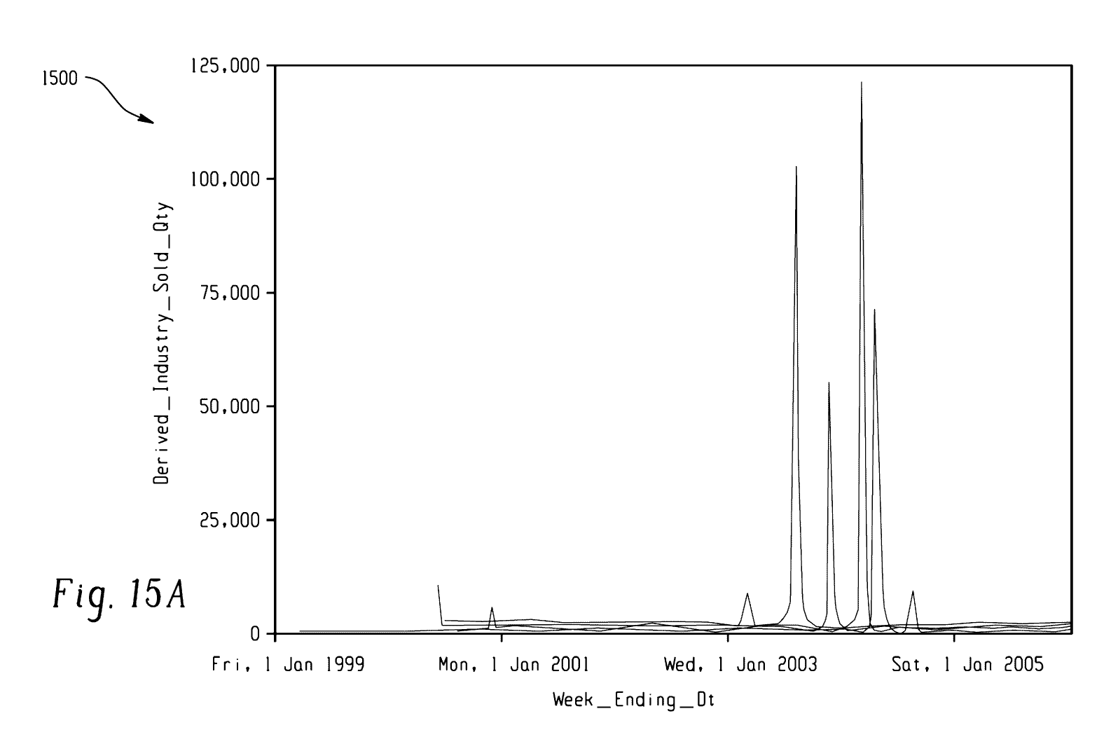

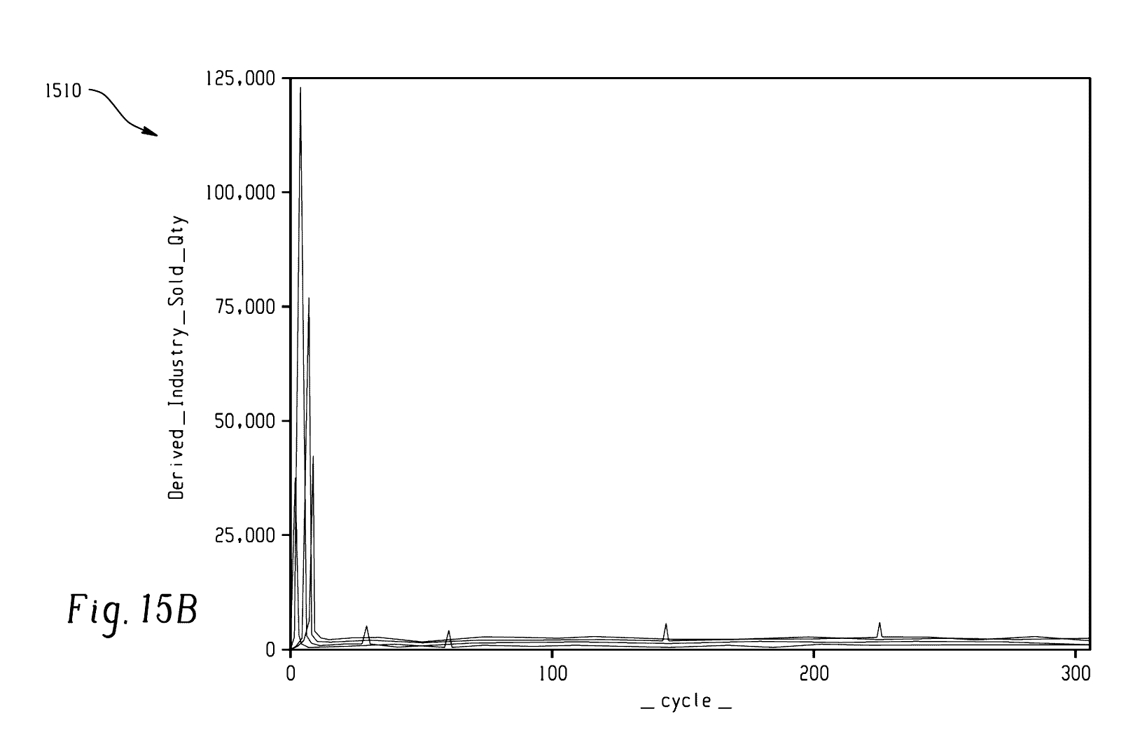

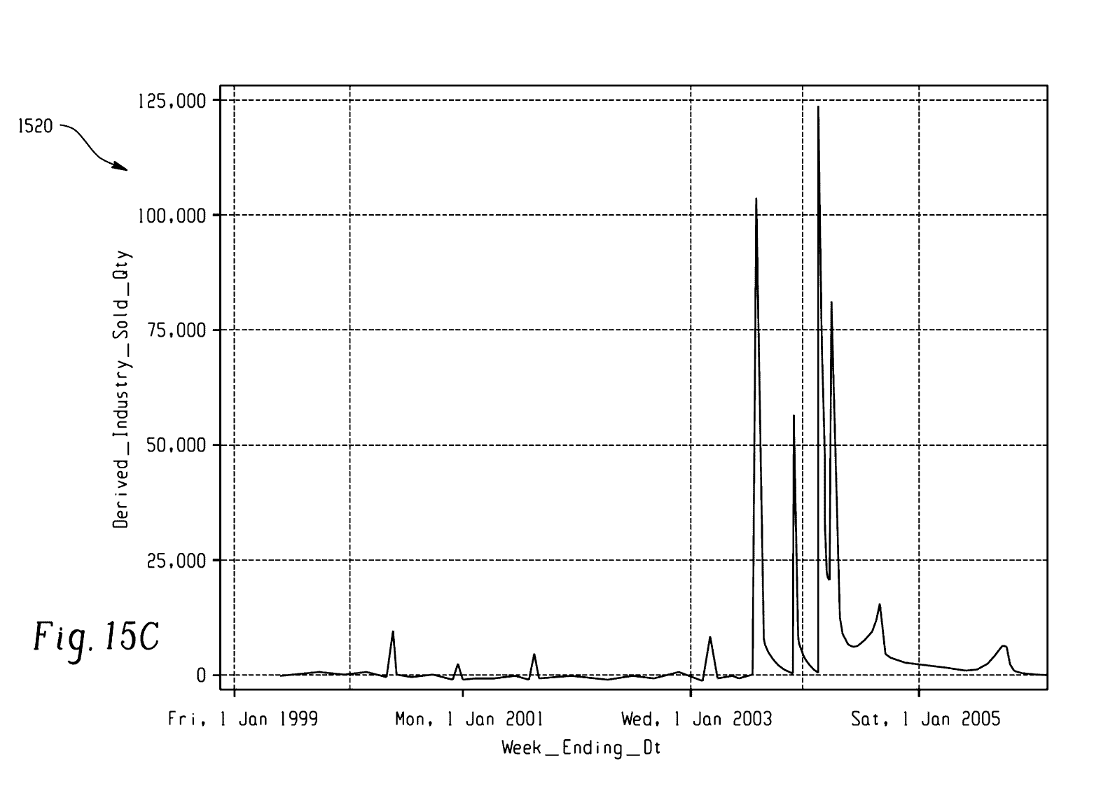

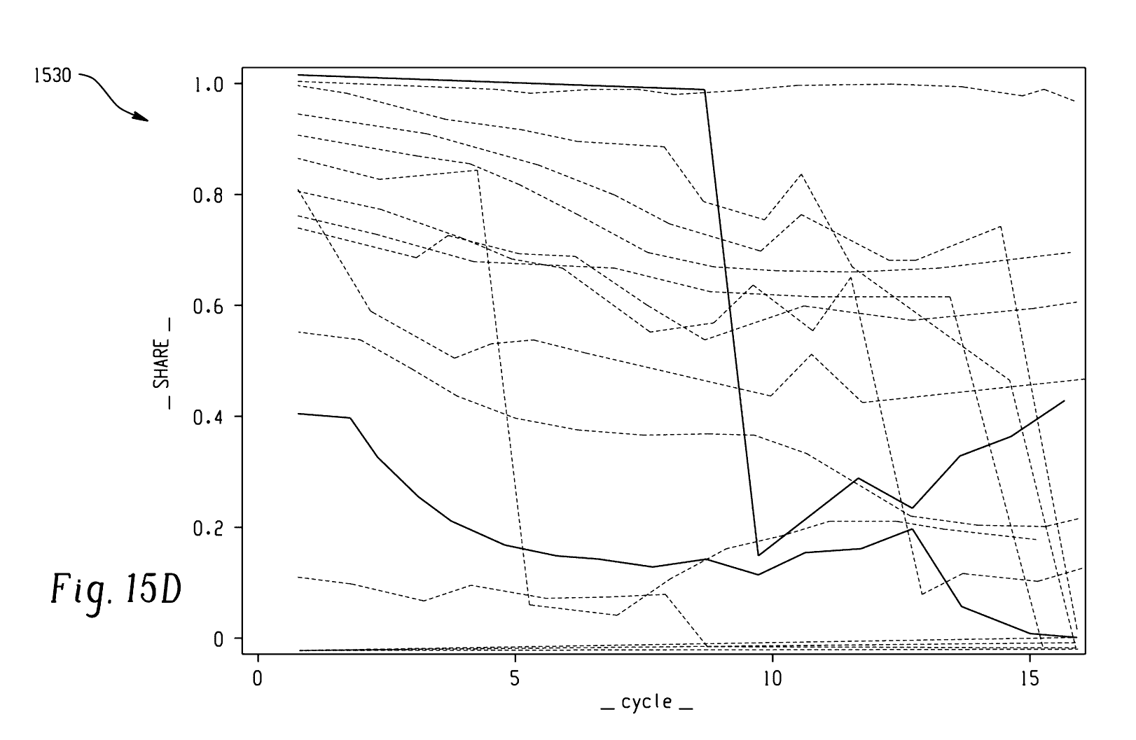

The new product prediction system can handle many different types of data, such as collected and/or derived data. FIGS. 15A-15E are graphs illustrating various examples of collected and derived past performance series data for a previously introduced product as well as ways in which a user can visualize such data. For example, FIG. 15A depicts at 1500 time series data for the quantity sold of a group of products, over a seven-year timeframe. Specifically, the graph depicts the dependent time series values for the products.

FIG. 15B depicts a graphical representation 1510 of cycle series data for the quantity sold of a group of products, over a cycle timeframe of approximately 15 cycles. Cycle series data is derived from time series data, but rather than representing the time series data on an absolute time scale (e.g., the performance/sales of each product during the first week of January, 2007 or for the day of Jul. 3, 2005), cycle series data sets the introduction of each product as “cycle 1” in the derived data, and the time series data for each product is adjusted to this relative scale. Thus, if product 1 were introduced on Aug. 1, 2006 and product 2 were introduced on Sep. 15, 2007, and the cycle timeline is daily, performance/sales of product 1 on Aug. 1, 2006 and performance/sales of product 2 on Sep. 15, 2007 each would be represented in the first position on the horizontal axis (i.e., cycle 1), with each product's daily performance/sales being graphed sequentially from that point on the graph. In the example of motion picture ticket receipts, similar pictures may be introduced months or years apart, and it is very likely that, given that passage of time, the earlier picture will no longer be in the theaters when the later picture is released. Thus, viewing the ticket receipts for the two pictures on an absolute time scale would not convey meaningful information. However, adjusting to a relative time scale, such as ticket receipts for the first week of release, will present the data in a way that is more useful, allowing a user, for example, to see what correlations, if any, exist between the receipts derived by the earlier picture and the receipts derived by the later picture in their various weeks of release.

FIG. 15C depicts at 1520 a graph of an aggregate time series. The aggregate time series may represent, for example, the sum of time series data for all selected series i at a particular time t, or it may be based on the average of the time series data at time t or another aggregation. Also, the aggregate time series data may be derived on the basis of the time series data for each of the selected series i, or it may be supplied as a data set separate from the time series data. In addition, the aggregate time series data may have associated with it an independent time series vector, which may help model or predict values for the aggregate time series data, such as by providing macro-scale inputs.

FIG. 15D includes a graph 1530 showing request series data for a group of products. Request series data is derived from the aggregate time series data and the cycle series data for the group of products, and it describes the relative request for each product over the cycle index. A request series may be formed from the cycle series y_{i,l} and the aggregate time series yₜ^{A} as follows:

v_{i,l}=y_{i,l}/yₗ^{A} for l=1 . . . Lᵢ where l=(t+1−tᵢ^{b})

and

\vec{v}ᵢ={v_{i,l}}ₗ₌₁^{L}^{ᵢ}

represents the request series vector for the i^{th} series. In other words, vᵤ would represent the percentage for the i^{th} product at the l^{h} cycle index with respect to the aggregate time series. It should be noted that all request series have a common cycle index and common scale.

FIG. 15E depicts at 1540 a graph containing cumulative series data. Cumulative series data describes the cumulative request for a product over the cycle index, information which may be useful, for example, for diffusion models when a saturation level must be estimated. Cumulative series data c_{i,l} is derived from the cycle series data y_{i,l}, according to the following formula:

$${c}_{i , l} = {\sum }_{j = i}^{l} {y}_{i , j} for l = 1 , … , {L}_{i}$$

$$and$$

$${\vec{c}}_{i} = {\{ {c}_{i , l} \}}_{l = 1}^{{L}_{i}}$$

represents the cumulative series vector for the i^{th} series. Thus, if l=10, then c_{i,l} represents the total quantity of product sold within the first ten cycles after the product was introduced.

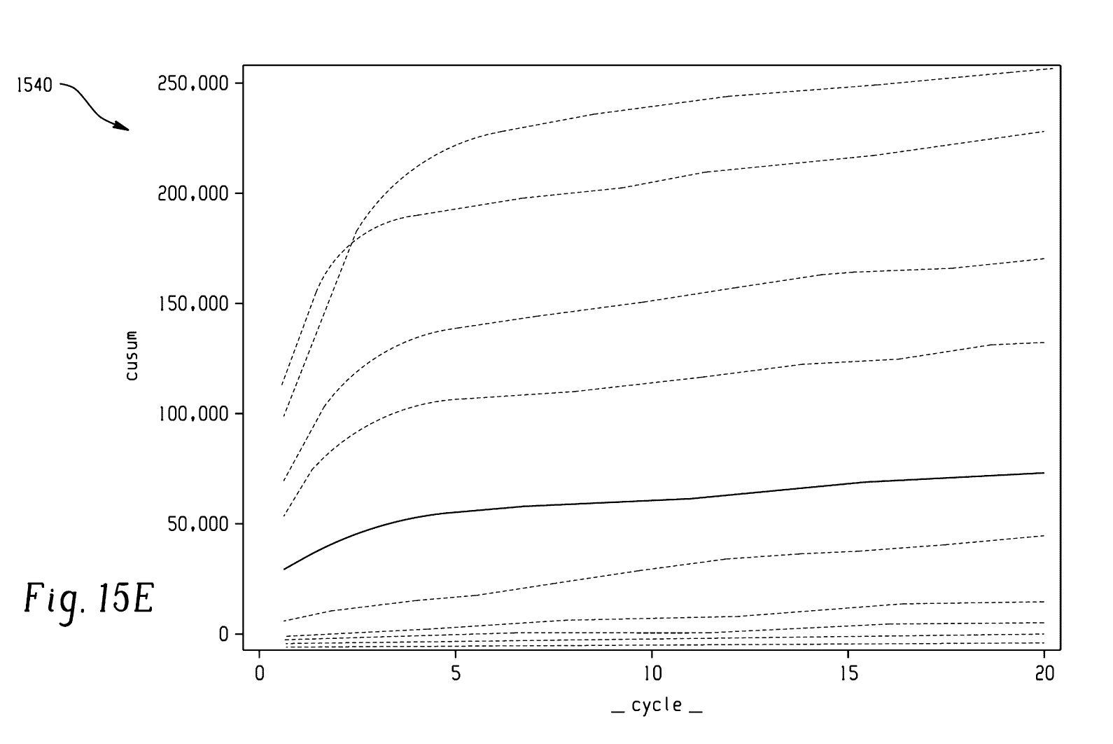

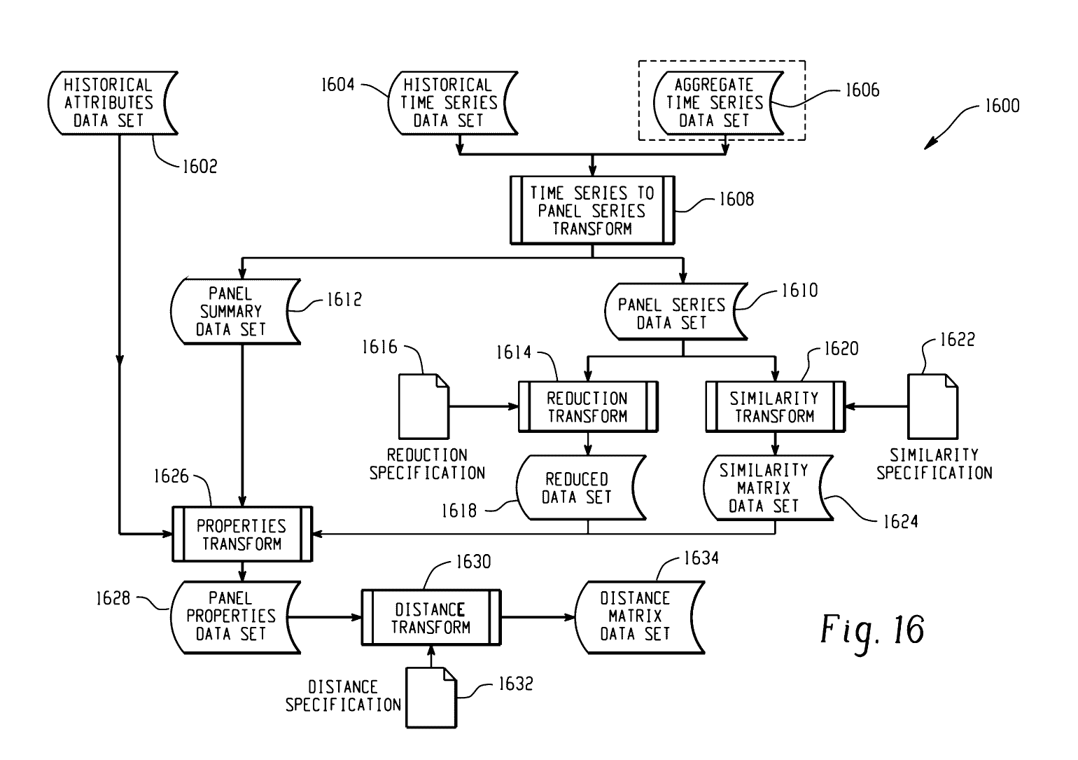

Data that can be processed by the new product prediction system includes derived data (e.g., as shown in FIG. 15B). FIG. 16 provides an example of how derived data can be generated within the new product prediction system. More specifically, FIG. 16 depicts at 1600 processes involved in the derivation of the derived past product data sets from the past data sets that are supplied. The inputs to the derivation processes are past attributes data set 1602, past time series data set 1604, and optionally, aggregate time series data set 1606. If aggregate time series data set 1606 is not supplied, then it is derived prior to commencing the other derivation processes. Past time series data set 1604 and aggregate time series data set 1606 (whether supplied or derived) are input to time series to panel series transform 1608. Time series to panel series transform 1608 operates on the input data to generate the panel series data set 1610, which includes the range of derived data sets, including for example, cycle series data, request series data, and cumulative series data, and the panel summary data set 1612, which may be represented as Qᵢ. At 1614, using a time series reduction specification 1616, such as \vec{r}ᵢ=R(Zᵢ), the panel series data set 1610 is transformed into reduced data set 1618, which may be represented as \vec{r}ᵢ. Using a time series similarity specification 1622, such as s_{i,j}=Sim(Zᵢ, Zⱼ), the panel series data set 1610 is transformed into similarity matrix data set 1624, which may be represented as s₁₁. At 1626, panel summary data set 1612, reduced data set 1618, similarity matrix data set 1624, and past attributes data set 1602 are merged to form the panel properties data set 1628. Finally, at 1630, the panel properties data set 1628 is transformed using a distance measure, as specified at 1632, for example d_{i,j}=D(\vec{z}ᵢ^{P}, \vec{z}ⱼ^{P}). The result is distance matrix data set 1634, which may also be represented as d_{i,j}.

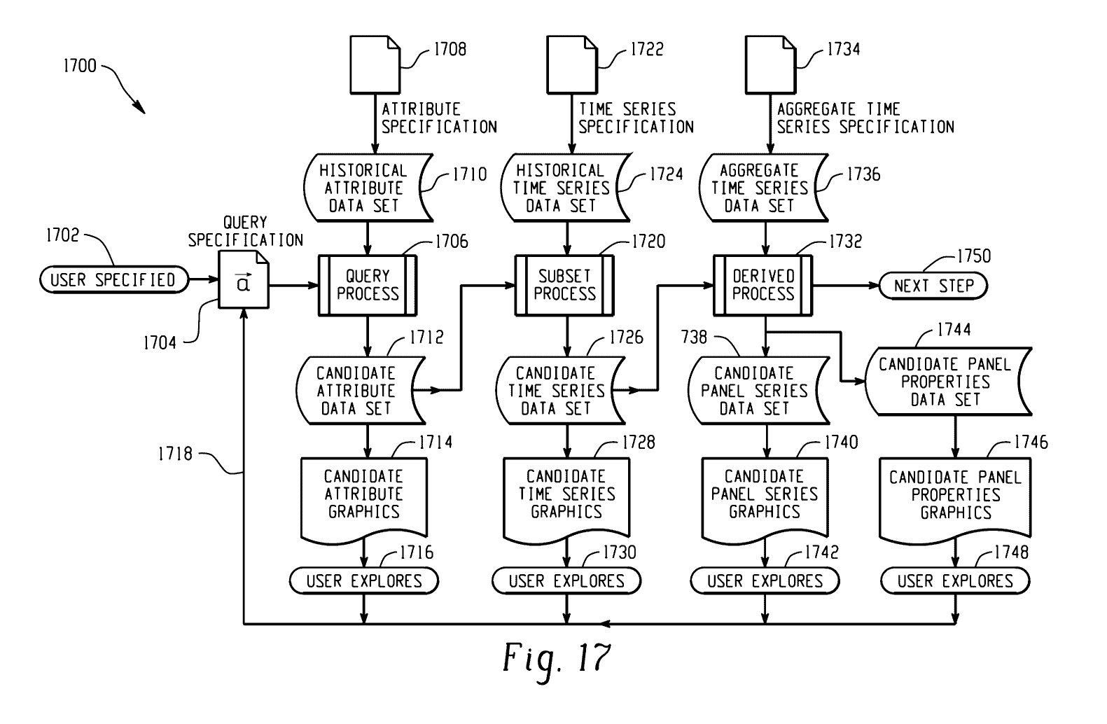

As discussed above, the new product prediction system includes a query step. FIG. 17 depicts at 1700 additional details of the query step. Aspects of the more detailed depiction of the query step incorporate, for example, the derivation processes discussed above with reference to FIG. 16, as well as the querying and subset procedures discussed above with reference to FIG. 12A and FIG. 14, respectively. Thus, for example, at 1702 a user specifies a query specification, which is input to the query process 1706. In addition, the user specifies an attribute specification, which is applied to the past attribute data set 1710, with the result comprising an additional input to query step 1706. The query step combines the inputs to produce the candidate attribute data set 1712, which candidate attribute graphics 1714 permit the user to explore, as shown at 1716, and the user may modify at 1718 the query specification based on the exploration at 1716. Once the data set 1712 is satisfactory, it becomes an input to subset process 1720. In addition, at 1722 the user specifies a time series specification, which is applied to past time series data set 1724, the result comprising an additional input to subset process 1720. Subset process 1720 combines the inputs to generate candidate time series data set 1726. Candidate time series graphics 1728 facilitate exploration by the user of data set 1726, as shown at 1730. The user may modify at 1718 the query specification based on the exploration 1730. Once the data set 1726 is satisfactory, it becomes an input to the derivation process 1732. Also, the user specifies an aggregate time series specification 1734, which is applied to aggregate time series data set 1736, the result of which comprises an additional input to the derivation process 1732. Derivation process 1732 produces candidate panel series data 1738, which candidate panel series graphics 1740 permit the user to explore 1742, and candidate panel properties data set 1744, which candidate panel properties graphics 1746 permit the user to explore 1748. Based on either of the exploration steps 1742 or 1748, the user may modify 1718 the query specification. Once the candidate panel series data set 1738 and candidate panel properties data set 1744 are satisfactory, they become the input to the next step 1750.

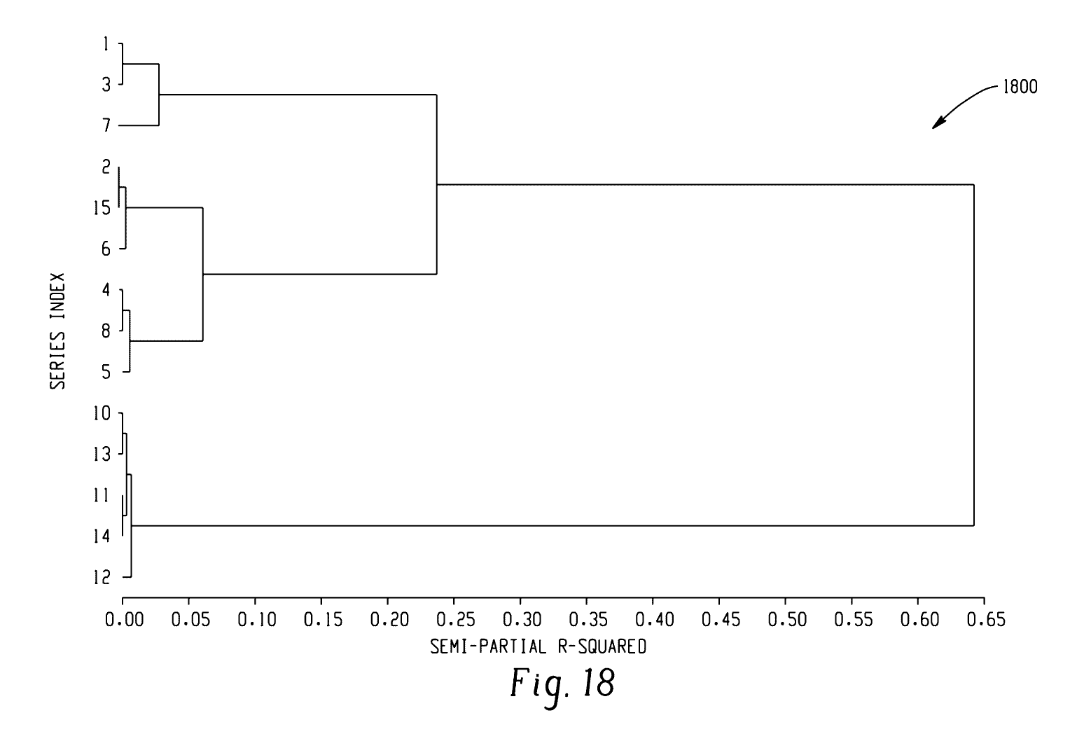

As discussed above, the new product prediction system includes a filter step. For example, a user may choose to use distance measures as the filter. As an illustration, FIG. 18 provides an example dendrogram that depicts information contained in a distance matrix of a cluster of past performance series data. The following is an example of a distance matrix:

D={\vec{d}ᵢ}ᵢ₌₁^{N}

Given the distance matrix, a clustering method may be specified by the user to be applied to the data, which could for example result in clusters as depicted in dendrogram 1800. In the dendrogram 1800, the largest of the more significant clusters consists of series indices 1, 3, 7, 2, 15, 6, 4, 8, and 5. The smaller of the more significant clusters consists of series indices 10, 13, 11, 14, and 12. If, on the other hand, four clusters are considered, then the cluster consisting of series indices 10, 13, 11, 14, and 12 would be the largest and most significant. This clustering may be used as part of the filter step in predicting the performance of a new product, in order to remove from the candidate data set any outliers that might tend to reduce the accuracy of the models extracted from the data set of products similar to the new product.

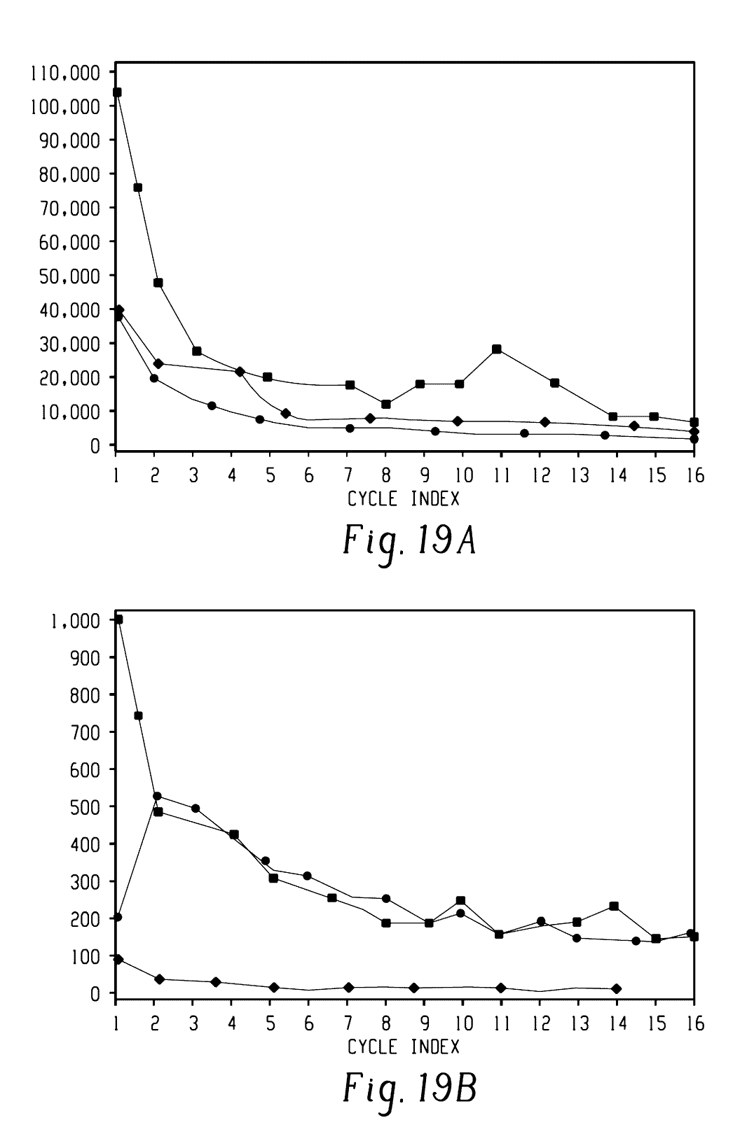

FIGS. 19A and 19B are examples of plots of the cycle series of two of the clusters represented in the dendrogram of FIG. 18. These provide the user with additional information about the relationships between the products chosen in the query step and whether the set of similar products chosen in the query step should be altered before the results are passed to the next step.

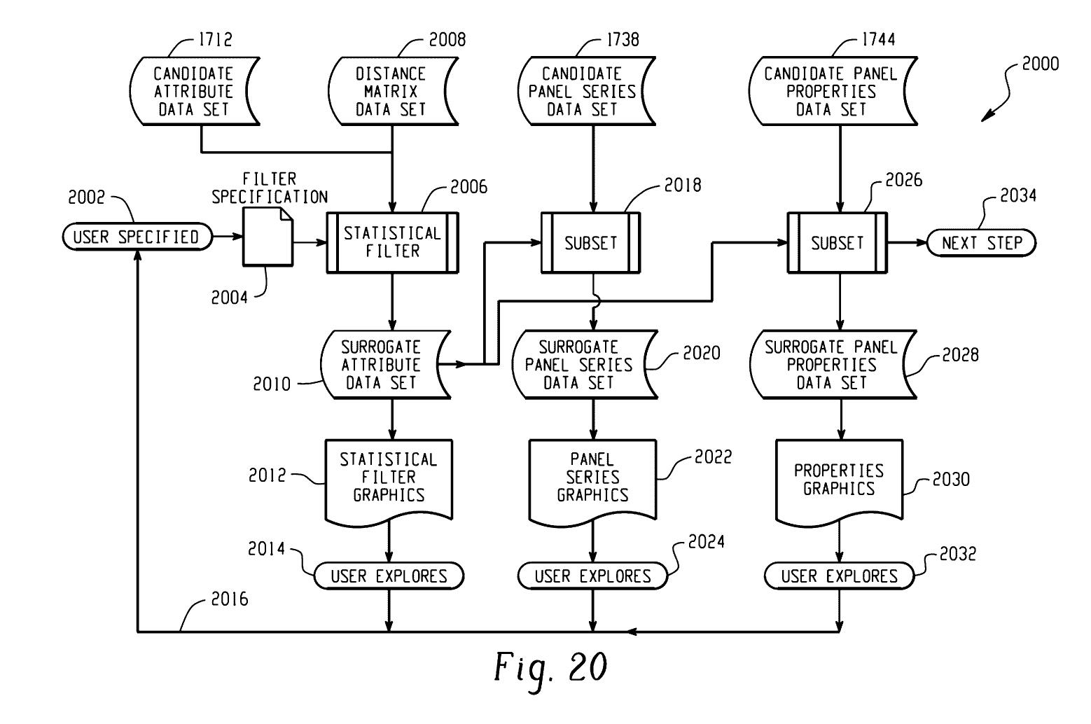

FIG. 20 depicts at 2000 additional details of the filter step. Aspects of the more detailed depiction of the filter step may incorporate, for example, the visualizations of FIGS. 18, 19A, and 19B, as well as the filtering and subset procedures discussed above with reference to FIG. 12A and FIG. 14, respectively. In this example, a user specifies at 2002 the filter specification 2004 that is input into statistical filter 2006. Statistical filter 2006 also takes as inputs candidate attribute data set 1712 and distance matrix data set 2008, where data set 1712 was an output of the query step described in FIG. 17. Statistical filter 2006 combines the inputs to generate surrogate attribute data set 2010. The statistical filter graphics 2012 allow the user to explore 2014 the data set 2010. If the user feels, based on the exploration 2014, that changes are needed to make the data set 2010 more useful and accurate, then changes are incorporated into the filter specification, as shown at 2016.

Once the data set 2010 is properly defined, it becomes an input to the subset operation at 2018. Subset operation 2018 also takes as input candidate panel series data set 1738, which was one output of the query step described in FIG. 17. The subset operation 2018 combines the inputs to generate surrogate panel series data set 2020. The surrogate panel series data set 2020 may include one or more of the data listed below, which may be derived given a set of statistically filtered candidate series indices, i=1 . . . N.

Surrogate Panel Series: (\vec{z}_{i,l}=y_{i,l}, v_{i,l}, c_{i,l}, c_{i,l}^{%}, q_{i,l}, Qᵢ, \vec{x}_{i,l})

Surrogate Time Series: y_{i,t}

Surrogate Cycle Series: y_{i,l}

Surrogate Request series: v_{i,l}

Surrogate Cumulative Series: c_{i,l}

Surrogate Cumulative % Series: c_{i,l}^{%}

Surrogate Profile Series: q_{i,l}

Surrogate sum of the cycle series: Qᵢ

Surrogate Input Series Vector: \vec{x}_{i,l}

The panel series graphics 2022 facilitate the user's exploration 2024 of the data set 2020. If the user feels that the data set 2020 requires modification, then changes are incorporated into the filter specification, as shown at 2016.

Subset operation 2026 also accepts as input surrogate attribute data set 2010. Subset operation combines data set 2010 with candidate panel properties data set 1744, a data set that was one output of the query step illustrated in FIG. 17. This combination produces surrogate panel properties data set 2028. The surrogate panel properties data set 2028 may include one or more of the data listed below, which may be derived given a set of statistically filtered candidate series indices, i=1 . . . N.

Surrogate Panel Properties: \vec{z}ᵢ^{P}=(Qᵢ, \vec{a}ᵢ, \vec{r}ᵢ, \vec{s}ᵢ)

Surrogate sum of the cycle series: Qᵢ

Surrogate's Attribute Data Vector: \vec{a}ᵢ

Surrogate Reduced Data Vector: \vec{r}ᵢ

Surrogate Similarity Vector: \vec{s}ᵢ

Properties graphics 2030 permit the user to explore 2032 the data set 2028, and any changes the user feels are needed to improve data set 2028 are incorporated into filter specification 2004, as shown at 2016. Once the subset operations are complete, the process may move to the next step 2034.

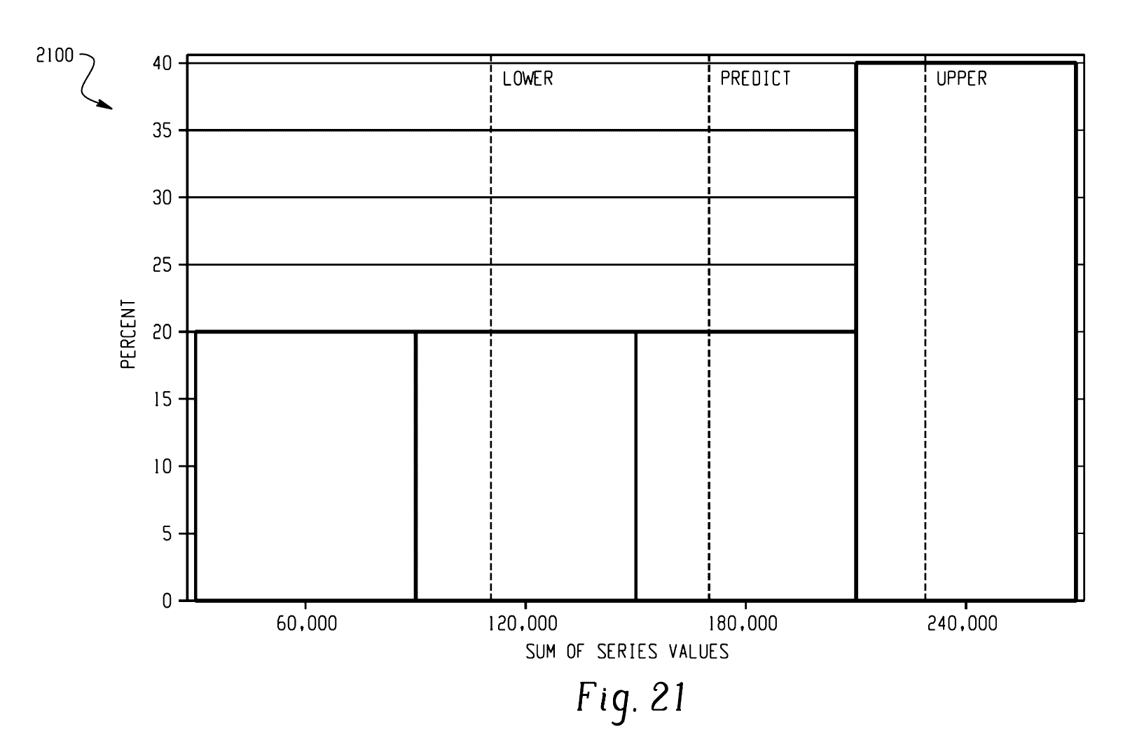

As discussed above, the new product prediction system includes a model step. The model step can be configured in many different ways in order to extract modeling features from the output of the filter step (i.e., the surrogate data). For example, FIG. 21 depicts at 2100 the predictions generated by a particular type of model (i.e., panel summary model) processing surrogate data from the filter step. The values presented are for the surrogate series values, Qᵢ. The vertical reference lines represent the prediction, \hat{Q}, and its 95% confidence limits. Given the surrogate panel series data created, for example, as described in FIG. 20, a prediction for the new product can be generated using a prediction method, F( ) specified by the user:

(yₗvₗ,cₗ,cₗ^{%,}qₗ,Q)=(F{Zᵢ}ᵢ₌ₗ^{N}, {\vec{z}ᵢ^{P}}ᵢ₌₁^{N}:θ)

where F( )) represents the prediction method, Zᵢ represents the surrogate panel series matrix for the i^{th} dependent series, \vec{z}ᵢ^{P} surrogate panel properties vector for the i^{th} dependent series, θ represents the parameter vector to be estimated, and (yₗ, vₗ, cₗ, cₗ^{%}, qₗ, Q) represents the new product panel series to be predicted. The new product series are not subscripted by the series index, i, because they are not contained in the past data. Typically, the prediction method only predicts the cycle series, yₗ, the request series and the aggregate series (rₗ, yₗ^{A}), the cumulative series cₗ, the cumulative percent series and the sum of the cycle series (cₗ^{%}, Q), or the profile series and the sum of the cycle series, (qₗ, Q). From any of these predictions, the others can be readily computed, due to the relationship:

yₗ=vₗyₗ^{A}=cₗ−cₗ₋₁=(cₗ^{%}−cₗ₋₁^{%})Q=qₗQ and when l=1,y₁=c₁=c₁%Q=q₁Q

Typically, when the prediction method predicts both the request series and the aggregate time series, it is done in the following separate models:

vₗ=F₁({Zᵢ}ᵢ₌₁^{N}:θ₁)

yₜ^{A}=F₂((yₜ^{A},\vec{x}ₜ^{A}):θ₂)

where F₁( ) represents the request series and F₂ ( ) represents aggregate time series prediction methods, respectively.

Typically, when the prediction method predicts both the cumulative percentage series and the sum of the cycle series, it is done in the following separate models:

cₗ^{%}=F₁({Zᵢ}ᵢ₌₁^{N}:θ₁)

Q=F₂=({\vec{z}ᵢ^{P}}ᵢ₌₁^{N}:θ₂)

where F₁( ) represents the cumulative percentage series and F₂ ( ) represents sum of the cycle series prediction methods, respectively.

Typically, when the prediction method predicts both the profile series and the sum of the cycle series, it is done in separate models.

qₗ=F₁({Zᵢ}ᵢ₌₁N:θ₁)

Q=F₂({\vec{z}ᵢ^{P}}ᵢ₌₁^{N}:θ₂)

where F₁( ) represents the profile series and F₂ ( ) represents sum of the cycle series prediction methods, respectively.

There are many product prediction methods that may be used in combination, including, but not limited to: growth curves, diffusion models, mixed models, panel series models, smoothing models, neural networks, response models, share models, judgmental models, Bayesian methods, and combination methods. These models can be automatically selected based on a selection criterion such as MAPE, RMSE, AIC, and many others. Weighted combinations of the models based on the criterion are also possible. Additionally, the selection criterion can be based on in-sample or out-of-sample results or a weighted combination of the two. After the appropriate model specification is selected, the model can be fitted to the panel series data.

After selecting a new product prediction model specification, the parameter vector, θ, is estimated using the surrogate panel series data as follows:

(ŷₗ,\hat{v}ₗ,ĉₗ,ĉₗ,\hat{q}ₗ,\hat{Q})=\hat{F}({Zᵢ}ᵢ₌₁^{N},{\vec{z}ᵢ^{p}}ᵢ₌₁^{N}:\hat{θ})

where \hat{F}( ) represents the fitted model, Zᵢ represents the surrogate panel series matrix for the i^{th} dependent series, \vec{z}ᵢ^{P} surrogate panel properties vector for the i^{th} dependent series, \hat{θ} represents the parameter vector estimates, and (ŷₗ, \hat{v}ₗ, ĉₗ, ĉₗ^{%}, \hat{q}ₗ, \hat{Q}) represents the new product series predictions. The model parameter estimates, \hat{θ}, are typically optimized based on the data or provided by the user when little data is available. For a diffusion model example, the innovation and imitation parameters may be provided. Using these model parameter estimates, various model components estimates can be computed from the data. For a diffusion model example, the adoption component can be estimated. For a seasonal model example, the seasonal component can be estimated. Together, the model parameter and component estimates are called the fitted model. From the fitted model various statistical features can be extracted from the surrogate panel series that can be used to predict the performance of the new product.

Typically, a new product prediction method only generates predictions for either yₗ, cₗ, (rₗ, yₗ^{A}), (cₗ^{%}, Q) or (qₗ, Q). All of the other predictions can be generated from the others using the following relationship:

yₗ=vₗyₗ^{A}=cₗ−cₗ₋₁=(cₗ^{%}−cₗ₋₁^{%})Q=qₗQ and when l=1,y₁=c₁=c₁^{%}Q=q₁Q

Regardless of how the predictions were created, there are several ways in which predictions may be explored. These methods of exploring predictions include time series exploration, aggregate time series exploration, cycle series exploration, request series exploration, cumulative series exploration, cumulative percent series exploration, and profile series exploration.

With respect to time series exploration, for a given series index, i, a time series plot illustrates a single time series, y_{i,t}, with respect to the time index, tε{tᵢ^{b}, . . . tᵢ^{e}}. Also, for a given series index, i, a time series plot illustrates a single request series, v_{i,t}, with respect to the time index, tε{tᵢ^{b}, . . . tᵢ^{e}}. A cumulative series plot for a given series index, i, illustrates a single cumulative series, c_{i,t}, with respect to the time index, tε{tᵢ^{b}, . . . tᵢ^{e}}. For a given series index, i, a cumulative percent series plot illustrates a single cumulative percent series, c_{i,t}^{%}, with respect to the time index, tε{tᵢ^{b}, . . . tᵢ^{e}}, while a profile series plot illustrates a single profile series, q_{i,t}, with respect to the time index, tε{tᵢ^{b}, . . . tᵢ^{e}}.

In cases where the system must illustrate multiple time series, vector series plotting may be used. For each series index, i, a vector series plot jointly illustrates several time series, y_{i,t}, with respect to the time index,

$$t ∈ \{ \begin{matrix}min & & max & \\ & ( {t}_{i}^{b} ) , … , & & ( {t}_{i}^{e} ) \\ i & & i & \end{matrix} \} .$$

An example vector series plot is illustrated by FIG. 15A, where the vertical axis represents the dependent series values, y_{i,t}, and the horizontal axis represents the time index, t. Each plot line in FIG. 15A represents an individual series, i. For each series index, i, a request series vector plot jointly illustrates several request series, v_{i,t}, with respect to the time index,

$$t ∈ \{ \begin{matrix}min & & max & \\ & ( {t}_{i}^{b} ) , … , & & ( {t}_{i}^{e} ) \\ i & & i & \end{matrix} \} .$$

A cumulative vector plot for a each series index, i, jointly illustrates several cumulative series, c_{i,t}, with respect to the time index,

$$t ∈ \{ \begin{matrix}min & & max & \\ & ( {t}_{i}^{b} ) , … , & & ( {t}_{i}^{e} ) \\ i & & i & \end{matrix} \} .$$

Further, a cumulative percent vector plot for each series index, i, jointly illustrates several cumulative percent series, c_{i,t}^{%}; with respect to the time index,

$$t ∈ \{ \begin{matrix}min & & max & \\ & ( {t}_{i}^{b} ) , … , & & ( {t}_{i}^{e} ) \\ i & & i & \end{matrix} \} ,$$

and a profile vector plot for each series index, i, jointly illustrates several profile series, q_{i,t}, with respect to the time index,

$$t ∈ \{ \begin{matrix}min & & max & \\ & ( {t}_{i}^{b} ) , … , & & ( {t}_{i}^{e} ) \\ i & & i & \end{matrix} \} .$$

Time series exploration may employ many different analyses and transformations. For example, possible time series analyses include cross series plots over time, autocorrelation plots, and cross-correlation plots. Meanwhile, possible time series transformations (either individually or jointly) include functional transformations, such as log, square-root, logistic, or Box-Cox, difference transformations, for example simple and seasonal differencing, and seasonal decomposition, including additive, multiplicative, pseudo-additive, or log-additive.

Aggregate time series exploration is facilitated by review of an aggregate time series plot, which illustrates the aggregation of all time series, yₜ^{A}, with respect to the time index,

$$t ∈ \{ \begin{matrix}min & & max & \\ & ( {t}_{i}^{b} ) , … , & & ( {t}_{i}^{e} ) \\ i & & i & \end{matrix} \} .$$

An example aggregate time series plot is illustrated by FIG. 15C, where the vertical axis represents the aggregate of dependent series values, yₜ^{A}, for example request, and the horizontal axis represents the time index, t. Possible aggregate time series plots include series plots over time, cross series plots over time, autocorrelation plots, and cross-correlation plots. Further, potential aggregate time series transformations include functional transformations such as log, square-root, logistic, and Box-Cox, difference transformations, such as simple and seasonal differencing, and seasonal decomposition, for example additive, multiplicative, pseudo-additive, and log-additive.

Cycle series exploration may include generation of cycle series plots by the system. A cycle series plot for a given series index, i, illustrates a single cycle series, y_{i,l}, with respect to the cycle index, l=1, . . . ,Lᵢ. Further, for a each series index, i, a cycle series panel plot jointly illustrates several cycle series, y_{i,l}, with respect to the cycle index, l=1, . . . , L^{P}. An example cycle series panel plot is illustrated in FIG. 15B. The vertical axis represents the dependent series values, y_{i,l}, and the horizontal axis represents the cycle index, l. Each plot line represents an individual series, i. Analyses that may be used during cycle series exploration include composite cycle (average or median profile), joint and individual diffusion analysis, joint and individual exponential decay analysis, and correlation between cycle and cumulative series.

Exploration of request series may include, for a given series index, i, a request series plot, which illustrates a single request series, v_{i,l}, with respect to the cycle index, l=1, . . . , Lᵢ. A request series panel plot for each series index, i, jointly illustrates several request series, v_{i,l}, with respect to the cycle index, l=1, . . . L^{P}. An example request series panel plot is illustrated in FIG. 15D, where the vertical axis represents the request series values, v_{i,j}, and the horizontal axis represents the cycle index, l. Each plot line represents an individual series, i.

Cumulative series exploration may include the review of different graphical representations of cumulative series data. For a given series index, i, a cumulative series plot illustrates a single cumulative series, c_{i,l}, with respect to the cycle index, l=L, . . . , Lᵢ. Also, for each series index, i, a cumulative series panel plot jointly illustrates several cumulative series, c_{i,j}, with respect to the cycle index, l=1, . . . , L^{P}. An example cumulative series panel plot is illustrated in FIG. 15E, where the vertical axis represents the cumulative series values, C_{i,l}, and the horizontal axis represents the cycle index, l. Each plot line represents an individual series, i. As another example, for a each series index, i, a panel summary histogram jointly illustrates several cumulative requests, Qᵢ=c_{i,L}_{ᵢ}. The example panel summary histogram at 2100 in FIG. 21 illustrates this representation, and the bars in FIG. 21 represent the histogram, while the solid line represents a normal distribution with the same mean and variance.

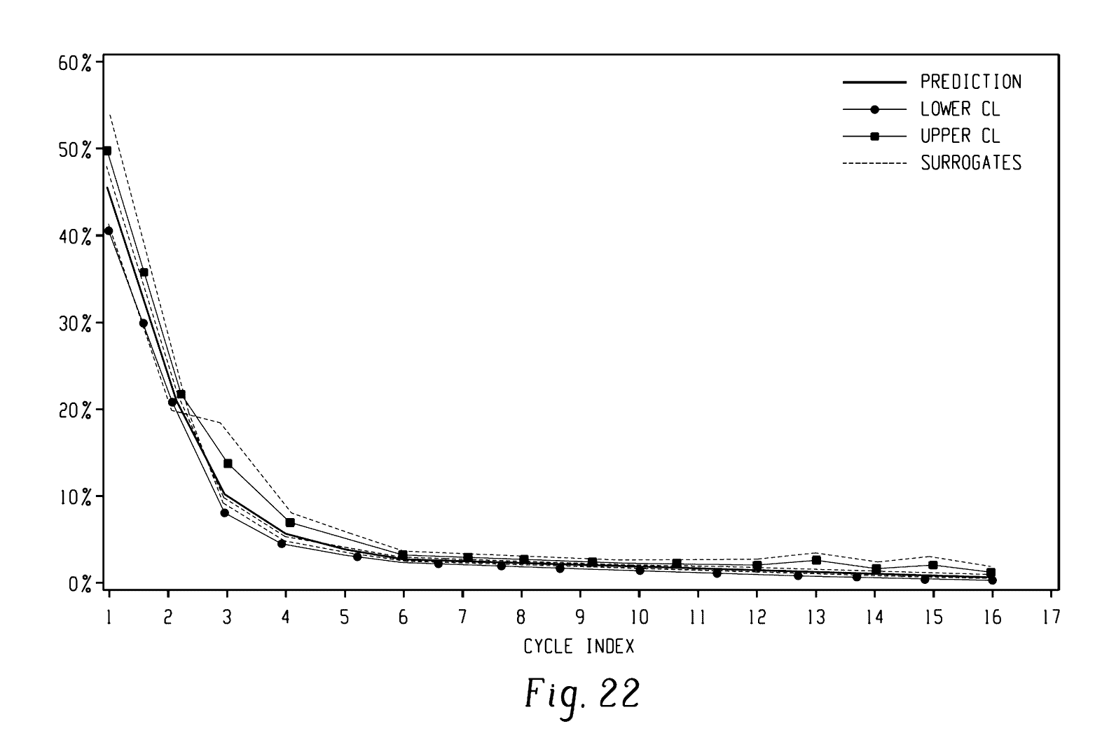

FIG. 22 provides another example of a model (used during the model step) generating predictions from data provided by the filter step. More specifically, FIG. 22 depicts at 2200 predictions for a new product prediction, wherein the dashed lines represent the surrogate series values, q_{i,l}. The solid unmarked line represents the prediction, \hat{q}₁, the line marked with circles its lower 95% confidence limit, and the line marked with squares its upper 95% confidence limit.

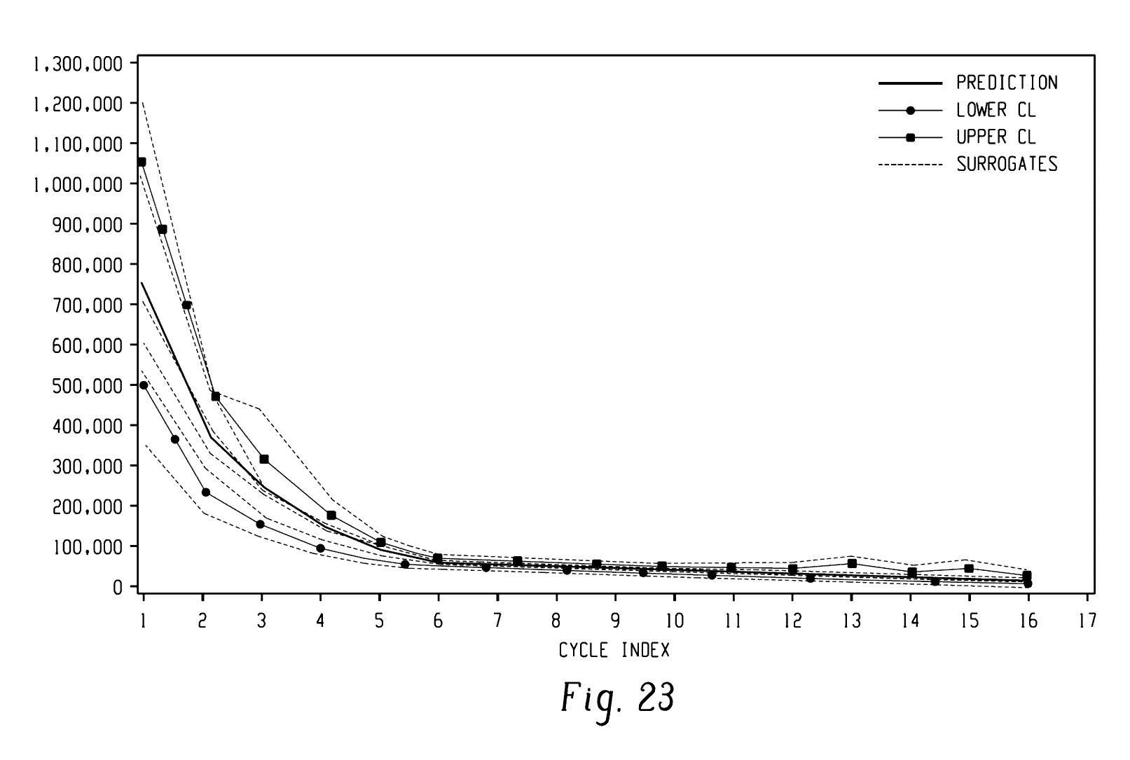

FIG. 23 depicts at 2300 yet another example of predictions for a new product prediction. The model for the cycle series, yₗ, could combine the simple averages of the panel summary and the profile series. The dashed lines represent the surrogate series values, y_{i,l}. The solid unmarked line represents the prediction, ŷₗ, the line marked with circles its lower 95% confidence limit, and the line marked with squares its upper 95% confidence limit.

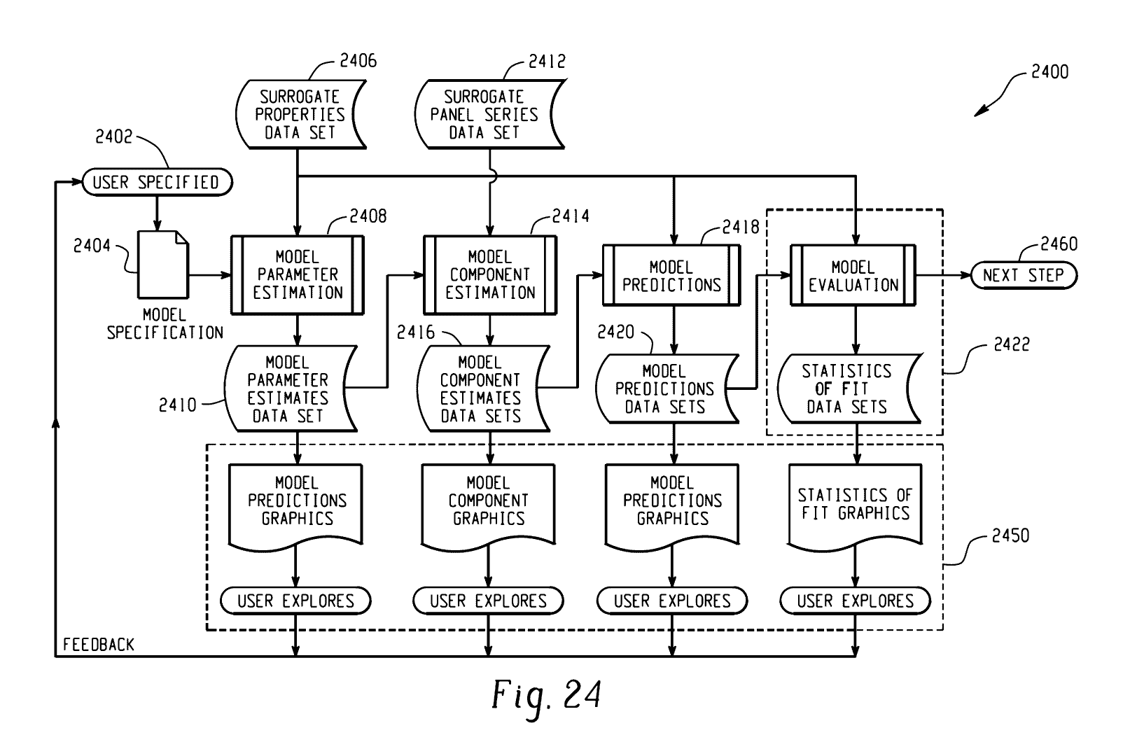

It should be understood that the model step can be implemented with many different types of operations, such as the detailed operations shown at 2400 in FIG. 24. With respect to FIG. 24, the user initially specifies at 2402 a model 2404:

(yₗ,vₗ,cₗ,cₗ^{%},qₗ,Q)=F({Zᵢ}ᵢ₌₁^{N}:θ)

Using the surrogate properties data 2406, the model parameters can be estimated or optimized at 2408 as symbolized by \hat{θ}. Using the model parameter estimates 2410 and the surrogate panel series data 2412, the model components can be estimated at 2414. Using the model component estimates 2416, the model predictions can be estimated at 2418 as follows:

(ŷₗ,\hat{v}ₗ,ĉₗ,ĉₗ^{%},\hat{q}ₗ,\hat{Q})=\hat{F}({Zᵢ}ᵢ₌₁^{N},{\vec{z}ᵢ^{P}}ᵢ₌₁^{N}:\hat{θ})

Using the model predictions 2420, the model can be evaluated at 2422 as follows: SOF(\vec{e},nₚ). In addition, as shown at 2450, after each sub-step described above, the user can graphically explore the results and modify the model specification. Additionally, the user can remove a surrogate series from further considerations that are deemed outliers based on the model results. The process then proceeds to the next step 2460.

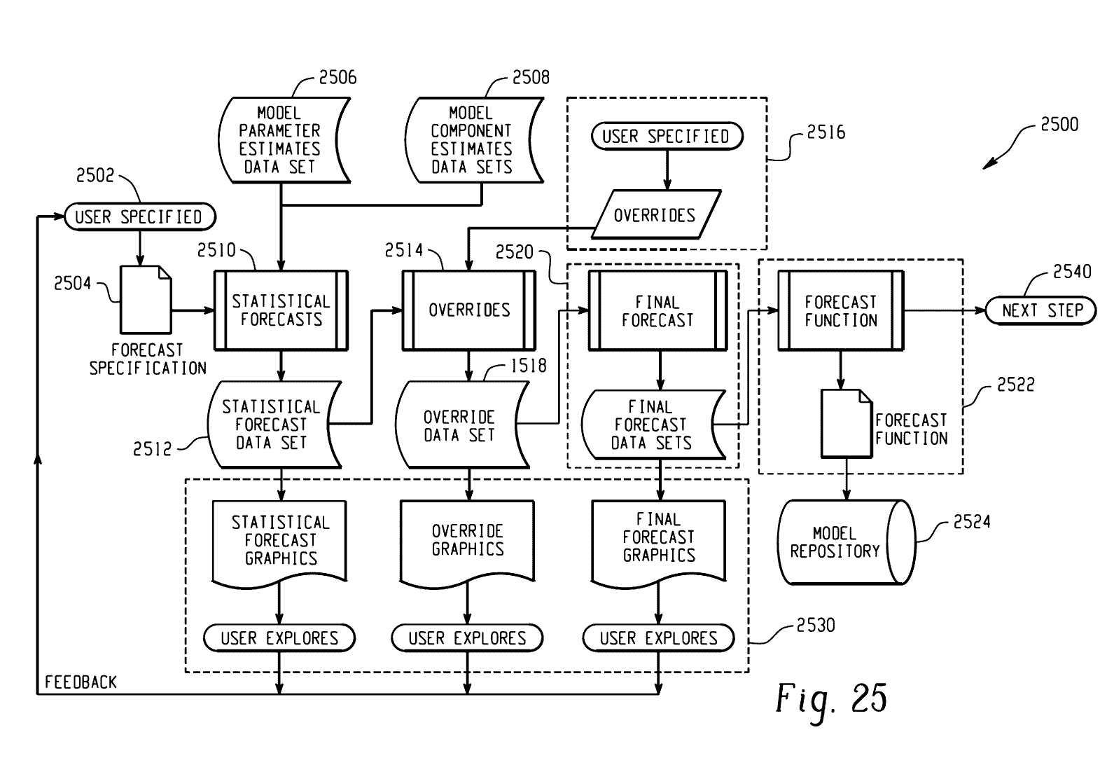

As discussed above, the new product prediction system includes a prediction step. The prediction step can be configured in many different ways, such as in the manner depicted at 2500 in FIG. 25. In the prediction operational scenario depicted in FIG. 25, the user specifies at 2502 the prediction specification 2504: tε{t^{b}, . . . , t^{e}}, which defines timing characteristics of the prediction. Using the model parameter estimates data set 2506 and model component estimates data set 2508, statistical predictions 2510 are generated based on extracted features from the past data. After viewing statistical predictions 2512, the user can optionally apply judgmental overrides 2514, 2516. Combining the statistical predictions 2512 and the overrides 2518, the final predictions 2520 can be computed. A prediction function file 2522 is created and stored in a model repository 2524. In addition, as shown at 2530, after each sub-step described above, the user can graphically explore the results and modify the prediction specification. Additionally, the user can apply and remove overrides based on graphical feedback. The process then proceeds to next step 2540.

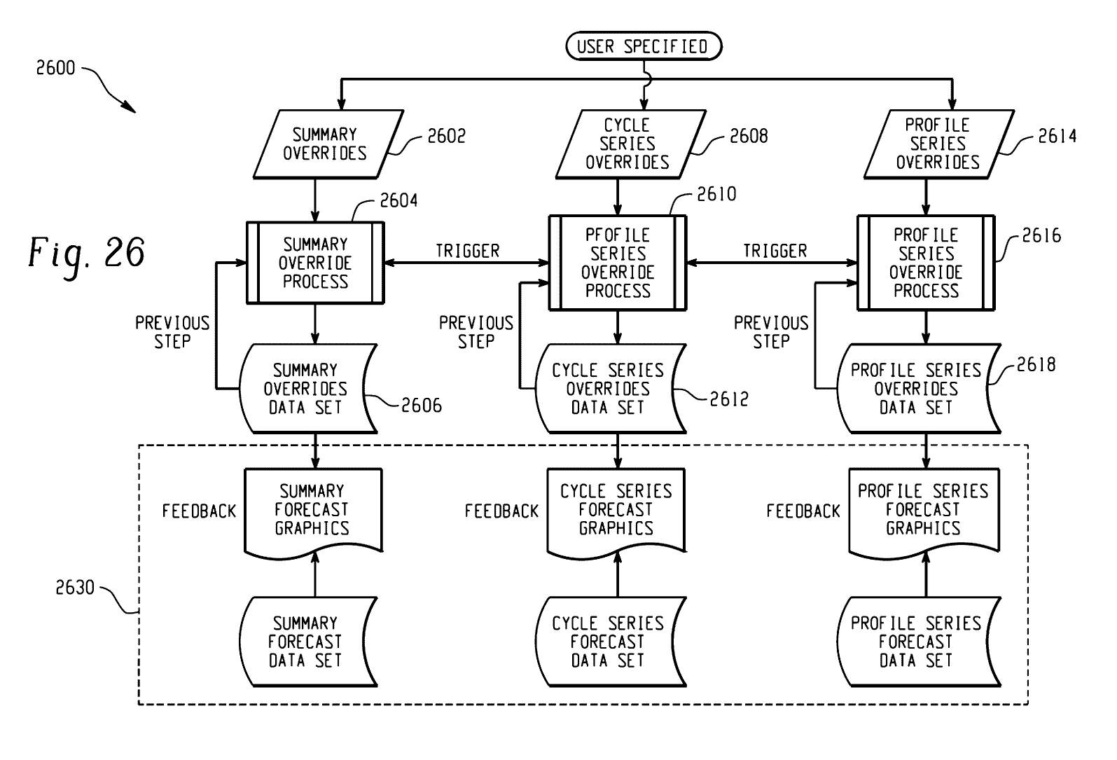

As depicted in FIG. 25, a user can employ overrides during the prediction step. The overrides can be implemented in many different ways, such as in the manner depicted at 2600 in FIG. 26. For example, summary (Q) prediction overrides can be accomplished by a user specifying summary overrides 2602, \hat{Q}^{J}, to the summary predictions, \hat{Q}. The summary override data set 2606 is updated using the summary override process 2604. These overrides trigger changes in the cycle series overrides 2608, ŷₜ^{J}, because ŷₜ^{J}≈\hat{q}ₜ^{J}\hat{Q}^{J}. Using the summary override data set 2606 and the previous cycle series override data set, the cycle series override data set 2612 is updated using the cycle series override process 2610.

For profile series (qₜ) prediction overrides, the user specifies the profile series overrides 2614, \hat{q}ₜ^{J}, to the profile series predictions, \hat{q}ₜ. These overrides trigger changes in the cycle series overrides 2608, ŷₜ^{J}. The profile series override data set 2618 is updated using the profile series override process 2616. These overrides trigger changes in the cycle series overrides, ŷₜ^{J}, because ŷₜ^{J}≈\hat{q}ₜ^{J}\hat{Q}^{J}. Using the profile series override data set 2618 and the previous cycle series override data set, the cycle series override data set 2612 is updated using the cycle series override process 2610.

For cycle series (yₜ=Qqₜ) prediction overrides, the user specifies the cycle series overrides 2608, ŷₜ^{J}, to the cycle series predictions, ŷₜ. The cycle series override data set 2612 is updated using the cycle series override process 2610. These overrides trigger changes in both the summary, \hat{Q}^{J}, and profile series, \hat{q}ₜ^{J}, overrides because ŷₜ^{J}≈\hat{q}ₜ^{J}\hat{Q}^{J}. Using the cycle series override data set 2612 and the previous profile series override data set, the profile series override data set 2618 is updated using the profile series override process 2616. Also, using the cycle series override data set 2612 and the previous summary override data set, the summary override data set 2606 is updated using the summary override process 2604.

As shown at 2630, in each type of override, the user may graphically explore the prediction to determine the effect of the override(s). And based on the user's judgment, overrides may be added or removed.

While examples have been used to disclose the invention, including the best mode, and also to enable any person skilled in the art to make and use the invention, the patentable scope of the invention is defined by claims, and may include other examples that occur to those skilled in the art. Accordingly, the examples disclosed herein are to be considered non-limiting.

It is further noted that the systems and methods may include data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented by program code comprising program instructions that are executable. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

This written description uses examples to disclose the invention, including the best mode, and also to enable a person skilled in the art to make and use the invention. The patentable scope of the invention may include other examples that occur to those skilled in the art.

The systems' and methods' data (e.g., associations, mappings, etc.) may be stored and implemented in one or more different types of computer-implemented ways, such as different types of storage devices and programming constructs (e.g., data stores, RAM, ROM, Flash memory, flat files, databases, programming data structures, programming variables, IF-THEN (or similar type) statement constructs, etc.). It is noted that data structures describe formats for use in organizing and storing data in databases, programs, memory, or other machine-readable media for use by a computer program.

The systems and methods may be provided on many different types of machine-readable media including transitory and non-transitory computer storage mechanisms (e.g., CD-ROM, diskette, RAM, flash memory, computer's hard drive, etc.) that contain instructions for use in execution by a processor to perform the methods' steps and implement the systems described herein.

What is claimed is:

1. A system for predicting performance of a product, the system comprising:
one or more processors; and
one or more non-transitory computer-readable storage mediums containing instructions that, when executed by the one or more processors, cause the one or more processors to perform operations including:
querying a group of past products to identify a subgroup of products related to a new product, wherein each of the past products is associated with past performance data and product attribute data, wherein products in the subgroup share one or more product attributes with the new product, wherein the past performance data and the product attribute data for the products in the subgroup form a set of candidate series data, and wherein querying includes facilitating a first structured judgment analysis in identification of the subgroup of products related to the new product;
filtering the set of candidate series data to add or remove past performance data for one or more products in the subgroup, wherein the filtered set of candidate series data forms a set of surrogate series data, and wherein filtering includes facilitating a second structured judgment analysis in forming the set of surrogate series data;
extracting a set of statistical modeling features from the set of surrogate series data, wherein extracting includes facilitating a third structured judgment analysis for forming the set of statistical modeling features; and
generating a predicted performance for the new product, wherein generating includes generating a prediction function specification using the set of statistical modeling features extracted from the set of surrogate series data, and wherein generating includes facilitating a fourth structured judgment analysis in generating the prediction function specification;
wherein one or more graphical user interfaces are provided for one or more of the querying, filtering, extracting, or generating to facilitate structured judgment analysis in analyzing the predicted performance of the new product.

2. The system of claim 1, wherein structured judgment analysis includes:
receiving an input data set;
receiving an analysis specification;
applying the analysis specification to the input data set to generate a statistical results data set;
receiving judgmental data;
applying the judgmental data to the statistical results data set to generate a judgmental results data set; and
identifying one of the statistical results data set and the judgmental results data set as a structured judgment analysis output.

3. The system of claim 1, wherein the past performance data comprises panel series data.

4. The system of claim 1, wherein querying, filtering, extracting, and generating are performed using a computer-implemented wizard that includes:
a back operation configured to access a previous step for facilitating modification of data with respect to the previous step;
a next operation configured to examine an effect of modifications of the data on one or more succeeding steps; and
a reset operation configured to undo any changes made and to restore values to an initial generated state.

5. The system of claim 1, wherein one or more of the querying, filtering, extracting, and generating are automatically performed without intervention of an analyst.

6. The system of claim 1, wherein filtering the set of candidate series data includes identifying clusters of products in the subgroup, and wherein past performance data is removed for products in one or more of the identified clusters.

7. The system of claim 1, wherein querying the group of past products includes:
providing a first graphical interface for display on a computer display device to facilitate specifying a statistical analysis, wherein the first graphical interface is configured to receive values for product attributes associated with the new product;
providing a second graphical interface for display on the computer display device to facilitate performing the specified statistical analysis and generating statistical analysis results, wherein the second graphical interface is configured to receive a command to query the candidate series data;
providing a third graphical interface for display on the computer display device to facilitate exploring of the statistical analysis results, wherein the second graphical interface is configured to display the set of candidate series data;
providing a fourth graphical interface for display on the computer display device to facilitate overriding the statistical analysis results, wherein the fourth graphical interface is configured to receive a command to remove or add one or more of the past products from or to the subgroup or alter the values for product attributes to generate a revised set of candidate series data; and
providing a fifth graphical interface for display on the computer display device to facilitate visual analysis of an impact of overriding the statistical analysis results, wherein the fifth graphical interface is configured to provide the revised set of candidate series data.

8. The system of claim 7, wherein the third graphical interface that facilitates exploring the statistical analysis results identifies an amount of data present in the surrogate series data.

9. The system of claim 1, wherein filtering the set of candidate series data includes:
providing a first graphical interface for display on a computer display device to facilitate specification of a statistical analysis, wherein the first graphical interface is configured to receive a statistical filter specification;
providing a second graphical interface for display on the computer display device to facilitate performing the specified statistical analysis and generating statistical analysis results, wherein the candidate series data includes multiple candidate series, wherein the second graphical interface provides properties of the candidate series data, provides statistical distances between the multiple candidate series to identify outlier candidate series, and removes outlier candidate series to form the surrogate series data, and wherein the surrogate series data includes multiple surrogate series;
providing a third graphical interface for display on the computer display device to facilitate exploring of the statistical analysis results, wherein the third graphical interface provides the surrogate series data;
providing a fourth graphical interface for display on the computer display device to facilitate overriding the statistical analysis results, wherein the fourth graphical interface is configured to receive a command to add or remove one or more of the candidate series to form revised surrogate series data; and
providing a fifth graphical interface for display on the computer display device to facilitate visual analysis of an impact of overriding the statistical analysis results, wherein the fifth graphical interface provides the revised surrogate series data.

10. The system of claim 9, wherein the third graphical interface that facilitates exploring the statistical analysis results provides an indication of how many surrogate series are included in the surrogate series data.

11. The system of claim 1, wherein extracting the set of statistical modeling features includes:
providing a first graphical interface for display on a computer display device to facilitate specification of a statistical analysis, wherein the first graphical interface is configured to receive a statistical model specification;
providing a second graphical interface for display on the computer display device to facilitate performing the specified statistical analysis and generating statistical analysis results, wherein the surrogate series data includes multiple surrogate series, wherein the statistical model specification is fit to the set of surrogate series data, wherein the set of statistical modeling features are extracted based on the statistical model specification, wherein pooled predictions are computed for the set of surrogate series data using the set of statistical modeling features, and wherein prediction errors for each of the multiple surrogate series are computed based on the pooled predictions;
providing a third graphical interface for display on the computer display device to facilitate exploring of the statistical analysis results, wherein the third graphical interface displays the set of surrogate series data, the pooled predictions, and the statistical analysis results for each of the surrogate series;
providing a fourth graphical interface for display on the computer display device to facilitate overriding the statistical analysis results, wherein the fourth graphical interface is configured to receive a command to remove one or more surrogate series from the set of surrogate series data to generate revised surrogate series data; and
providing a fifth graphical interface for display on the computer display device to facilitate visual analysis of an impact of overriding the statistical analysis results, wherein the fifth graphical interface provides the revised surrogate series data and the statistical analysis results.

12. The system of claim 1, wherein generating the predicted performance for the new product includes:
providing a first graphical interface for display on a computer display device to facilitate specification of a statistical analysis, wherein the first graphical interface is configured to receive a prediction specification describing timing of the new product;
providing a second graphical interface for display on the computer display device to facilitate performing the specified statistical analysis and generating statistical analysis results corresponding to statistical predictions for the new product, wherein the statistical predictions for the new product are based upon timing considerations for the new product;
providing a third graphical interface for display on the computer display device to facilitate exploring of the statistical analysis results, wherein the third graphical interface is configured to provide the statistical predictions for the new product;
providing a fourth graphical interface for display on the computer display device to facilitate overriding the statistical analysis results, wherein the fourth graphical interface is configured to receive a command to override one or more of the statistical predictions for the new product; and
providing a fifth graphical interface for display on the computer display device to facilitate visual analysis of an impact of overriding the statistical analysis results, wherein the fifth graphical interface is configured to display the statistical predictions and one or more overrides.

13. A computer-implemented method for predicting performance of a product, comprising:
querying, using one or more data processors, a group of past products to identify a subgroup of products related to a new product, wherein each of the past products is associated with past performance data and product attribute data, wherein products in the subgroup share one or more product attributes with the new product, wherein the past performance data and the product attribute data for the products in the subgroup form a set of candidate series data, and wherein querying includes facilitating a first structured judgment analysis in identification of the subgroup of products related to the new product;
filtering, using the one or more data processors, the set of candidate series data to add or remove past performance data for one or more products in the subgroup, wherein the filtered set of candidate series data forms a set of surrogate series data, and wherein filtering includes facilitating a second structured judgment analysis in forming the set of surrogate series data;
extracting, using the one or more data processors, a set of statistical modeling features from the set of surrogate series data, wherein extracting includes facilitating a third structured judgment analysis for forming the set of statistical modeling features; and
generating, using the one or more data processors, a predicted performance for the new product, wherein generating includes generating a prediction function specification using the set of statistical modeling features extracted from the set of surrogate series data, and wherein generating includes facilitating a fourth structured judgment analysis in generating the prediction function specification;
wherein one or more graphical user interfaces are provided for one or more of the querying, filtering, extracting, or generating to facilitate structured judgment analysis in analyzing the predicted performance of the new product.

14. The method of claim 13, wherein structured judgment analysis includes:
receiving an input data set;
receiving an analysis specification;
applying the analysis specification to the input data set to generate a statistical results data set;
receiving judgmental data;
applying the judgmental data to the statistical results data set to generate a judgmental results data set; and
identifying one of the statistical results data set and the judgmental results data set as a structured judgment analysis output.

15. The method of claim 13, wherein querying, filtering, extracting, and
generating are performed using a computer-implemented wizard that includes:
a back operation configured to access a previous step for facilitating modification of data with respect to the previous step;
a next operation configured to examine an effect of modifications of the data on one or more succeeding steps; and
a reset operation configured to undo any changes made and to restore values to an initial generated state.

16. The method of claim 13, wherein one or more of the querying, filtering,
extracting, and generating are automatically performed without intervention of an analyst.

17. The method of claim 13, wherein filtering the set of candidate series data includes identifying clusters of products in the subgroup, and wherein past performance data is removed for products in one or more of the identified clusters.

18. The method of claim 13, wherein querying the group of past products includes:
providing a first graphical interface for display on a computer display device to facilitate specifying a statistical analysis, wherein the first graphical interface is configured to receive values for product attributes associated with the new product;
providing a second graphical interface for display on the computer display device to facilitate performing the specified statistical analysis and generating statistical analysis results, wherein the second graphical interface is configured to receive a command to query the candidate series data;
providing a third graphical interface for display on the computer display device to facilitate exploring of the statistical analysis results, wherein the third graphical interface is configured to display the set of candidate series data;
providing a fourth graphical interface for display on the computer display device to facilitate overriding the statistical analysis results, wherein the fourth graphical interface is configured to receive a command to remove or add one or more of the past products from or to the subgroup or alter the values for product attributes to generate a revised set of candidate series data; and
providing a fifth graphical interface for display on the computer display device to facilitate visual analysis of an impact of overriding the statistical analysis results, wherein the fifth graphical interface is configured to provide the revised set of candidate series data.

19. The method of claim 13, wherein filtering the set of candidate series data includes:
providing a first graphical interface for display on a computer display device to facilitate specification of a statistical analysis, wherein the first graphical interface is configured to receive a statistical filter specification;
providing a second graphical interface for display on the computer display device to facilitate performing the specified statistical analysis and generating statistical analysis results, wherein the candidate series data includes multiple candidate series, wherein the second graphical interface provides properties of the candidate series data, provides statistical distances between the multiple candidate series to identify outlier candidate series, and removes outlier candidate series to form the surrogate series data, and wherein the surrogate series data includes multiple surrogate series;
providing a third graphical interface for display on the computer display device to facilitate exploring of the statistical analysis results, wherein the third graphical interface provides the surrogate series data;
providing a fourth graphical interface for display on the computer display device to facilitate overriding the statistical analysis results, wherein the fourth graphical interface is configured to receive a command to add or remove one or more of the candidate series to form revised surrogate series data; and
providing a fifth graphical interface for display on the computer display device to facilitate visual analysis of an impact of overriding the statistical analysis results, wherein the fifth graphical interface provides the revised surrogate series data.

20. The method of claim 13, wherein extracting the set of statistical modeling features includes:
providing a first graphical interface for display on a computer display device to facilitate specification of a statistical analysis, wherein the first graphical interface is configured to receive a statistical model specification;
providing a second graphical interface for display on the computer display device to facilitate performing the specified statistical analysis and generating statistical analysis results, wherein the surrogate series data includes multiple surrogate series, wherein the statistical model specification is fit to the set of surrogate series data, wherein the set of statistical modeling features are extracted based on the statistical model specification, wherein pooled predictions are computed for the set of surrogate series data using the set of statistical modeling features, and wherein prediction errors for each of the multiple surrogate series are computed based on the pooled predictions;
providing a third graphical interface for display on the computer display device to facilitate exploring of the statistical analysis results, wherein the third graphical interface displays the set of surrogate series data, the pooled predictions, and the statistical analysis results for each of the surrogate series;
providing a fourth graphical interface for display on the computer display device to facilitate overriding the statistical analysis results, wherein the fourth graphical interface is configured to receive a command to remove one or more surrogate series from the set of surrogate series data to generate revised surrogate series data; and
providing a fifth graphical interface for display on the computer display device to facilitate visual analysis of an impact of overriding the statistical analysis results, wherein the fifth graphical interface provides the revised surrogate series data and the statistical analysis results.

21. The method of claim 13, wherein generating the predicted performance for the new product includes:
providing a first graphical interface for display on a computer display device to facilitate specification of a statistical analysis, wherein the first graphical interface is configured to receive a prediction specification describing timing of the new product;
providing a second graphical interface for display on the computer display device to facilitate performing the specified statistical analysis and generating statistical analysis results corresponding to statistical predictions for the new product, wherein the statistical predictions for the new product are based upon timing considerations for the new product;
providing a third graphical interface for display on the computer display device to facilitate exploring of the statistical analysis results, wherein the third graphical interface is configured to provide the statistical predictions for the new product;
providing a fourth graphical interface for display on the computer display device to facilitate overriding the statistical analysis results, wherein the fourth graphical interface is configured to receive a command to override one or more of the statistical predictions for the new product; and
providing a fifth graphical interface for display on the computer display device to facilitate visual analysis of an impact of overriding the statistical analysis results, wherein the fifth graphical interface is configured to display the statistical predictions and one or more overrides.

22. A non-transitory machine-readable storage medium for predicting performance of a product, comprising instructions configured to cause a data processing system including one or more processors to perform operations including:
querying, using the one or more processors, a group of past products to identify a subgroup of products related to a new product, wherein each of the past products is associated with past performance data and product attribute data, wherein products in the subgroup share one or more product attributes with the new product, wherein the past performance data and the product attribute data for the products in the subgroup form a set of candidate series data, and wherein querying includes facilitating a first structured judgment analysis in identification of the subgroup of products related to the new product;
filtering, using the one or more processors, the set of candidate series data to add or remove past performance data for one or more products in the subgroup, wherein the filtered set of candidate series data forms a set of surrogate series data, and wherein filtering includes facilitating a second structured judgment analysis in forming the set of surrogate series data;
extracting, using the one or more processors, a set of statistical modeling features from the set of surrogate series data, wherein extracting includes facilitating a third structured judgment analysis for forming the set of statistical modeling features; and
generating, using the one or more processors, a predicted performance for the new product, wherein generating includes generating a prediction function specification using the set of statistical modeling features extracted from the set of surrogate series data, and wherein generating includes facilitating a fourth structured judgment analysis in generating the prediction function specification;
wherein one or more graphical user interfaces are provided for one or more of the querying, filtering, extracting, or generating to facilitate structured judgment analysis in analyzing or generating the predicted performance of the new product.

23. The non-transitory machine-readable storage medium of claim 22,
wherein structured judgment analysis includes:
receiving an input data set;
receiving an analysis specification;
applying the analysis specification to the input data set to generate a statistical results data set;
receiving judgmental data;
applying the judgmental data to the statistical results data set to generate a judgmental results data set; and
identifying one of the statistical results data set and the judgmental results data set as a structured judgment analysis output.

24. The non-transitory machine-readable storage medium of claim 22,
wherein querying, filtering, extracting, and generating are performed using a computer-implemented wizard that includes:
a back operation configured to access a previous step for facilitating modification of data with respect to the previous step;
a next operation configured to examine an effect of modifications of the data on one or more succeeding steps; and
a reset operation configured to undo any changes made and to restore values to an initial generated state.

25. The non-transitory machine-readable storage medium of claim 22, wherein one or more of the querying, filtering, extracting, and generating are automatically performed without intervention of an analyst.

26. The non-transitory machine-readable storage medium of claim 22, wherein filtering the set of candidate series data includes identifying clusters of products in the subgroup, and wherein past performance data is removed for products in one or more of the identified clusters.

27. The non-transitory machine-readable storage medium of claim 22, wherein querying the group of past products includes:
providing a first graphical interface for display on a computer display device to facilitate specifying a statistical analysis, wherein the first graphical interface is configured to receive values for product attributes associated with the new product;
providing a second graphical interface for display on the computer display device to facilitate performing the specified statistical analysis and generating statistical analysis results, wherein the second graphical interface is configured to receive a command to query the candidate series data;
providing a third graphical interface for display on the computer display device to facilitate exploring of the statistical analysis results, wherein the third graphical interface is configured to display the set of candidate series data;
providing a fourth graphical interface for display on the computer display device to facilitate overriding the statistical analysis results, wherein the fourth graphical interface is configured to receive a command to remove or add one or more of the past products from or to the subgroup or alter the values for product attributes to generate a revised set of candidate series data; and
providing a fifth graphical interface for display on the computer display device to facilitate visual analysis of an impact of overriding the statistical analysis results, wherein the fifth graphical interface is configured to provide the revised set of candidate series data.

28. The non-transitory machine-readable storage medium of claim 22,
wherein filtering the set of candidate series data includes:
providing a first graphical interface for display on a computer display device to facilitate specification of a statistical analysis, wherein the first graphical interface is configured to receive a statistical filter specification;
providing a second graphical interface for display on the computer display device to facilitate performing the specified statistical analysis and generating statistical analysis results, wherein the candidate series data includes multiple candidate series, wherein the second graphical interface provides properties of the candidate series data, provides statistical distances between the multiple candidate series to identify outlier candidate series, and removes outlier candidate series to form the surrogate series data, and wherein the surrogate series data includes multiple surrogate series;
providing a third graphical interface for display on the computer display device to facilitate exploring of the statistical analysis results, wherein the third graphical interface provides the surrogate series data;
providing a fourth graphical interface for display on the computer display device to facilitate overriding the statistical analysis results, wherein the fourth graphical interface is configured to receive a command to add or remove one or more of the candidate series to form revised surrogate series data; and
providing a fifth graphical interface for display on the computer display device to facilitate visual analysis of an impact of overriding the statistical analysis results, wherein the fifth graphical interface provides the revised surrogate series data.

29. The non-transitory machine-readable storage medium of claim 22, wherein extracting the set of statistical modeling features includes:
providing a first graphical interface for display on a computer display device to facilitate specification of a statistical analysis, wherein the first graphical interface is configured to receive a statistical model specification;
providing a second graphical interface for display on the computer display device to facilitate performing the specified statistical analysis and generating statistical analysis results, wherein the surrogate series data includes multiple surrogate series, wherein the statistical model specification is fit to the set of surrogate series data, wherein the set of statistical modeling features are extracted based on the statistical model specification, wherein pooled predictions are computed for the set of surrogate series data using the set of statistical modeling features, and wherein prediction errors for each of the multiple surrogate series are computed based on the pooled predictions;
providing a third graphical interface for display on the computer display device to facilitate exploring of the statistical analysis results, wherein the third graphical interface displays the set of surrogate series data, the pooled predictions, and the statistical analysis results for each of the surrogate series;
providing a fourth graphical interface for display on the computer display device to facilitate overriding the statistical analysis results, wherein the fourth graphical interface is configured to receive a command to remove one or more surrogate series from the set of surrogate series data to generate revised surrogate series data; and
providing a fifth graphical interface for display on the computer display device to facilitate visual analysis of an impact of overriding the statistical analysis results, wherein the fifth graphical interface provides the revised surrogate series data and the statistical analysis results.

30. The non-transitory machine-readable storage medium of claim 22, wherein generating the predicted performance for the new product includes:
providing a first graphical interface for display on a computer display device to facilitate specification of a statistical analysis, wherein the first graphical interface is configured to receive a prediction specification describing timing of the new product;
providing a second graphical interface for display on the computer display device to facilitate performing the specified statistical analysis and generating statistical analysis results corresponding to statistical predictions for the new product, wherein the statistical predictions for the new product are based upon timing considerations for the new product;
providing a third graphical interface for display on the computer display device to facilitate exploring of the statistical analysis results, wherein the third graphical interface is configured to provide the statistical predictions for the new product;
providing a fourth graphical interface for display on the computer display device to facilitate overriding the statistical analysis results, wherein the fourth graphical interface is configured to receive a command to override one or more of the statistical predictions for the new product; and
providing a fifth graphical interface for display on the computer display device to facilitate visual analysis of an impact of overriding the statistical analysis results, wherein the fifth graphical interface is configured to display the statistical predictions and one or more overrides.
